(19) United States
(12) Patent Application Publication
(10) Pub. No.: US 2026/0045124 A1
(43) Pub. Date: Feb. 12, 2026

(54) SYSTEM, METHOD, AND APPARATUS FOR CONFIGURABLE VEHICLE DATA COLLECTION

(71) Applicant: Sonatus, Inc., Sunnyvale, CA (US)

(72) Inventors: Yu Fang, Palo Alto, CA (US); James Murphy, Alameda, CA (US); Yixiang Chen, Palo Alto, CA (US)

(21) Appl. No.: 19/364,937

(22) Filed: Oct. 21, 2025

Related U.S. Application Data
(63) Continuation of application No. PCT/US2025/010485, filed on Jan. 6, 2025.
(63) Continuation-in-part of application No. 18/123,183, filed on Mar. 17, 2023.
Application No. 18/123,183 is a continuation of application No. 17/469,148, filed on Sep. 8, 2021, now Pat. No. 11,721,137.
Application No. 17/469,148 is a continuation of application No. 17/195,589, filed on Mar. 8, 2021, now Pat. No. 11,538,287.
(60) Provisional application No. 63/619,267, filed on Jan. 9, 2024.

(51) Int. Cl. G07C 5/00; G07C 5/08; H04L 67/125

(52) U.S. Cl. CPC G07C 5/008; G07C 5/0808; G07C 5/0816; H04L 67/125

(57) ABSTRACT

An apparatus may include a policy acquisition circuit configured to interpret a vehicle policy data value comprising a data collection description. A device may include a policy processing circuit configured to generate parsed policy data corresponding to the data collection description, and to determine a memory allocation value in response to the parsed policy data. A device may include a policy execution circuit configured to collect vehicle data from one or more vehicle end points in response to the parsed policy data, and to store at least a portion of the collected vehicle data in response to the memory allocation value.

### CROSS-REFERENCE TO RELATED APPLICATIONS

The present application is a continuation of, and claims priority to, PCT Patent Application Serial No. PCT/US2025/010485, filed on Jan. 6, 2025, published on Jul. 17, 2025, as International Publication No. WO2025/151377, and entitled “SYSTEM, METHOD, AND APPARATUS FOR CONFIGURABLE VEHICLE DATA COLLECTION” (Attorney Docket No. SONA-0016-WO).

PCT Patent Application Serial No. PCT/US2025/010485 claims the benefit of and priority to U.S. Provisional Patent Application Ser. No. 63/619,267, filed 9 Jan. 2024 and entitled “SYSTEM, METHOD, AND APPARATUS FOR HIGH CAPABILITY CONFIGURABLE VEHICLE DATA COLLECTION” (SONA-0016-P01).

The present application also claims priority to and is a continuation-in-part of U.S. patent application Ser. No. 18/123,183, filed 17 Mar. 2023 and entitled “SYSTEM, METHOD, AND APPARATUS FOR MANAGING VEHICLE DATA COLLECTION” (SONA-0010-U01-C01-C05).

U.S. patent application Ser. No. 18/123,183 claims priority to, and is a continuation of, U.S. patent application Ser. No. 17/469,148, filed Sep. 8, 2021, and entitled “SYSTEM, METHOD, AND APPARATUS FOR MANAGING VEHICLE DATA COLLECTION” (SONA-0010-U01-C01).

U.S. patent application Ser. No. 17/469,148 claims priority to, and is a continuation of, U.S. application Ser. No. 17/195,589, filed Mar. 8, 2021, now U.S. Pat. No. 11,538,287 issued Dec. 27, 2022 and entitled “SYSTEM, METHOD, AND APPARATUS FOR MANAGING VEHICLE DATA COLLECTION” (SONA-0010-U01).

Each one of the foregoing patents and patent applications are incorporated herein by reference in their entirety for all purposes.

### BACKGROUND

Vehicle communication networks are utilized to connect sensors, actuators, controllers, user interfaces, rider personal devices, trailers, and communication devices throughout a vehicle. Recent trends have been increasing the burden on these vehicle communication networks, with more devices being connected, more data passing between devices, lower latency requirements to meet vehicle performance, safety, and emissions requirements, and added vehicle features. Additionally, consumers expect increasing connectivity, reduced driver burden, and features that increase the burdens on vehicle communication networks. These trends are expected to continue, and to accelerate, for the foreseeable future.

Traditional vehicle communication networks (CAN, LIN, FlexRay, MOST, LVDS, etc.) suffer from a number of drawbacks and challenges. These vehicle communication networks have been developed to meet the particular challenges of a vehicle environment, and have accordingly developed separately from other networks, such as computer local area networks, wide area networks, massively interconnected networks (e.g., the internet), and wireless networks. Most vehicle networks consist of a data link layer and an application layer, utilizing robust and dedicated equipment such as a Controller Area Network (CAN) bus, with dedicated or shared wiring between devices utilizing specific data protocols (e.g., J1939, OBD, etc.). A modern vehicle may have multiple network buses, with specific commands and communications available, and limited customization and data speed available. E.g., CAN buses typically operate at up to about 1 Mbps, with high capability CAN buses operating up to about 10 Mbps. Additionally, CAN buses experience latency greater than 25 ms, and generally higher from about 60 ms to 500 ms, depending upon the configuration, the traffic on the CAN, the priority for particular messages, and the like.

As the number of devices and the data rate demand from the devices increases, traditional vehicle communication networks require the implementation of higher performance buses. Because the automotive industry is a high volume industry with a very low tolerance for failure of components, automotive manufacturers utilize the same components for a long time, and across a broad range of vehicles-including sharing of components across manufacturers. Additionally, a change to a nominally more capable component may introduce risks, integration costs, re-certification burdens for a given application, or have other undesirable consequences to the system. Accordingly, even if vehicle communication networks transition to a higher capability network configuration, it is desirable to keep network types segregated in the system, and to keep a large number of legacy devices (e.g., CAN compatible) in a system for a long period of time.

Data collection from vehicles includes a number of additional challenges. For example, data collection operations are subject to regulation and liability risks, especially with data collection that may include private or personally identifiable information. Data collectors, including entities that may have ownership or possession of sensitive data are subject to risk while holding data, for example in the event of inadvertent or malicious access to the data. With regard to vehicle data being collected, a large amount of data may be collected, and a large number of purposes for collecting the data may be present, increasing the risks relative to other general data storage applications. Accordingly, it may be desirable to control data collection, storage, and access, to reduce risks, and it may further be desirable to include verification of data access, partitioning or other exclusion of data when the data is not being used, and the like.

Data collection for vehicles is further complicated by the amount and type of data to be communicated between the vehicle and external devices, where the network system of the vehicle is limited by constraints of a mobile application, expenses and/or bandwidth limitations incurred by high data rates and large data transfers. Even in light of the foregoing, customer demands, market expectations, increasing requirements for efficiency of vehicle operations, and the increase of functional capability for data related applications are continuing to proliferate the aggregate amount of data to be transferred, the number of off-vehicle applications utilizing transferred data, the number of purposes that the data may be utilized for, and the number of users or entities having a legitimate need for portions of the transferred data. Additionally, applications utilizing the data continue to increase in sophistication and capability, increasing the data demand for the limited available transfer resources, and increasing the cost and complexity of logistical control and storage of the transferred data. For example, higher capability pathing or operation algorithms related to the vehicle, increasing automation of vehicle functions, increasing demand for prognostic determinations and/or maintenance support, and increasing media streams (both the number of media streams and the quality of those media streams) all drive for increased demand in data rates, stored data amounts, and the number of entities or applications accessing the stored data.

The complexities and other challenges set forth preceding have synergistic effects that cause the complexity of the vehicle data environment to be even greater than the sum of the individual contributions from each challenge.

As one example, the increasing number of entities or applications accessing the data increases the likelihood that individual data requests will overlap—for example with multiple entities requesting the same or similar data. Further, the increasing number of entities or applications accessing the data increases the likelihood that members of the accessing group will share similar authorization levels, such that the data access for individual members of the entity or application group require data management.

In another example, regulations regarding sensitive data are increasing, which increases the data management requirements of the system generally, but also increases the likelihood that data management may be subjected to multiple constraints at a given time, and/or changing constraints over time as regulations change.

In yet another example, the complex environment of presently known and transitioning vehicle network architectures—for example vehicles having mixed network types and/or partitioned networks—increase the complexity of data access for individual entities that, without certain aspects of the present disclosure, may otherwise be required to determine requesting parameter specifications for particular data elements, and to update those requesting parameters as vehicle network architectures evolve. In view of the increasing number of entities requesting data access, the aggregate cost to the automotive support market increases non-linearly, as each of the entities incurs the costs to track requesting parameter specifications. Additionally, the trajectory of additional entities requesting data access is moving toward entities that are positioned further away in the technological knowledge space from core automotive functions, and accordingly the intricacies and idiosyncrasies of vehicle and/or automotive applications, including on-vehicle network configurations, specific data descriptions, data requesting and communication protocols, industry standards or customs for presenting information, and the like, are becoming less well known on average for each incremental new entity, further increasing the cost volume function (e.g., the cost over time for a given entity to meet desired data collection deliverables, where the given entity may be an automotive manufacturer, and/or a vehicle market, a geographic market, and/or an industry such as the automotive industry, the passenger car industry, etc.). For example, consider a notional cost volume function such as:

COST=#of entities*basic learning cost*adapting to transition cost trajectory*data trajectory cost*regulatory adaptation cost*data access/storage liability cost

The described COST function is a non-limiting notional example to demonstrate how various challenges and complications with regard to presently known systems interact and synergize to increase the costs to meet future data collection functions for vehicle applications. The cost parameters described are not intended to cover all costs related to the challenges present for the automotive data collection industry or presently known systems. Parameters may be averages or other complex functions, and the values of particular parameters will generally not be known with specificity. In addition, the units of the COST may be expressed in monetary values, as a resource (e.g., engineering hours, computation time, etc.) to meet data collection targets over time, as another non-monetary unit such as equivalent emissions, customer satisfaction, risk incurred, public perception losses or gains, etc. The #of entities parameter reflects generally the number of entities accessing vehicle data over time; the basic learning cost reflects the costs for new entities to learn the specifics of data collection requirements and protocols for a specific vehicle, vehicle type, market, etc.; the adapting to transition cost trajectory reflects the costs to adapt to changing vehicle network configurations, including network types and organization; the data trajectory cost reflects the increasing demand for data collection from relevant vehicles over time, including data communication, storage, and resulting functional consequences such as not being able to support a desired application or costs to enhance data communication infrastructure; the regulatory adaptation cost reflects the costs associated with an increasing number of regulations, an increasing number of regulatory frameworks, and/or an increasing number of regulating entities; and the data access/storage liability cost reflects the costs incurred for compliance and security of data, and/or losses incurred due to data breaches, unauthorized use, or the like.

### SUMMARY

Certain aspects of the present disclosure include adjusting the routing of communications on a network, whether between separate devices on the network, or between a device on the network and an external device. Certain aspects of the present disclosure include applying configurations and/or policies to controllers of the vehicle, facilitating communication between end points of the vehicle, including between end points on different networks or different network zones, and between end points that utilize distinct data formatting, data rates, communication protocols, or the like. Certain aspects of the present disclosure include utilizing and managing shared storage to support data collection and/or data sharing between end points. Without limitation to any aspect of the present disclosure, some tools that can be utilized to tactically implement certain operations herein, in combination with the present disclosure, and descriptions that can enhance understanding of some of the terminology used herein (e.g., policy, end point, external device, network protocol, network type, etc.) can be found in one or more of the following U.S. patents or patent applications: U.S. application Ser. No. 17/027,167, filed 21 Sep. 2020, and entitled SYSTEM, METHOD, AND APPARATUS TO SUPPORT MIXED NETWORK COMMUNICATIONS ON A VEHICLE (SONA-0006-U01); U.S. application Ser. No. 17/027,187, filed 21 Sep. 2020, and entitled SYSTEM, METHOD, AND APPARATUS TO EXTRA VEHICLE COMMUNICATIONS CONTROL (SONA-0007-U01); U.S. application Ser. No. 17/195,589, filed 8 Mar. 2021, and entitled SYSTEM, METHOD, AND APPARATUS FOR MANAGING VEHICLE DATA COLLECTION (SONA-0010-U01); U.S. application Ser. No. 17/833,614, filed 6 Jun. 2022, and entitled SYSTEM, METHOD, AND APPARATUS FOR MANAGING VEHICLE DATA COLLECTION (SONA-0012-U01); and/or U.S. application Ser. No. 18/244,147, filed 8 Sep. 2023, and entitled SYSTEM, METHOD, AND APPARATUS TO EXECUTE VEHICLE COMMUNICATIONS USING A ZONAL ARCHITECTURE (SONA-0015-U01), each of which is incorporated herein by reference in the entirety for all purposes.

Example and non-limiting aspects of the present disclosure, which may be utilized in whole or in part with any one or more of the preceding systems, apparatuses, controllers, circuits, and/or procedures preceding, and/or with any other aspect of the present disclosure, are described following. The following aspects are non-limiting, and any one or more of these, or none of these, may be utilized in a given embodiment.

An example procedure includes an operation to enhance trigger operations, where a trigger may be utilized as a decision element in any feature, such as: triggering a data collection event; triggering a diagnostic; triggering an active or passive test operation; triggering an automated vehicle response operation; and/or triggering an update operation. In certain embodiments, a trigger may form a part of another operation, act as an intermediary operation within any operation (e.g., utilized to pause or continue the parent operation), including without limitation within one of the listed types of operations.

An example trigger enhancement operation includes utilizing an external event of any type within the trigger operation, for example a weather based event, time of day, calendar event (e.g., a holiday, day of the week, fiscal year event, etc.), and/or combining the external event with specific knowledge of the vehicle and/or owner/operator of the vehicle (e.g., responding to the birthday of the vehicle owner, a normal trip event for the vehicle, an estimate for a likely destination of the vehicle on a trip, etc.).

An example trigger enhancement operation includes utilizing logical vehicle groupings for the trigger, for example in response to the vehicle being a part of a logical group, applying a trigger to the group, etc. Without limitation, a logical vehicle grouping includes vehicles sharing an aspect, such as: vehicles utilizing a particular configuration, component, or feature; vehicles having a related maintenance event, recall, or campaign; vehicles having a common a manufacturer, body builder, dealer, and/or OEM; vehicles having a common owner (e.g., a fleet); vehicles having a common owner type (e.g., commercial, personal, rental, first responder, government); vehicles having a common duty cycle (e.g., a quantitative/statistical description of the duty cycle and/or a categorical description of the duty cycle); and/or vehicles having a common application and/or function (e.g., delivery, line haul, first responder, commuter, etc.).

An example trigger enhancement operation further includes an individualized trigger, for example where the vehicle is part of a logical grouping for the trigger. For example, a trigger criterion may be based on the logical grouping and include further customization, which may be applied automatically, for the particular vehicle. Individualization aspects may include, without limitation: setting the trigger criteria (e.g., a threshold value for the trigger, which is adjusted for a characteristic of the individual vehicle); adjusting data collected in response to the trigger; formatting data in response to the trigger; applying time windows (e.g., utilized to determine the trigger, and/or time windows over which the trigger is active or monitored); action duration (e.g., duration of an action commenced in response to the trigger, for example due to the dynamics in the vehicle, and/or an amount of time over which the action will be performed); and/or an organization of actions (e.g., the sequencing of actions, and/or parallel or serial operations of one or more actions). In certain embodiments, setting the individualization parameters for a trigger includes determining the purpose for the trigger, and the characteristics of vehicles within the logical grouping that may affect the purpose for the trigger. For example, an action to track fuel consumption may relate to monitoring for a fraction of the fuel in the vehicle to be consumed, which may depend upon the fuel capacity of the vehicle. In another example, certain vehicle types, or the specific history of the vehicle, may indicate times of day where a trigger monitoring and responsive action is more likely to be effective. Thus, common situations can be addressed with a common trigger action for the logical grouping, but tailored for specific vehicles within the group. In certain embodiments, trigger options may be configured (e.g., the triggering parameters and/or trigger criteria) for certain vehicles, such as prototype, engineering, or test vehicles, where those options may be made unavailable for other types of vehicles (e.g., a standard passenger car application in use by a customer).

An example trigger enhancement operation allows for a variable duration of the trigger, which may be commanded upon initial communication of the trigger to the vehicle. In certain embodiments, the variable duration of the trigger may be adjusted based on the logical vehicle grouping for the vehicle, and/or individualized trigger options for the vehicle within the logical grouping. Example variable duration options include, without limitation: a persistent trigger (e.g., evaluating the trigger and performing the responsive action, which may include collecting data and/or capturing the trigger event occurrence, on a continuous basis over a specified time period, during certain relevant operating conditions, and/or on an ongoing basis); a one-time trigger (e.g., evaluating the trigger until the trigger event occurs, and then ceasing the monitoring; which may include performing the trigger response actions one time); an n-based time trigger (e.g., evaluating the trigger until the trigger event occurs n times, where n is a selected number, for example to confirm certain behavior, to provide a statistically relevant event data set, to support comparisons between vehicles, etc.); a defined duration trigger (e.g., monitor the trigger for X number of days; the duration can be time based, utilization based (e.g., for the next 1,000 miles, until 100 miles are traversed under cruise control operation, until 10,000 hp-hr of energy is delivered to the powertrain, etc.), and/or based on certain operating conditions (e.g., until 10 start/stop cycles are performed); and/or a transient trigger (e.g., monitor whenever another trigger condition is active, which can result in an intermittent and/or transient trigger evaluation). It can be seen that the trigger operations are not exclusive, for example a trigger evaluation may be persistent until a defined duration value is exceeded. It can further be seen that trigger operations may be operated in a sequence, for example monitoring a temperature of the vehicle whenever the vehicle is operating at another condition (e.g., high altitude, high power, high ambient temperature, etc.).

An example procedure includes an operation to implement a user interface for a user entering recipes (e.g., policies, automated vehicle responses, triggers, etc., which can be downloaded to vehicle(s) for implementation and/or utilized as a template or starting point for any operations herein), setting up triggers (e.g., trigger evaluation conditions, and/or responses to the trigger evaluation conditions), and/or requesting policies or other active information from a vehicle (or group of vehicles) (e.g., getting a summary, overview, report, or detailed description of policies, triggers, automated actions, recipes, etc., that are active on the vehicle; active information may be limited to triggers/policies/recipes/automated actions (TPRA) that are actively being monitored and/or acted upon, and/or may include TPRA that would be monitored and/or acted upon if other conditions were met-such as another active trigger that is being evaluated). In certain embodiments, inactive information may also be requested, for example trigger operations that have been completed but remain in the system—for example where collected data has not been transmitted off the vehicle, and accordingly the trigger information may still be in the system even though it will no longer be acted upon.

Example operations to implement the user interface include allowing the user to select or generate logical vehicle groupings, to determine the type of TPRA information to be reported, and to provide a display of the TPRA information that is searchable, sortable, filterable, or the like, according to specific vehicles, vehicle characteristics, information about the TPRA (e.g., triggers where an evaluation has returned an event detection), etc. In certain embodiments, TPRA information on the user interface may be exported (e.g., to form a template or recipe for creating a new TPRA) and/or modified (e.g., where a modification of the TPRA initiates an update interface, and populates the update with information based on the modification activity in the TPRA user interface). In certain embodiments, the user interface may utilize feature or function nicknames, allow the importing of all or portions of a recipe into the creation portion of another recipe, allow for the user to create and/or name recipes, etc.

An example procedure includes operations to enhance data collection operations for a vehicle. An example operation includes providing a dedicated memory reservation for a data collection operation, for example determining an amount of data to be collected for the operation (e.g., determined from the commanding operation to collect the data, such as a trigger, automated action, diagnostic action, test action, etc.), and reserving the memory space, for example in a shared storage location, on a controller of the vehicle, etc. The operation to reserve the memory space may be specific allocation (e.g., ensuring that specific memory locations remain available) or non-specific allocation (e.g., ensuring that sufficient memory remains available, without necessary allocating specific addresses for the memory). In certain embodiments, operations for dedicated memory reservation include communicating to the controller(s) responsible for the data collection where the collected data is to be stored. In certain embodiments, the memory reservation may be distributed, for example where more than one controller is responsible to collect the data, and/or where a data store on the vehicle is itself a distributed data store (e.g., a logical data store having portions in various memory locations on the vehicle).

An example memory reservation operation includes utilizing a shared memory reservation basket—for example reserving memory for various data collection operations as a unified memory allocation to support the various data collection operations. In the example, the shared memory reservation basket may be a specific allocation or a non-specific allocation, and additionally or alternatively the shared memory reservation basket may be strictly sufficient for all memory operations (e.g., 10 competing data collection operations that utilize 10 MB each, where 100 MB is allocated to support those data collection operations), and/or may be statistically sufficient for the memory operations (e.g., in a further example, where less than 100 MB is allocated to support those data collection operations, for example 50 MB, or 75 MB). In certain embodiments, memory reservation operations include determining a statistically sufficient allocation for the memory operations, for example support for data collection for anti-correlated triggers (e.g., if trigger A occurs and orders collection of data A, then the conditions will not occur for trigger B and a corresponding collection of data B). In certain embodiments, the statistically sufficient allocation for the memory operations may be performed utilizing a Bayesian estimate, which may be operated in the aggregate (e.g., based on the likelihood of each trigger event to occur) and/or to determine specific likelihoods for correlation and/or anti-correlation (e.g., the occurrence of trigger A may make the occurrence of trigger B more or less likely) between triggers and/or other contingent data collection and storage operations. In certain embodiments, historical usage of the memory for various triggers, automated operations, diagnostics, and/or tests on the vehicle may be utilized, including correlating those usage patterns with other vehicle characteristics (e.g., owner, application, duty cycle, and/or, without limitation, any other vehicle aspect such as those set forth in relation to logical vehicle groupings). In certain embodiments, on-vehicle events, such as the occurrence of a fault code, certain operating conditions, change in vehicle usage pattern, etc., may be utilized to determine and/or adjust the shared memory reservation basket. In certain embodiments, an iterative improvement algorithm, for example a machine learning or artificial intelligence based application, may be utilized to set or adjust the shared memory reservation basket for a group of contingent data collection and storage operations.

In certain embodiments, the group of contingent data collection and storage operations that are correlated into a particular shared memory reservation basket may be adjusted, for example to improve the likelihood that the basket is correctly sized, to simplify determinations of the correct basket size, to adjust the likelihood that a given basket is correctly sized, or the like. For example, contingent data collection and storage operations that are mission critical may be provided with dedicated memory storage resources, placed into a shared memory reservation basket that is strictly sufficient, and/or placed into a shared memory reservation basket with a high confidence value that the basket is statistically sufficient. In certain embodiments, shared storage within a basket may be prioritized based on the type of data, the requesting entity for the storage operation (e.g., the related end point, flow, application, controller, etc.), the recency of the data, or the like, for example allowing for the storage of at least high priority data until the data can be moved off vehicle (e.g., to the cloud), some of the data can be deleted (e.g., under data expiration and/or data life cycle management operations), some of the data can be compressed, and/or additional storage can be allocated to the shared memory reservation basket.

Certain aspects that a user may utilize to determine how to group contingent data collection and storage operations include aspects such as: the variability in the size of data collected for an operation, and/or a statistical description thereof; the expected life cycle of the collected data within the shared memory reservation basket; further processing to be performed on the collected data, the resulting size after the processing, and the timing thereof; the correlation or anti-correlation between operations, and/or the certainty thereof; the effect of the distribution of operations between baskets (e.g., reduced uncertainty on one basket may increase or decrease the uncertainty in other baskets, and the effect of these may be greater than or less than the effect on the assigned basket); and/or the availability of historical information about the data collection and storage operations on the vehicle and/or on other similar vehicles.

In certain embodiments, collected data pursuant to a contingent data collection and storage operation may be packaged, for example within a file, a discrete number of files, in dedicated memory locations, or the like. In certain embodiments, the packaging may include more than one instance of a contingent data collection operation, and/or each contingent data collection operation may be packaged individually. Accordingly, embodiments herein contemplate a 1:1 correlation between packages and data collection operations, a many:1 correlation between packages and data collection operations, or a many:many correlation between packages and data collection operations. In certain embodiments, a package may be removed from a shared memory reservation basket (e.g., to simplify estimates of statistical sufficiency of the baskets) and/or the contingent data operation may be removed from the shared memory reservation basket (e.g., a contingent data operation that will not be executed again) once the package is prepared. The utilization of packages for collected data can enhance management of the shared memory allocation, provide for ease in determining statistical information about the vehicle (e.g., data waiting to be sent to the cloud; aggregating or describing data responsive to a particular trigger, diagnostic, test, etc., potentially for a group of vehicles), and/or provide for improved response time during limited transmission windows to the cloud, a tool, or the like (e.g., when sending the data off-vehicle).

In certain embodiments, real-time data, flow logs, vehicle status values (e.g., fault codes, errors, operating status parameters such as START, RUN, CRUISE, STOP, etc.), metadata (e.g., time stamps or other values associated with the contingent data collection operation), or the like may be captured and made available with the collected data. In certain embodiments, such data may be packaged with the collected data in the package(s) created for the data.

In certain embodiments, for example when collected data, packages, or the like are transmitted off vehicle, a memory buffer will be utilized to ensure seamless transmission operations, and to avoid repeat transmission operations (e.g., when a large data package transmission is interrupted).

In certain embodiments, transmission operations for collected data, packages, or the like may be classified, and competition for limited data storage and/or transmission resources may be resolved in response to the classification. For example, the classification of collected data to be stored or transmitted may be determined according to a policy uniquifier for the collected data—for example according to a policy type for the associated policy that defined the contingent data collection operation. Additionally or alternatively, the data type of the collected data may be utilized for the classification. Additionally or alternatively, entity characteristics for any associated entity (e.g., the entity providing the policy, providing the data, and/or utilizing the data, where the entity may be an external entity such as an organization that provided the policy, or an end point, flow, or application on the vehicle). For example, vehicle control data, data requested by a vehicle manufacturer, and/or data provided by a vehicle control end point may be classified as high priority data. In certain embodiments, the classification of the collected data and/or package may be determined based on vehicle operating conditions—for example in a vehicle operating condition where plentiful memory and/or network communication resources are available, sensitive data such as audio-visual (AV) data may be high priority data, and in another vehicle operating condition such as during an update, and/or where network communication resources are limited, the AV data may be low priority data. In certain embodiments, the classification and/or priority for the collected data and/or package may be utilized to arbitrate resources in any manner, for example allowing higher priority data to always win, utilizing a weighted priority scheme, using round robin (and/or weighted round robin) scheduling of resources, or the like.

An example procedure includes operations to enhance data collection operations for a vehicle, by creating data elements passed between applications on the vehicle to support TPRA operations. For example, parameters that are commonly utilized by a number of TPRA operations may be provided in a location accessible to the relevant end points on the vehicle, which can reduce the number of processing operations to create and store these parameters. For example, an intermediate determination for a TPRA operation may include comparing parameters, determining intermediate states, or the like, where the example procedure includes making these determinations one time and making the results available, which reduces redundant workloads on controllers of the vehicle. In certain embodiments, the created data elements may exist on the vehicle already, where the common location operation reduces the workload on a controller that provides that parameter. In certain embodiments, the created data elements may not exist on the vehicle already, but emerge from common processes that occur to perform the various TPRA operations, and that can be parsed from the aggregate body of the TPRA operations. In certain embodiments, the procedure includes an operation to simplify the TPRA operations in view of the created data elements.

An example procedure includes operations to enhance data collection operations for a vehicle, by providing a flexible policy implementation for the vehicle. In certain embodiments, the policy may be configured to operate immediately (e.g., even at runtime), at a next start-up event, and/or in response to a trigger condition. Policies that are operated in response to a trigger condition may utilize a flag value, where the flag value includes a known description for the policy trigger (e.g., “STARTUP”, “HIGH POWER”, etc.) that may be stored on the vehicle and/or standardized by a relevant entity (e.g., the manufacturer, a fleet owner, etc.). In certain embodiments, policies that are operated in response to a trigger condition may include the trigger condition within the policy. Without limitation to any other aspect of the present disclosure, example and non-limiting policy implementations include one or more of: an on demand policy (e.g., ends on shutdown, after one execution, or after X executions), a limited behavior policy (e.g., limiting operations to streaming, data capture, and/or data capture options), and/or persistent (e.g., ongoing evaluation and operation of the policy). In certain embodiments, each policy may be assigned a uniquifier (e.g., a unique ID assigned to the policy, and/or generated from the policy data), and/or a policy-client uniquifier (e.g., a unique ID for the policy and entity that supplied the policy, and/or generated from the policy data and/or entity source data).

In certain embodiments, operations set forth throughout the present disclosure may support, be adjusted for, and/or have operational changes made in response to a QoS for data transmission, which may include QoS parameters for entities (e.g., end points, controllers, flows, applications, circuits, etc.) on the vehicle.

An example procedure includes operations to enhance data collection operations and/or storage management operations includes operations to perform time series data compression on collected data, packages, and/or any other stored data on the system. In certain embodiments, operations to perform delta-delta compression, sigma compression, and/or encoding compression, including combining one or more of these in certain embodiments, have demonstrated superior compression performance (e.g., based on compressed data size, compression processing time, compressed data integrity, and/or de-compression processing time) relative to previously known compression schemes, for collected data in embodiments herein.

In certain embodiments, time series data may be compressed by including an operation to remove the time series field, and/or to separately compress the time series field. For example, a continuous time series field may be removed entirely without loss of data by tracking a series beginning time and a data increment time. For relatively continuous time series data, for example a series including gaps, significant compression can be realized by storing a number of time series beginning time markers (e.g., corresponding to any breaks or lost data points). In certain embodiments, it may be acceptable to fill out pseudo data in the gaps (e.g., interpolated data) to preserve the time series continuity, and/or to fill in dead data (e.g., that may be marked or tagged). In certain embodiments, the data may be further compressed by encoding, for example in the common situation where many of the data values have a same value. Additionally or alternatively, a sigma compression (or zero-picking) may be applied where many of the data values have repeated zeros. In certain embodiments, delta compression may be performed after applying any time series compression, encoding, and/or zero-picking, for example to promote a large number of data points having a specific value (e.g., a zero value).

In certain embodiments, compression operations may additionally or alternatively include leaving a portion of the data uncompressed, for example to facilitate query operations, providing headers for the data, and/or providing a context view for a client of the data (e.g., to find and/or display the data on a user interface for a user external to the vehicle). For example, a portion of the data related to trigger operations may be uncompressed to facilitate display and/or finding the related data package—for example to provide a user with a quick understanding of why the data package was captured. In certain embodiments, collected data may be stored in chunks (e.g., determined by blocks of time, data size, number of interesting data features in each chunk, etc.; where the number of interesting features may relate to detected events within the chunk, according to a gradient of data within the chunk, reversals of data patterns in the chunk, etc.). In a further example, a portion of each chunk may be left uncompressed, for example allowing a user to rapidly browse any interesting events for the vehicle within the data, and rapidly perform a limited decompression operation to evaluate the specific data within the chunk. In certain embodiments, the data may be indexed, and/or the data chunks may be indexed. In certain embodiments, the chunking and/or indexing scheme may be set by a user (e.g., by providing a policy to the vehicle). In certain embodiments, the chunking and/or indexing scheme may be set according to a diagnostic and/or fault tree analysis (FTA) (e.g., as a contingent data collection operation serving the diagnostic and/or FTA), allowing for the construction of powerful diagnostic and/or FTA operations that can seamlessly collect desired data from the vehicle under desired conditions, that is compressed and formatted in a manner that rapidly facilitates analysis to support the diagnostic and/or FTA.

### BRIEF DESCRIPTION OF THE FIGURES

FIG. 1 is a schematic diagram of an example data collection system according to certain embodiments of the present disclosure;

FIG. 2 is a schematic diagram of an example vehicle having aspects of a data collection system according to certain embodiments of the present disclosure;

FIG. 3 is a schematic diagram of an example off-vehicle device according to certain embodiments of the present disclosure;

FIG. 4 is a diagram of example internal and/or external applications according to certain embodiments of the present disclosure;

FIGS. 5A and 5B depict a schematic diagram of an example vehicle network infrastructure for a vehicle according to certain embodiments of the present disclosure;

FIG. 6 is a schematic diagram of an example edge gateway according to certain embodiments of the present disclosure;

FIG. 7 is a schematic diagram of an example ethernet switch according to certain embodiments of the present disclosure;

FIG. 8 is a schematic diagram of an example ethernet device according to certain embodiments of the present disclosure;

FIG. 9 is a schematic diagram of an example user consent controller according to certain embodiments of the present disclosure;

FIG. 10 is a schematic diagram of an example data collector controller according to certain embodiments of the present disclosure;

FIG. 11 is a schematic diagram of an example first partition according to certain embodiments of the present disclosure;

FIG. 12 is a schematic diagram of an example second partition according to certain embodiments of the present disclosure;

FIG. 13 is a schematic diagram of an example cloud system according to certain embodiments of the present disclosure;

FIG. 14 depicts an example cloud system for retrieving selected data from a vehicle according to certain embodiments of the present disclosure;

FIG. 15 depicts an example schematic diagram of an operation that includes an operation for data collection operations from a vehicle according to certain embodiments of the present disclosure;

FIG. 16 depicts an example procedure for separating responsive data to a vehicle data collection operation according to certain embodiments of the present disclosure;

FIG. 17 depicts an example procedure for separating responsive data to a vehicle data collection operation according to certain embodiments of the present disclosure;

FIG. 18 depicts an example system for retrieving selected data from a vehicle according to certain embodiments of the present disclosure;

FIG. 19 depicts an example procedure for identifying data according to certain embodiments of the present disclosure;

FIG. 20 depicts an example cloud system for preparing data collection policies according to certain embodiments of the present disclosure;

FIG. 21 depicts an example policy creator circuit according to certain embodiments of the present disclosure;

FIG. 22 depicts an example request interface according to certain embodiments of the present disclosure;

FIG. 23 depicts an example procedure for operating a request interface according to certain embodiments of the present disclosure;

FIG. 24 depicts an example system to support enhanced vehicle data collection;

FIG. 25 depicts an apparatus to provide an external even triggered policy;

FIG. 26 depicts example external event trigger conditions;

FIG. 27 depicts example location values;

FIG. 28 depicts an example apparatus to determine a target group of vehicles;

FIG. 29 depicts example shared vehicle aspects;

FIG. 30 depicts an example apparatus to support policy creation;

FIG. 31 depicts an example user data collection interface;

FIG. 32 depicts example normalized data parameters;

FIG. 33 depicts an example apparatus to manage data collection and storage;

FIG. 34 depicts an example basket scheme for allocating shared memory;

FIG. 35 depicts example components of a policy reporting circuit;

FIG. 36 depicts an example vehicle having a controller to manage data collection, storage, and data sharing;

FIG. 37 depicts an example apparatus to manage data sharing and analysis;

FIG. 38 depicts example components of a data support circuit;

FIG. 39 depicts an example apparatus for policy life cycle management; and

FIG. 40 depicts example policy life cycle description options.

### DETAILED DESCRIPTION

Without limitation to any other aspect of the present disclosure, aspects of the disclosure herein reduce and/or eliminate any one or more of: a cost per entity added to a data collection system, a basic learning cost for a new entity to implement an application utilizing collected data, an adaptation cost to changing vehicle network configuration(s), a cost incurred to meet the increasing demand for data collection, a cost to adapt to a changing regulatory environment, and/or a cost to secure data and/or losses incurred for breaches or unauthorized use. Certain embodiments and/or aspects of the disclosure herein may address one or more of the described cost parameters. Certain embodiments and/or aspects of the disclosure herein may increase one or more given cost parameters, but nevertheless be beneficial by decreasing the overall cost function for a target vehicle, vehicle type, entity, industry, etc. Certain embodiments and/or aspects of the disclosure herein may increase one or more given cost parameters, but provide other benefits such as improved functionality. In certain embodiments, improved functionality may be achieved at an increased cost, but at a lower cost than previously known systems configured to achieve a similar improved functionality.

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

The present disclosure describes systems, methods, and apparatuses to perform data collection operations related to a vehicle. Certain embodiments set forth herein reference a mixed vehicle network on a vehicle. Example mixed vehicle networks include a network having one or more CAN buses with a number of devices communicating over the CAN bus(es), and one or more ethernet networks with a number of devices communicating over the ethernet network, and communication that crosses from CAN to ethernet and/or vice-versa. Mixed networks are not limited to CAN and ethernet, and may include, without limitation, any one or more of a local interconnect network (LIN), FlexRay, Media Oriented Systems Transport (MOST), and/or low-voltage differential signaling (LVDS). Currently available ethernet networks are highly capable, having bandwidth ratings between 100 Mbps to 25 Gbps, and latency values between 5 ms to 20 us (0.02 ms). In certain embodiments, more than one ethernet network (or zone) may be present, and may include mixed capability ethernet networks. Additionally or alternatively, in certain embodiments, one or more networks present may include wireless networks such as a WiFi network (e.g., an 802.11x standard such as a/b/g; n; and/or ac), a mobile standard network (e.g., 4G and/or 5G), Bluetooth communications, universal serial bus (USB) connections, and/or fiber optic connections. The recited networks are non-limiting examples, and any type of network and/or communication protocol is contemplated herein for a mixed vehicle network.

In certain embodiments, the mixed vehicle network includes one or more low-capability networks combined with one or more high-capability networks. The capability that is considered low-capability depends upon the application, the number of devices that are in communication, the types of communication that are allowed on the network, and the available network management (e.g., registration, addition, or removal of devices, encryption of messages, customization of messages, etc.) for the particular network and communication protocols being utilized. In certain embodiments, the mixed vehicle network includes more than one network, where at least two of the networks present an integration challenge. For example, one of the networks may only allow certain types of communications, require certain types of synchronous or asynchronous communications, only allow connection of certain types of devices, limit the implementation of certain network topologies, or have other differences or limitations that render utilization of a single network (or network type) throughout the vehicle undesirable or impractical.

The description herein utilizing off-vehicle, extra-vehicle, and/or cloud-based interactions references any external network communications of the vehicle, including without limitation wireless-based communications (e.g., mobile data, WiFi, and/or Bluetooth) to external devices. Communications to external devices may be to a general network (e.g., over the internet), a WAN, a LAN, a mobile device in proximity to the vehicle, and/or combinations of these. Certain systems and procedures described herein particularly contemplate run-time operations of the vehicle, for example external communications occurring during operating conditions wherein the vehicle is executing a mission (e.g., moving, performing operations while not moving, etc.). The disclosure herein further contemplates communications that may occur during any period, including during down-time of the vehicle and/or during service events. The disclosure herein further contemplates communications that may occur through wired communication channels, such as when the vehicle network is in communication with a service tool, on-board diagnostics (OBD) instrument, or other physically coupled device.

The description herein references vehicle applications as a non-limiting example and for clarity of the present description. However, embodiments herein are applicable to other applications having similar challenges and/or implementations. Without limitation to any other application, embodiments herein are applicable to any application having multiple end points, including multiple data sources, controllers, sensors, and/or actuators, and which may further include end points present in distinct or distributed network environments, and/or applications having historical or legacy networking or communication systems that may be transitioning (within a given system, as a class of systems, and/or as an industry) to newer and/or more capable networking or communication systems. Example and non-limiting embodiments include one or more of: industrial equipment; robotic systems (including at least mobile robots, autonomous vehicle systems, and/or industrial robots); mobile applications (that may be considered “vehicles”, or not) and/or manufacturing systems. It will be understood that certain features, aspects, and/or benefits of the present disclosure are applicable to any one or more of these applications, not applicable to others of these applications, and the applicability of certain features, aspects, and/or benefits of the present disclosure may vary depending upon the operating conditions, constraints, cost parameters (e.g., operating cost, integration cost, operating cost, data communication and/or storage costs, service costs and/or downtime costs, etc.) of the particular application. Accordingly, wherever the present disclosure references a vehicle, a vehicle system, a mobile application, industrial equipment, robotic system, and/or manufacturing systems, each one of these are also contemplated herein, and may be applicable in certain embodiments, or not applicable in certain other embodiments, as will be understood to one of skill in the art having the benefit of the present disclosure.

A flow, as utilized herein, should be understood broadly. An example flow includes a related group of data (e.g., speed data, temperature data, audio-visual data, navigation data, etc.), a related group of functions (e.g., among vehicle functions, extra-vehicle functions such as service operations and/or data collection, aggregations between related vehicles, and/or combinations of these that are related for a particular system), a related group of devices (e.g., door actuators), and/or a related group of applications. Flows, as used herein, provide an organizing concept that may be utilized to relate certain data, certain end points, certain applications, and/or related functions of the vehicle or apart from the vehicle. In certain embodiments, a controller can utilize a flow to identify a data source, a data destination, permissions available for the flow, priority information related to the flow, or the like, to implement certain data regulating operations here. In certain embodiments, the utilization of the flow allows the controller to perform separate operations that may involve the same end points to support the desired network management. For example, a vehicle speed management application may have a high priority, and a speedometer end point may be associated with the vehicle speed management application. In the example, if the vehicle speed is being communicated to support the vehicle speed management application, then the controller applies a high priority to the vehicle speed message. However, if the vehicle speed is being communicated to support a trip planning flow (e.g., where a trip planning flow is present and does not have a high priority), the controller may apply a lower priority to the vehicle speed message. In a further example, a failure of a vehicle controller, portion of a network, or other off-nominal condition may result in the migration of the vehicle speed management application to another controller in the system, whereby the vehicle speed message is being communicated (e.g., where the backup controller is on another network) to support the vehicle speed management application, and the controller may apply a higher priority to the vehicle speed message. The utilization of flows and applications to organize the components of the system allows for the same or similar information to be regulated by the controller in a differential manner to support various functions, allowing for improvements in the performance and security of network regulation operations (e.g., reducing unnecessary cross-network traffic, and providing information only as needed), and supports additional functionality relative to previously known systems, such as redundancy support, distributed control, and granular cross-network messaging.

A policy, as utilized herein, includes a description of data to be collected, such as data parameters, collection rates, resolution information, priority values (e.g., ordering data collection values for selection in response to off-nominal conditions where not all data collection parameters can be serviced, etc.). In certain embodiments, a policy further includes event information, which may be stipulated as parameter or quantitative based events (e.g., a given data value exceeds a threshold, etc.), and/or categorical events (e.g., a particular fault code, operational condition or state, or vehicle location/jurisdiction occurs). In certain embodiments, a policy further includes an event response, such as data values to be captured in response to the occurrence of the event, and/or other changes in the data collection scheme such as increased or reduced data collection rates, changes in collected resolution, or the like. In certain embodiments, an event response further includes a time frame associated with the event occurrence, for example a time period after the event occurrence to utilize the adjusted data collection scheme, and/or a time period preceding the event occurrence (e.g., utilizing a rolling buffer or other data collection operation, providing temporary information that can subsequently be captured if the event occurs). In certain embodiments, changes to the data collection scheme for an event can include multiple changes—for example changes over a period of time, further changes based upon the progression of the event (e.g., if the event severity gets worse), and/or criteria to determine that an event is cleared. In certain embodiments, changes to a data collection scheme may be implemented based on event related clearance of the same or another event, for example implementing a data collection change until a next shutdown event of the vehicle, until a service technician clears the event, for a selected number of shutdown events occurs, or the like.

The utilization of a policy herein may reference a partial policy, and/or a parsed portion of a policy, for example the implied policy that would be implemented in response to a single data collection scheme from a single user, wherein the full policy is prepared, verified, and communicated to the vehicle after one or more partial policies are aggregated. The utilization of a policy herein may reference an unverified policy, for example after a policy responsive to a number of users is aggregated, but verification operations of the policy are not yet completed (e.g., before it is determined if the data collection implied by the policy can be performed). The utilization of a policy herein may reference a previously applied policy (e.g., a policy present on a vehicle before an updated version of the policy is communicated to the vehicle and/or implemented on the vehicle). The utilization of a policy herein may reference an updated policy, for example a verified policy that is pending for communication to the vehicle 102 and/or confirmed by the vehicle 102 (e.g., from the data collection controller 202).

Without limitation to any other aspect of the present disclosure, example embodiments of devices set forth throughout the present disclosure, including circuits, controllers, computing devices, modules, engines, configurable switches, configurable gateways, converged network devices, managers, evaluators, creators, applications, and other similar terminology, include any one or more of: any sensor present on the vehicle and/or communicative coupling to any such sensor (e.g., an electrical interface, LIN interface, A/D processing of a sensor signal, etc.); any actuator present on the vehicle and/or communicative coupling to any such actuator (e.g., electrical interface, LIN interface, command interface to the actuator, feedback interface from the actuator, etc.); any controller and/or computing device on the vehicle, cloud server, external device, etc., including processing resources, storage resources, I/O resources, and/or communication resources thereof; instructions stored on a computer readable medium, where the instructions are configured such that a computing device executing the instructions thereby performs one or more operations of the device; and/or access to any one or more of these either directly (e.g., accessing a parameter from a memory value of a controller, inserting a command value into a memory value of a controller, etc.) or indirectly (e.g., accessing a parameter on a network zone of the vehicle, providing a command value to a controller on a network zone of the vehicle, sending requests or commands to a controller of the vehicle, exercising an interface to access parameters, send commands, configure features, sensors, actuators, and/or control operations, etc.).

Descriptions herein referencing fault codes should be understood broadly, and include operations based on: fault code values (e.g., as determined by control operations, provided by relevant devices such as sensors, actuators, etc., and/or as determined from other parameters such as diagnostic algorithms, rationality checks, comparisons to other data values, etc.); fault counters (e.g., managing data used in fault determination, such as incrementing or decrementing counters or the like); a diagnostic value (e.g., an output of a diagnostic operation such as “PASS”, “FAIL”, “SUSPECT”, etc., and/or intermediate values that may indicate a diagnostic operation has a preliminary indication of off-nominal operation even if the diagnostic operation has not yet diagnosed a failure, and/or that may indicate the diagnostic operation has a preliminary indication that an off-nominal operation may be returning to normal even if the diagnostic operation has not yet determined that off-nominal operation has cleared); and/or a diagnostic trouble code (e.g., a parameter utilized to indicate a diagnostic event and/or state, which may be an industry standard code, proprietary code, or any other diagnostic trouble code).

Without limitation to any other aspect of the present disclosure, the term vehicle operating condition as used herein should be understood broadly, and may include a categorical and/or discrete value, such as a state condition (e.g., shutdown, moving, startup, idle, high load operation, low load operation, etc.). Additionally or alternatively, an example vehicle operating condition may be a quantitative and/or continuous value, such as a power throughput level, torque value, vehicle speed, etc.

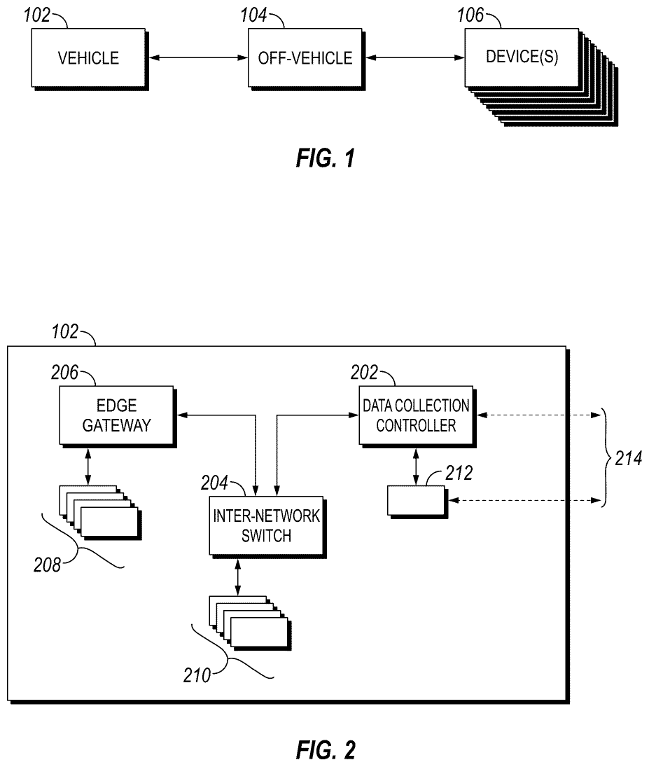

Referencing FIG. 1, an example system is disclosed having a vehicle 102 communicatively coupled to an off-vehicle device 104. The example system includes the off-vehicle 104 device(s) communicatively coupled to one or more user devices 106. For example, the vehicle 102 may include a mixed network having a number of data providing devices coupled to network(s) on the vehicle, for example with one or more devices coupled to a CAN network, and one or more other devices coupled to an ethernet network. The example system allows for users (e.g., application providers, fleet owners, manufacturers, customers, etc.) to access the off-vehicle 104 device, configuring data collection to be implemented from the vehicle 102 to the off-vehicle device 104. In a further example, the system allows for access to at least a portion of the collected data for utilization in an application relating to the vehicle. In certain embodiments, the system provides for authorization control for users and/or applications to ensure that data collection requests are properly made. In certain embodiments, the system provides for data collection control to ensure that requested data communications are achievable, and/or consume reduced data communication resources. In certain embodiments, the system provides for consent implementation to ensure appropriate consent (e.g., from an operator or owner of the vehicle) is provided before relevant data collection is performed. In certain embodiments, the system provides for isolation of specific vehicle information (e.g., data parameter names, communication protocol information, locations and/or ID values of data providers in a mixed network environment of the vehicle) from data requestors and/or users, thereby alleviating the data requestor and/or user from having to learn the specific vehicle information and/or keeping that information updated. In certain embodiments, the system provides for isolation of stored data collected from the vehicle from a system providing requested data to applications utilizing portions of the data. In certain embodiments, the system provides for integrated policy management controlling data collection parameters from a number of simultaneous data requestors, and/or providing enhanced policy management controls to certain users such as policy creators and/or policy controllers. In certain embodiments, the system provides for enhanced policy creation and/or updating, whereby the system communicates with a user in a manner structured to provide the user with high level functionality descriptions, without requiring knowledge from the user about the specific vehicle and/or specific data utilized to support the corresponding high level functionality. In certain embodiments, the system provides for enhanced data communication to and from the vehicle that is responsive to intermittent network access, and/or intermittent network bandwidth availability, to communicate requested data from the vehicle to an off-vehicle device.

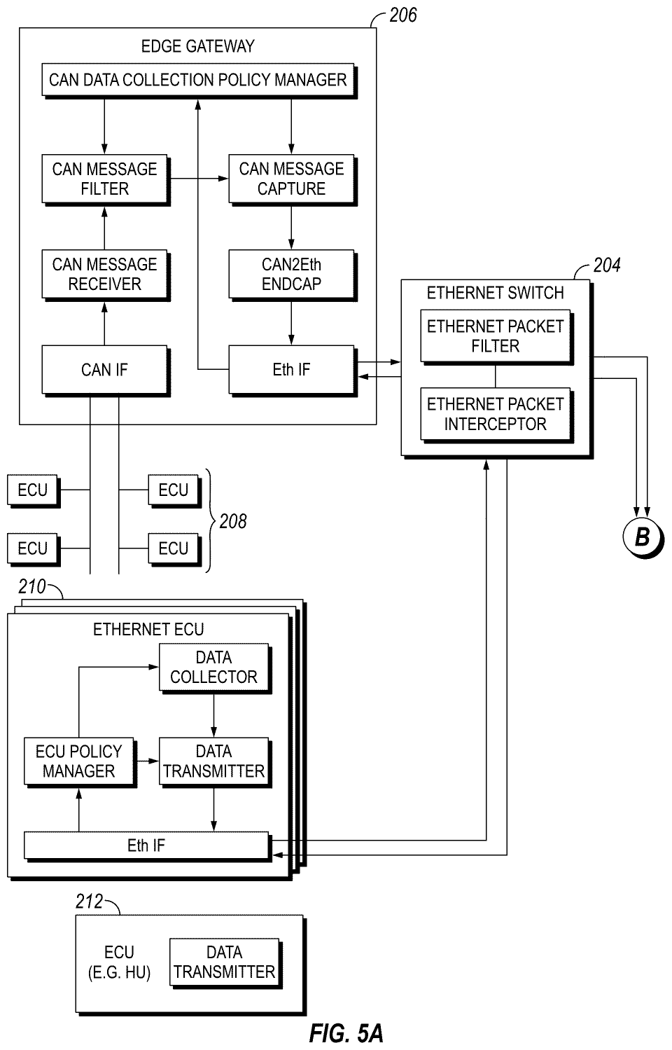

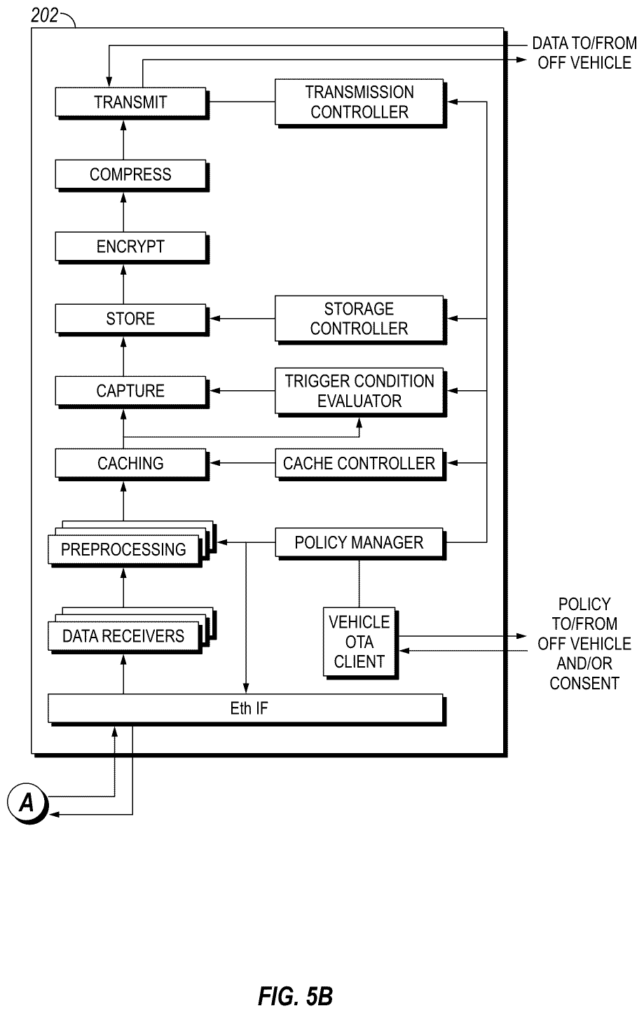

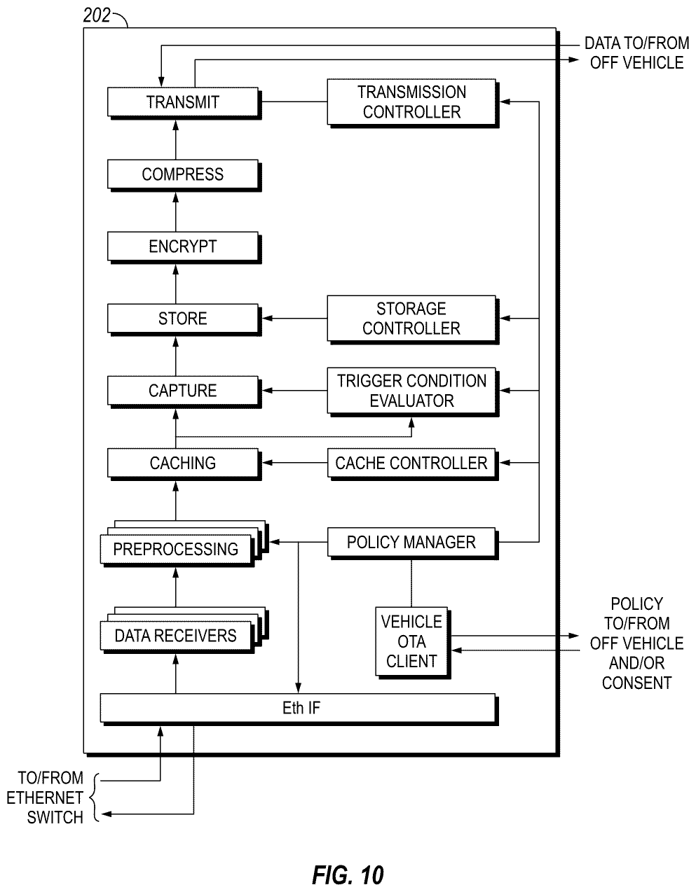

Referencing FIG. 2, an example vehicle 102 is depicted schematically having certain aspects of a data collection system set forth herein. The example vehicle includes a data collection controller 202 that is configured to accept a policy from an off-vehicle device 104, and to propagate functionality in response to the policy to on-vehicle devices to perform appropriate data collection. The example data collection controller 202 further communicates the collected data to the off-vehicle device 104, and/or manages communication in response to intermittent network availability and/or intermittent network bandwidth availability. Certain further and/or more detailed operations of the data collection controller 202 are described in the portion of the disclosure referencing FIGS. 5A, 5B, and 10.

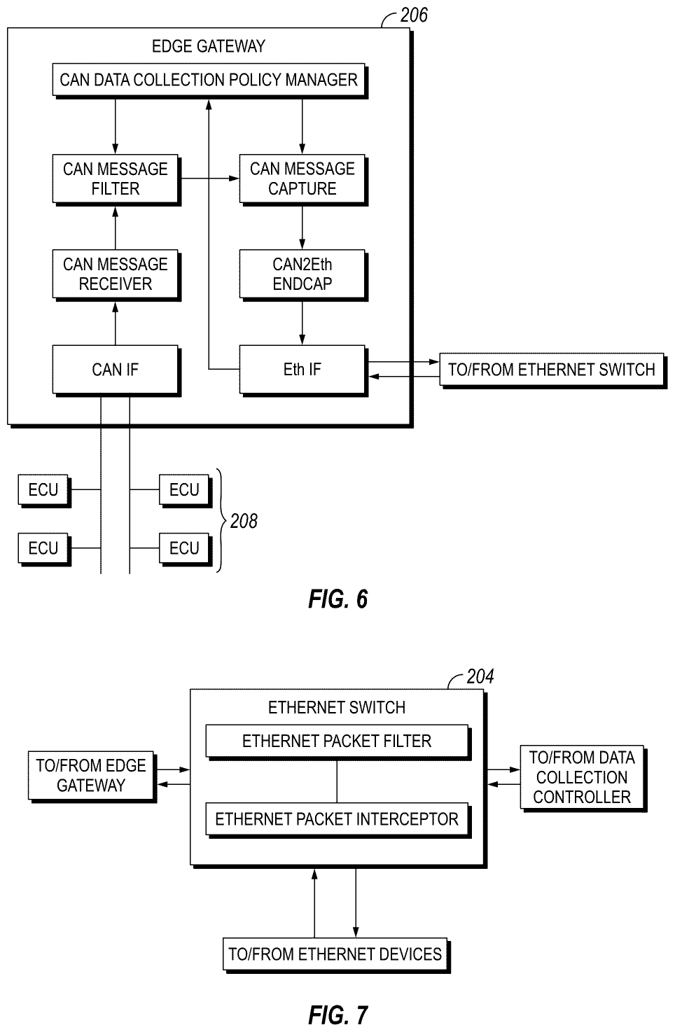

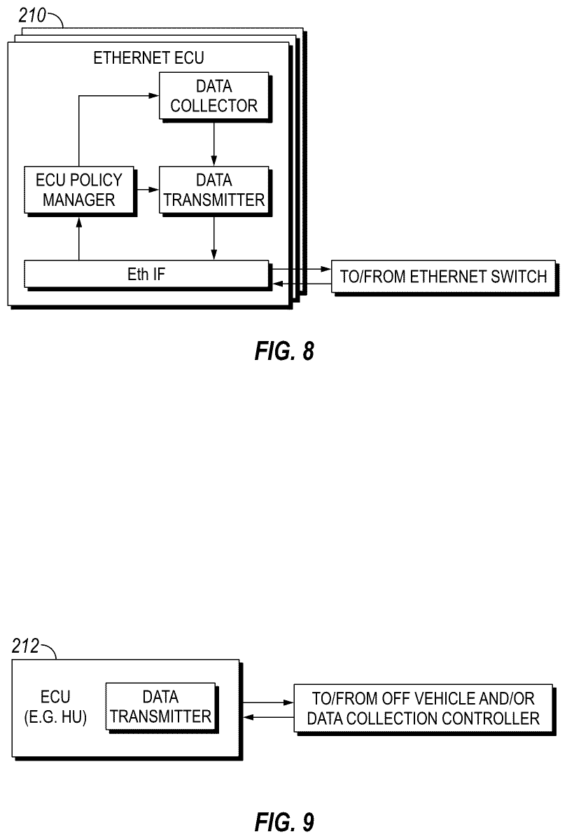

The example vehicle 102 further includes an inter-network switch 204 that is communicatively coupled to at least two networks on the vehicle 102. The example inter-network switch 204 is directly coupled to a number of devices (or end points) 210 on a first network (or network zone), and coupled to a second number of devices (or end points) 208 on a second network (or network zone), for example via communications with an edge gateway 206. Certain further and/or more detailed operations of the inter-network switch 204 are described in the portion of the disclosure referencing FIGS. 5A, 5B, and 7. Certain further and/or more detailed operations of the devices 210 are described in the portion of the disclosure referencing FIGS. 5A, 5B, and 8. Certain further and/or more detailed operations of the edge gateway 206 are described in the portion of the disclosure referencing FIGS. 5A, 5B, and 6.

The example vehicle 102 further includes a user consent controller 212 that is communicatively coupled to the data collection controller 202 and/or to the off-vehicle device 104. In certain embodiments, the user consent controller 212 may be an on-vehicle device such as a vehicle display (e.g., a PAD or console device), and/or the user consent controller 212 may be a mobile application (e.g., a mobile device of the user having a consent application operable thereon), a web-based application (e.g., a web application accessible to the user and relating to the vehicle 102), and/or may include more than one of these. Certain further and/or more detailed operations of the user consent controller 212 are described in the portion of the disclosure referencing FIGS. 5A, 5B, and 9. In the example of FIG. 2, external communications 214 are depicted, which may include communications to the off-vehicle device 104. The external communications 214 may be passed wirelessly (e.g., from an available transceiver on the vehicle and in communication with the data collection controller 202 and/or the user consent controller 212), and/or may be passed through a wired communication (e.g., a service tool, OBD device, or the like coupled to a network on the vehicle, for example as a device 210 in communication with the inter-network switch 204).

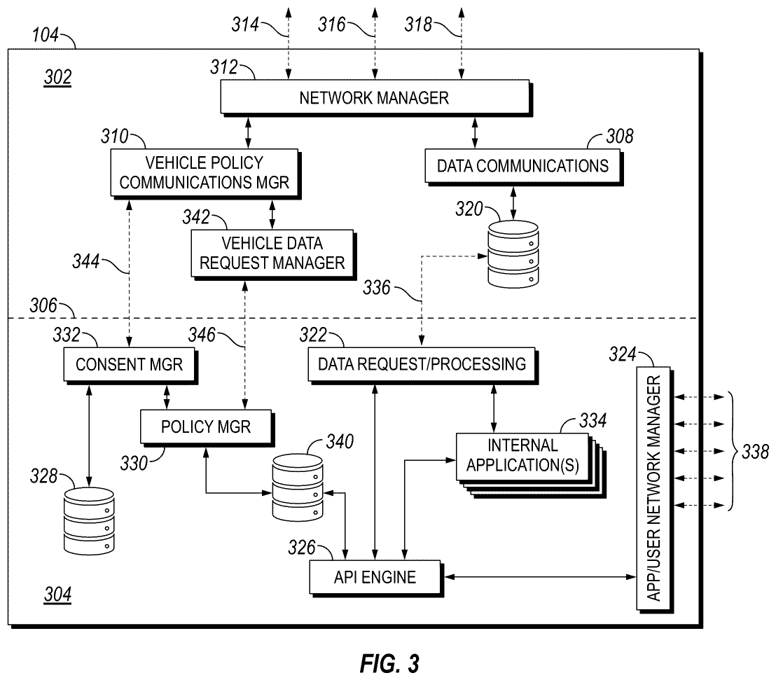

Referencing FIG. 3, an example off-vehicle device 104 is depicted. The example off-vehicle device 104 is depicted schematically as an integrated device having managers and other components depicted thereon to illustrate the interaction of functional elements of the off-vehicle device 104. The off-vehicle device 104 may be a distributed device, having aspects present on a number of controllers, transceivers, servers, or the like. In certain embodiments, the off-vehicle device 104 may be implemented at least partially as a cloud-based device, for example utilizing or communicating with a web-based and/or cloud-based service, such as Amazon Web Services (AWS), Microsoft Azure web services, Cloudflare network services, or the like. In certain embodiments, aspects of the off-vehicle device 104 may be segregated and/or distributed across more than one service, dedicated server, and/or computing device. In the example of FIG. 3, a first partition 302 performs certain operations of the off-vehicle device 104, and interfaces with a second partition 304 that performs certain other operations of the off-vehicle device 104. The example of FIG. 3 depicts a partition 306, where communications across the partition 306 may be configured to an interface specification or other agreed upon or implemented communication scheme.

The example partition 302 includes a network manager 312 that performs load management functions and manages communication with the vehicle 102. The example of FIG. 3 depicts policy communications 316, consent communications 314, and data communications 318 that are at least intermittently communicated with the vehicle 102. The example network manager 312 interfaces with a data communications 308 component, for example passing vehicle data received to the data communications 308 component. The example network manager 312 interfaces with a vehicle policy communications manager 310, for example receiving data collection policies, policy updates, and/or providing consent communications between the vehicle policy communications manager 310 and the vehicle 102. In certain embodiments, the vehicle policy communications manager 310 receives processed policies from a policy manager 330 (and/or from a vehicle data request manager 342) on the second partition 340, makes the policy available to the vehicle 102, and/or determines the timing of when to communicate the policy to the vehicle.

The example vehicle data request manager 342 determines data to be collected in response to a policy provided by the policy manager 330. In certain embodiments, a policy includes a number of data requests from users (e.g., devices 106 and/or internal applications 334), and the vehicle data request manager 342 aggregates the requested data into a set of specific parameters for data collection that meet the data collection needs of all data requests in the policy. In certain embodiments, the policy manager 330 and/or the vehicle data request manager 342 perform policy verification, ensuring that a given policy can be supported (e.g., the requesting user is authorized, the parameter is available on the vehicle, and/or the aggregated data collection to meet the policy can be achieved within the bandwidth limits available) before the vehicle data request manager 342 provides the data requests to the vehicle policy communications manager 310. In certain embodiments, the aggregated data collection set is stored in a data structure, such as an XML structure, a JSON data structure, an HTML data structure, or other selected data structure. In certain embodiments, the aggregated data collection set, including the relevant data structure, comprises the policy to be sent to the vehicle 102. In certain embodiments, the data structure to be sent to the vehicle 102 includes other information, such as event descriptions, priority information, and/or response information to off-nominal conditions such as intermittent network availability, as a part of the policy.

Embodiments of the present disclosure provide for systems, apparatuses, and methods for providing a service oriented architecture (SOA) and management of SOA features and functions. SOA embodiments herein are capable to support multiple types of services, such as data services and/or functional services. SOA embodiments herein are capable to support multiple types of service participants, including without limitation manufacturers, original equipment manufacturers (OEMs), customers, operators, owners, service personnel, fleet managers (e.g., service, dispatch, compliance, etc.), SOA service requestors, SOA service providers, and/or third-party applications. Embodiments herein are capable to support SOA operations over multiple networks, including one or more vehicle networks, vehicle networks having mixed network types, external networks, and/or cloud based networks. Embodiments herein are capable to support multiple network protocols, including for devices or participants as SOA service providers and/or SOA service requestors, including at least SOME/IP, MQTT, HTTP, CAN, LIN, FlexRay, MOST, TTP, and/or LVDS network protocols. Embodiments herein are capable to support reliable, secure, and convenient SOA service implementations, including service discovery, recovery, maintenance, and/or updates to available services provided and/or requested.

An example policy, as utilized herein, includes a policy provided by an external device that requests a vehicle to collect a set of data over a defined period of time, or short period of time, and to send the data back to the external device. The data may be sent back to the external device within a defined time period stated in the policy, and/or according to a default time period for such policy operations, and may include sending the data back to the external device as soon as the collection of the data is complete. The example policy may be deleted, removed, or otherwise considered complete after the data collection event, and/or after a successive number of data collection events. Such a policy may be referenced as an ad hoc policy, a one-time policy (which may include one or more finite data collection events), an impromptu policy, a single-use policy, an emergency policy, or the like. Example uses of such a policy include rapid response data collection (e.g., handling for an emergency event; information collection to prepare for an update, campaign, or other planned change to a number of vehicles; collection of a data set for training a model or an artificial intelligence component; and/or data collection under any circumstance where the use of the data is expected to be performed within a finite period of time, and ongoing data collection for the policy is not desired).

An example policy, as utilized herein, includes a policy provided by an external device that requests the vehicle to collect a set of data over an extended period of time, and/or on an ongoing basis, where the collected data is sent back to the external device periodically and/or intermittently at intervals that allow for improved utilization of bandwidth by selecting transmission times and/or allowing for compression operations on the data to reduce communicated data volumes. The example policy may be kept for a defined period, kept until removed by the external device, and/or kept until an event occurs (e.g., a research data collection operation, where the event is configured to establish that the vehicle is no longer relevant to the research). The defined period and/or event parameters to delete the policy may be defined within the policy. Example uses of such a policy include research projects, continuous improvement projects (e.g., development of diagnostic or prognostic algorithms for a vehicle or a related group of vehicles, continuous improvement of operational algorithms, etc.), ongoing analysis projects (e.g., analyzing a large data set to detect trends, changes within a related group of vehicles, and/or verify that a change to the related group of vehicles is having an expected effect), and/or projects where a time constant of the project output is long relative to data rates typically received from low utilization data transmission operations. Such a policy may be referenced as a research policy, an analysis policy, a non-urgent data policy, or the like.

An example policy, as utilized herein, includes a policy provided by an external device that requests a vehicle to collect a set of data over an extended period of time, and send the data back to the external device the vehicle as the data is collected, in defined data blocks as each data block is collected, and/or in a streaming fashion. The example policy may be kept for a defined period, kept until removed by the external device, and/or kept until an event occurs (e.g., a change in an algorithm or process utilizing the data, where the data utilized by the algorithm or process changes, where the algorithm or process is discontinued, where the algorithm or process is replaced by an updated algorithm or process, or the like). The defined period and/or event parameters to delete the policy may be defined within the policy. Example uses of such a policy include real-time monitoring of vehicle conditions, implementation of diagnostic or prognostic algorithms for a vehicle or a related group of vehicles, and/or projects where a time constant of the project output is short enough that low utilization data transmission operations are not sufficient to support the project, or to support the project with acceptable performance. Such a policy may be referenced as a real-time monitoring policy, an urgent data policy, an immediate data policy, or the like.

The first partition 302 further includes a data store 320, which may be a raw data store that stores the data provided by the data communications 308 component, the data store 320 keeps the data segregated from the second partition 304 until the collected data is requested, thereby segmenting the risk incurred from data storage. For example, the first partition 302 may be controlled by and/or operated by a first entity, and the second partition 304 may be controlled by and/or operated by a second entity, whereby the partition 306 segments the risk associated with the data storage. In certain embodiments, the data store 302 stores the data in an encrypted format, which may further be configured such that the first entity operating the first partition 302 cannot access the data values of the stored data. In certain embodiments, the data store 302 stores the data associated with metadata values, such as vehicle information, time stamps, data category descriptions, or the like, such that appropriate data can be supplied responsive to a data request by the data request/processing 322 component.

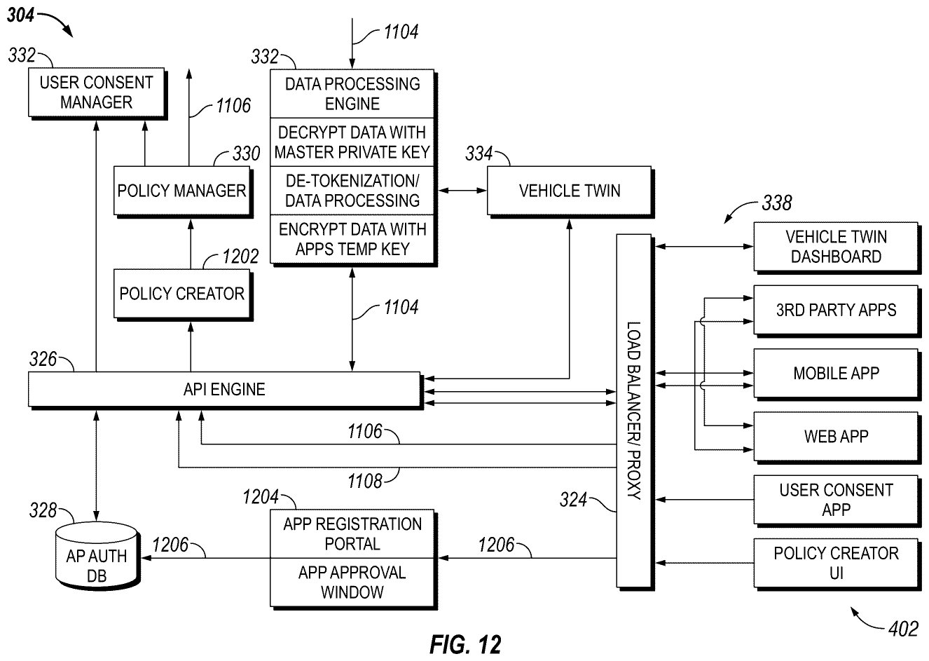

The example second partition 304 further includes a consent manager 332 that determines whether consent for data values in a policy are required, and communicates with the user consent controller and/or a consent application 402 (reference FIG. 12) to request and receive consent values. In certain embodiments, an application authorization data store 328 is utilized to store consent information, such as consent confirmations for a current policy, pending policy, or the like. The application authorization data store 328 may further be utilized to determine policy aspects (e.g., data parameters, sampling rates, event values, and/or use case values) that are authorized for access by specific users, user roles, applications 402, and/or in accordance with other authorization schemes to be utilized.

The example second partition 340 further includes a policy manager 330 that receives inputs from users and/or applications to determine a requested policy, policy update, policy change, or the like. In certain embodiments, the policy manager 330 interfaces with user devices 106, external applications 402, and/or internal applications 334 via an API engine 326 to determine the requested data collection, events, priorities, etc. to be utilized in determining the policy. In certain embodiments, a user or application may provide a requested policy as a data structure to the policy manager 330, for example a formatted data XML, JSON, HTML, or other data structure that includes formatted descriptions of the requested policy elements.

In certain embodiments, the policy manager 330 provides a user interface to a user or application to provide for rapid, convenient, and/or reliable formatting for policy requests. For example, the policy manager 330 interfacing with an application or user may provide a list of data elements, predetermined event values, and/or predetermined response values, that are available in the system. In certain embodiments, the list may include interface elements such as dropdown lists, check boxes, or other interfaces allowing for rapid selection of requested elements, and ensuring proper formatting of the requested elements. In certain embodiments, user and/or application authorization of requested elements may be performed during construction or entry of the requested policy elements-for example the policy manager 330 may hide unauthorized elements, display unauthorized elements in an alternative format (e.g., grayed out), and/or provide an alert or notification that an unauthorized element is presently contained within the requested policy elements. In certain embodiments, the policy manager 330 may allow unauthorized elements into the policy request (and/or omit pre-screening of authorization), where the policy manager 330 will reject creation of a policy based on the policy request if unauthorized elements are still present at a time of verifying an integrated policy for updating (e.g., integrating a number of policy requests from various users and/or applications into an integrated policy). In certain embodiments, the policy manager 330 may notify a user or application (e.g., a policy creator, policy controller, a super-user, or the like) that a verification of a policy request has failed, whether due to inclusion of an unauthorized data request, due to excessive communication bandwidth requirements, or otherwise. In certain embodiments, the policy manager 330 may identify which element of the policy request caused the verification failure, and/or may provide the notified user or application with options, such as a communication to the user or application making the unauthorized request, an option to authorize the unauthorized request, or the like.

In certain embodiments, operations of the policy manager 330 include operations to compile a number of policy requests from users and/or applications (internal or external) into an integrated policy structure. In certain embodiments, the policy manager 330 (and/or the vehicle data request manager 342) provides the integrated policy structure as a super-set of the data requests (e.g., consolidating data requests for a given parameter), and may further consolidate event requests and/or event responses where those consolidation operations can be made consistent with achieving the events and responses within the individual policy requests. In certain embodiments, the policy manager 330 may include consideration of the data super-set in determining event responses—for example where an event is requesting data to be taken in response to an event, but the data is already being collected for another request within the policy, the event may be omitted and/or the data collected may be reduced to account for the availability of the data.

In certain embodiments, the policy manager 330 includes operations to verify the integrated policy structure, for example to ensure that users and/or applications are only requesting authorized data, to ensure that data parameters requiring consent have the consent available (and/or communicating the consent requirement to the consent manager 332 for appropriate action), and/or to ensure that network bandwidth capabilities of the vehicle, data storage capabilities of the vehicle, or other parameters can meet the requirements of the integrated policy structure. In certain embodiments, the policy manager 330 keeps an updated “live” verification, for example verifying a potential integrated policy structure as policy requests are received from users and/or application. In certain embodiments, the policy manager 330 performs a verification upon request, for example by a policy creator, which may be performed as a “build” of a policy or policy update. In certain embodiments, the policy manager 330 utilizes a default policy, for example when a vehicle is first manufactured.

In certain embodiments, after the policy is verified, the policy manager 330 may communicate the policy to the vehicle policy communications manager 310 for communication to the vehicle 102. Additionally or alternatively, the policy manager 330 may communicate the policy to the vehicle policy communications manager 310 in response to a request from a policy creator, super-user, or other authorized system user.

In certain embodiments, the policy manager 330 or other system components may access a policy data store 340, which may include previously verified policies, legacy policies, one or more default policies, and/or GUI parameters such as common names for data elements, user role descriptions, application role descriptions (e.g., a set of event values, event responses, and/or data values available based upon an application role such as OEM, Manufacturer, 3^{rd} part, etc.), example event values and/or event responses, and/or vehicle data (e.g., nominal bandwidth descriptions, storage information, etc.).

In certain embodiments, the policy manager 330 provides a high level description to a user or application, which in certain embodiments may be referenced as a “use case.” A use case may include one or more data collection elements, such as a group of parameters to be collected, and/or may further include one or more associated events and/or event responses. The selection of the use case can thereby be utilized to quickly build a policy request having predetermined information therein. The use case presented to the user may be stored in the data store 340, and/or may depend upon the role and/or authorizations of the user and/or application. In certain embodiments, a use case may have an identifiable or common name, such as “routing application use case,” “passenger car standard use case,” “delivery vehicle use case,” etc. The data store 340 may have default use cases available, and/or may include use cases created or constructed, and/or made available by a policy creator, policy controller, super-user, or the like. In certain embodiments, a user and/or application may have the capability to build a policy request, and save the request as a use case for future implementation as a template, baseline group of data collection parameters, or the like. In certain embodiments, verification operations of the policy manager 330 may utilize the use case (e.g., utilizing a pre-determined value that for a given vehicle, user, application, or the like, that a use case is authorized or unauthorized), and/or verification operations of the policy manager 330 may evaluate the individual elements populated in response to the use case for verification. In certain embodiments, the data values populated by the use case may be displayed to the user and/or application, or may be hidden from the user and/or application.

The example second partition 304 further includes one or more internal applications 334—for example applications created or implemented by an operating entity associated with the second partition 304. The example second partition 304 further includes an application/user network manager 324, for example that performs load balancing operations, and provides communications to and/or receives communications from external applications using a communication interface 338. In certain embodiments, the application/user network manager 324 performs operations to implement a user interface or graphical user interface with external users and/or applications.

The example off-vehicle device 104 implements consent communications 344, policy communications 346, and/or data communication 336 to manage communication between the partitions 302, 304. The communications 344, 346, 336 may include standardized interface and/or protocols, for example such that a given partition 302, 304 can be operated independently from updates or changes to the other partition.

The example of FIG. 3 depicts two partitions 302, 304, although in certain embodiments the off-vehicle device 104 may be an integrated device, and/or aspects of the partitions 302, 304 may have additional partitions, and/or a different distribution of components between partitions.

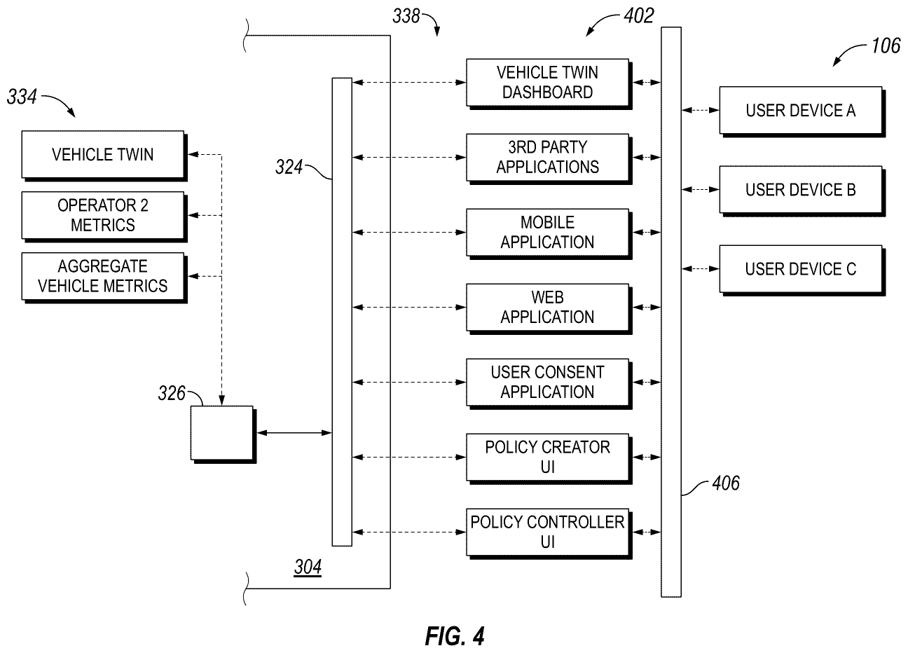

Referencing FIG. 4, example internal applications 334 and/or external applications 402 are depicted. The present disclosure is not limited to the depicted applications, and a given application may be provided as an internal application 334 or an external application 402. The example of FIG. 4 depicts a number of user devices 106, which may be communicatively coupled to the system through a network interface 406, which may include one or more aspects such as an internet connection, a mobile communication interface, a proprietary network interface, or the like. A given user device 106 may interface with one or more applications 402, and a given application 402 may interface with one or more user devices 106. In certain embodiments, an application 402 may be operated without an interfacing user device 106 (e.g., a data scraper, AI component, or the like), and/or may be operated selectively interfacing with a user device 106 at certain times or operating conditions, and operating independently of a user device 106 at other times or operating conditions.

Referencing FIGS. 5A and 5B, an example vehicle network infrastructure for a vehicle 102 is schematically depicted. The example vehicle 102 includes an ethernet switch in communication with a number of ethernet based devices (e.g., sensors, actuators, and/or controllers in communication with an ethernet network), an edge gateway device (e.g., interacting with a second network such as a CAN or second ethernet network, and providing parameters to the first network or ethernet network), a data collection controller, a number of ethernet devices, and a user consent controller.

Referencing FIG. 6, an example edge gateway 206 is depicted. The example Edge Gateway 206 includes a CAN data collection policy manager, which receives data collection commands from the data collection controller. The CAN data collection policy manager instructs CAN data collection from CAN devices 208 to support the data collection commands, and provides ethernet communication parameters to the ethernet switch to support the data collection. The utilization of the Edge Gateway 206 supports mixed network operation, and in certain embodiments allows the off-vehicle device 104 to operate without requiring knowledge of which devices are present on the CAN, ethernet, or other network. The example Edge Gateway 206 further includes CAN processing components, such as a CAN IP component that interprets CAN addresses of respective CAN components 208, a CAN message receiver that interprets CAN messages to determine the data values therein, and CAN message filter that supports, for example, down sampling of CAN messages to reduce network traffic within the vehicle network while supporting the policy. For example, if a parameter is provided on the CAN at a 20 ms rate, but the policy requires only a 1 sec sampling rate for the parameter, then the CAN message filter can expunge excess sampling of the message. In certain embodiments, other components may perform down sampling in addition to, or instead of, a CAN message filter. For example, the ethernet switch and/or the data collection controller may perform appropriate down sampling. The location of the down sampling may depend on the specifics of the policy (e.g., if a parameter may occasionally be sampled faster due to an event, then the CAN message filter may provide data at the highest rate that could be required, allowing another component to down sample when the higher rate is not required, and/or the CAN message filter may be responsive to the event, down sampling appropriately based one the circumstances). The example CAN Gateway 206 additionally includes a CAN message capture, for example passing the CAN sampled data and/or buffering the CAN sampled data until it is passed. The example CAN Gateway further includes a CAN2Eth Encap component, that encapsulates the captured CAN message into an ethernet message (e.g., including leading and/or trailing message data, and/or packaging one or more of the CAN messages into a single ethernet packet). The example CAN Gateway further includes an Eth IP component, which communicates the encapsulated CAN messages to the appropriate address on the ethernet network. In certain embodiments, messages are passed in both directions, for example allowing the CAN data collection policy manager to receive appropriate portions of the current policy, allowing the Edge Gateway to receive event data indicators (e.g., than a given event has occurred), and the like. In certain embodiments, a mixed network may include different network types than a CAN-ethernet mix, and/or may include networks with distinct protocols (e.g., packet sizes, leading/trailing bits, etc.), where the Edge Gateway includes appropriate components therefore.

Referencing FIG. 7, an example ethernet switch 204 is depicted. The example ethernet switch 204 includes an ethernet packet filter component, for example to perform down sampling and/or to reject un-needed packets (e.g., data responsive to an event provided by an ethernet device and/or the Edge Gateway during an operating period where the event is not active) and an ethernet packet interceptor. The example ethernet packet interceptor retrieves selected data from the ethernet network. In certain embodiments, the ethernet switch 204 performs operations such as port switching or other routing operations. The example ethernet switch 204 is in communication with the data collection controller 202, the Edge Gateway 206, and one or more ethernet devices 210.

Referencing FIG. 8, an example ethernet device 210 is depicted. In certain embodiments, the ethernet device 210 manages policy implementation relevant to the specific device, for example utilizing an ECU policy manager (electronic control unit) that determines data transmission values responsive to the policy, including data rates, resolution, and/or data response to events. In certain embodiments, the ECU manager performs event detection (e.g., reading ethernet parameters and determining whether the event is active). In certain embodiments, the ECU manager receives an event status, and manages only the data transmission requirements responsive to the event status. The ethernet device 210 further includes a data collector, which may down sample, adjust resolutions of data values, and/or provide multiple data values (e.g., within a packet, and/or time stamped for later matching in the data collection controller 202 and/or off-vehicle device 104). The example ethernet device 210 further includes a data transmitter that provides packets to an Eth IP, where the Eth IP manages addressing, sending, and/or receiving of associated packets. The example ethernet device 210 may be associated with a specific component, for example controlling ethernet communications responsive to the policy for the associated component. Additionally or alternatively, the ethernet device 210 may be a part of the component (e.g., managing ethernet communications for the component that may be in addition to the data collection aspects supporting the policy) and/or may be a part of a controller associated with the component. The example ethernet device 210 is in communication with the ethernet network, and/or the ethernet switch 204.

Referencing FIG. 9, an example user consent controller 212 is depicted. The user consent controller 212 may be a part of, and/or may be associated with, an on-vehicle user input device such as a console (e.g., a touch screen interface) accessible to the vehicle operator. In certain embodiments, the user consent controller 212 may be omitted, and/or may be in another part of the system, for example as an application for a mobile device, a web portal or other interface for a connected device, or the like. For example, where the owner of the vehicle and/or associated data is separate from the operator, and/or for the convenience of the operator, an alternate interface may be provided for consent communications. In one example, an operator utilizes a mobile device having an application installed thereon for performing consent operations, for example having a login or authentication operation that confirms the association with the vehicle. In another example, an owner or agent having authority accesses an application or web portal-for example a fleet manager having a web based access on a computing device and/or a mobile application associated with the vehicle. In certain embodiments, user consent can be provided for multiple vehicles within a single interface (e.g., a web application listing a group of vehicles) and/or with a single action (e.g., approving a policy update for a selected group of vehicles). In certain embodiments, a user consent application (e.g., reference FIG. 4) may be used in conjunction with, or as an alternative to, the user consent controller 212.

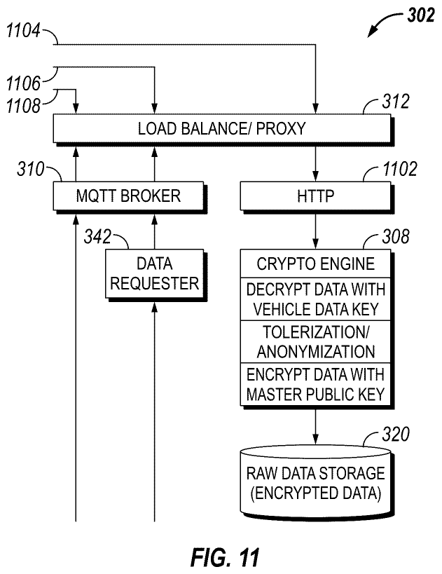

Referencing FIG. 10, an example data collector controller 202 having a number of components thereon, and configured to functionally execute operations of the data collector controller 202 is schematically depicted. The data collector controller 202 includes a vehicle OTA client (over the air) that receives policy updates, policies, and/or policy notifications from the off-vehicle device 104. The example vehicle OTA client communicates the policy, policy update, and/or policy notification to the policy manager. In certain embodiments, the policy may be provided from the off-vehicle device 104 through an MQTT broker (reference FIG. 11), allowing for the vehicle 102 to subscribe for policy updates, and to receive immediate notification that an updated policy is available, without requiring that the full policy be communicated to the vehicle 102 until the vehicle 102 is in a condition to receive and/or implement the policy. In certain embodiments, the policy manager may download a policy update and store it for later implementation. In certain embodiments, the policy manager may command a download of the policy only when the vehicle 102 is in a condition to implement the policy (e.g., during a shutdown operation, during steady state operation, or the like).

The example policy manager verifies the policy, for example performing checks based on vehicle specific information that may not be available to the policy manager 330 on the off-vehicle device 104, to ensure the policy can be implemented. For example, if the policy requires data collection from device that is not present, requires network traffic (on either network of the vehicle, through the ethernet switch, or at some other component of the vehicle network) that is not possible or otherwise not compliant with the requirements of the vehicle, and/or requires a type of information that the vehicle 102 cannot provide (e.g., a sampling rate and/or resolution that is not available), the policy manager may reject the policy and/or provide a notification to the off-vehicle device 104 that the policy was rejected. In certain embodiments, the policy manager may be configured to partially implement the policy, for example implementing higher priority data collection elements from one part of the policy and rejecting other lower priority data collection elements, and/or replacing part of a currently implemented policy having a lower priority than a high priority portion of the updated policy. However, in certain embodiments, the policy controller may be configured to either accept or reject a new or updated policy in the whole. In certain embodiments, for example where the policy manager is not able to fully comply with a new or updated policy, the policy manager may be configured to communicate information about the partial implementation of the policy to the off-vehicle device 104 (e.g., a flag indicating only partial compliance, and/or further information such as which parameters are not being serviced, and/or a level of service available or being provided instead).

In certain embodiments, the policy manager parses the policy elements and communicates relevant elements to policy managers throughout the system (e.g., to the Edge Gateway, ethernet switch, ethernet devices, and/or other components with the data collection controller 202 as described following). The example data collection controller 202 includes data receiver component(s) that receive data responsive to the policy (and/or planned for response if an event condition is detected) from the ethernet network (e.g., utilizing an Eth IP component) and/or other components on the vehicle 102 (e.g., from the user consent controller). The data receivers provide the data to a pre-processing component, which may determine virtual sensor or modeled values, adjust data sample rates (e.g., performing filtering operations), adjust resolution values, and the like. In certain embodiments, the pre-processing component may perform certain operations that support event detection, such as determining secondary state values that inform the event status determination, reject or tag data based on fault codes present, or the like.

The example data collection controller 202 includes a caching component that performs short-term data storage, for example to allow for parameter processing, and/or to support information capture such as rolling buffers where an event may trigger short-term past data recovery (e.g., a trigger indicating an accident, a component failure, or the like where past data is desirable when the event is detected). The example caching component may be responsive to commands from cache controller, which may receive parsed caching instructions to support the policy, and/or may adjust caching operations in response to the current operating conditions of the vehicle 102. In certain embodiments, the size of the cache and/or other available storage may affect the ability of the data collection controller 202 to meet the requirements of a policy. For example, where numerous events in the policy provide for significant consumption of cache memory, the policy manager may determine that the current configuration of the vehicle 102 cannot meet the policy. In certain embodiments, for example where multiple part numbers of the cache component having distinct cache sizes are present within a group of vehicles, and/or where a vehicle specific condition is present (e.g., a portion of the cache memory is failed or otherwise unavailable), the policy manager having superior information about the specific vehicle relative to the policy manager 330 on the off-vehicle device 104, may make a determination that the policy cannot be verified where the policy manager 330 approved the policy. In certain embodiments, the trigger condition evaluator receives parsed information from the policy manager indicating event detection criteria, and the trigger condition evaluator determines which event conditions are present in response to the event detection criteria and the cached and/or captured data. In certain embodiments, event detection may be performed in other components as described throughout the present disclosure, such as at the Edge Gateway policy manager and/or at the Ethernet device policy manager. In certain embodiments, the policy manager of the data collection controller 202 determines which device has sufficient information available to fulfill operations of the event detection, and provides parsed elements of the policy to the appropriate component. Accordingly, in certain embodiments, the trigger condition evaluator may reference a state value indicating whether a given event condition has occurred, rather than perform a direct detection of the parameters utilized to determine whether an event has occurred. In certain embodiments, one device may perform primary event detection, and another component (e.g., the trigger condition evaluator) may perform a secondary detection of the same event, for example providing a system that is responsive to detect an event when a primary sensor indicating the event has failed, but a backup sensor to detect the occurrence of the event.

The example data collection controller 202 includes a capture component that provides the parameters for storage. In certain embodiments, the capture component is responsive to commands from a trigger condition evaluator, for example indicating that a trigger condition (event) is active, and may pull further information from the caching component (e.g., buffered values available in the cache) to support the implementation of the policy. The example data collection controller 202 includes a storage component that stores the captured data for transmission to the off-vehicle device 104. An example storage component utilizes non-volatile memory, such as FLASH memory, allowing for stored data that has not been transmitted to be saved in the event of power loss. The example data collection controller 202 includes a storage controller that provides storage commands for the storage component to support implementation of the policy, and/or to support specific operating conditions of the vehicle 102, such as intermittent loss of network communication to the off-vehicle device 104 and/or intermittent ability to communicate data to the off-vehicle device 104 (e.g., where higher priority resources are utilizing available bandwidth, and/or where data communication limits exist, such as a data plan limitation). In certain embodiments, storage of data collection parameters is performed until the store component is full, wherein some of the data is purged (e.g., oldest data, lowest priority data, and/or least utilized data). For example, if a first data element supports numerous policy requests, and another data element supports only a single policy request, the storage controller may be configured to keep the data that meets the higher percentage of the available policy requests. In certain embodiments, data element correspondence to various policy requests is not available at the data storage controller 202, and other criteria are utilized to determine which data will be purged or expired. In certain embodiments, a portion of the data to be purged may additionally or alternatively be compressed and/or summarized to reduce utilization of the storage. In certain embodiments, a portion of the data to be purged may be down sampled to reduce utilization of the storage. In certain embodiments, the amenability of certain data elements to compression, summarization, and/or down sampling (amenability may include required consumption of processing power, descriptive value of the data in a compressed, summarized, or down sampled format for the underlying data, or similar considerations) may be considered in determining the commands from the storage controller in response to a full (or filling) storage component. In certain embodiments, commands to compress, summarize, and/or down sample data in response to a full or filling storage component may be provided as a part of the policy, and/or the policy may further includes instructions for techniques to be utilized for the compression, summarization, and/or down sampling of data when indicated. In certain embodiments, the policy may further include thresholds (e.g., storage value thresholds, time remaining until storage is full, etc.) indicating when storage purging, compression, summarization, and/or down sampling operations are to be performed.

In certain embodiments, the storage controller is configured to support cache operations by utilizing a portion of the storage available on the storage component. In certain embodiments, the storage controller may be configured to determine an amount of storage than can be utilized based on historical information such as usage fractions of the storage component over time, and/or network availability to transfer collected data to the off-vehicle device 104. In certain embodiments, storage support for the caching component may be defined within the policy. In certain embodiments, storage support for the caching component may not be utilized. In certain embodiments, the availability of storage support for the caching component may be considered by the policy manager in operations to verify the policy.

In certain embodiments, the data collection controller 202 includes an encryption component configured to encrypt data to be transmitted to the off-vehicle device 104. In certain embodiments, the data collection controller 202 includes a compression component configured to compress data to be transmitted to the off-vehicle device 104. The compression may be lossy or lossless compression, and the compression type may be determined according to the type of data, the descriptive value of the data after compression, and/or may be determined by the policy. The data collection controller 202 further includes a transmit component configured to transmit collected data to the off-vehicle device 104, and a transmission controller component to configure the transmission, for example to support selected data protocols, to mediate between competing transmission resource of the vehicle 102 (e.g., comparing relative data priority to other transmission elements, scheduling transmission according to a data plan, vehicle operating condition, and/or to support a virtual channel utilized on a transceiver). In certain embodiments, the transmission controller is responsive to parsed elements of the policy indicating data plan values (which may differ between specific data elements—for example where a first data element is associated with a first requestor having a first data plan, and where a second data element is associated with a second requestor having a second data plan), transmission priorities, and/or vehicle operating conditions related to any of the foregoing.

Referencing FIG. 11, an example first partition 302 is depicted having a number of components configured to functionally execute operations of the first partition 302. The example first partition 302 includes a load balancing/proxy controller 312 (e.g., a network manager) configured to communicatively interact with the data collection controller 202. The example load balancing/proxy controller 312 interacts utilizing policy communications 1106, consent communications 1108, and data communications 1104 between the vehicle 102 and the off-vehicle device 104. The communications 1104, 1106, 1108 include primary data communications, authentications, confirmations, and the like.

The example first partition 302 further includes an http component 1102 configured to package the received data into a selected data structure (e.g., http for the example of FIG. 11) for storage. The example first partition 302 further includes a data communications component 308 configured to package the data for storage, and may further include a crypto engine that decrypts the received data (e.g., utilizing a temporary vehicle key), a tokenization/anonymization component that recoverably replaces sensitive data with a token, and an encryption component that encrypts the data with a master public key (e.g., where the data request/processing component 322 has the master private key), such that the first partition 302 cannot access the data values. In certain embodiments, the data communications component 308 associates metadata with the stored data such that a request from the data request/processing component 322 can be answered with the corresponding data. The example first partition 302 stores the data into a raw data storage 320 for access, as authorized, by internal applications 334 and external applications 402.

The example first partition 302 further includes an MQTT broker that publishes an updated policy, such that subscribing devices (e.g., a data collection controller 202) receive a notification that an updated policy is available. In certain embodiments, the first partition 302 may push updated policies to a vehicle 102, and/or the vehicle 102 may periodically request whether a policy update is available, and/or request policy updates in response to certain events (e.g., certain operating conditions, service events, network availability events, etc.).

Referencing FIG. 12, an example second partition 304 includes a policy creator component 1202, for example to perform operations to compile, implement, create, and/or store policies for utilization in the system. In certain embodiments, the policy creator component 1202 is further configured to roll out policy updates, for example updating a policy to a small number of vehicles before sending the policy update to a larger number of vehicles. The example second partition 304 further includes the data request/processing component 322 having a data processing engine that decrypts received data from the first partition 302 utilizing a master private key, a de-tokenization component that restores tokenized information within the received data, and an encryption component that re-encrypts the data with a temporary key for sharing of the data with an application and/or user device requesting the data (if authorized). The example of FIG. 12 includes an internal application 334 such as a vehicle twin application being operate for a corresponding vehicle 102, and a number of external applications 402, such as a vehicle twin dashboard, a 3^{rd} party application (of any type), a mobile application, a web based application, a user consent application, and/or a policy creator user interface.

The example second partition 304 further includes an application registration portal, and an application approval workflow component (together—1204) that interfaces with applications and proposed applications to ensure proper authorization, enforce application standards, and the like. The application registration portal, and the application approval workflow component 1204 further interact 1206 with the application authorization database 328 to record application registrations, and ensure authorization of accessing applications.

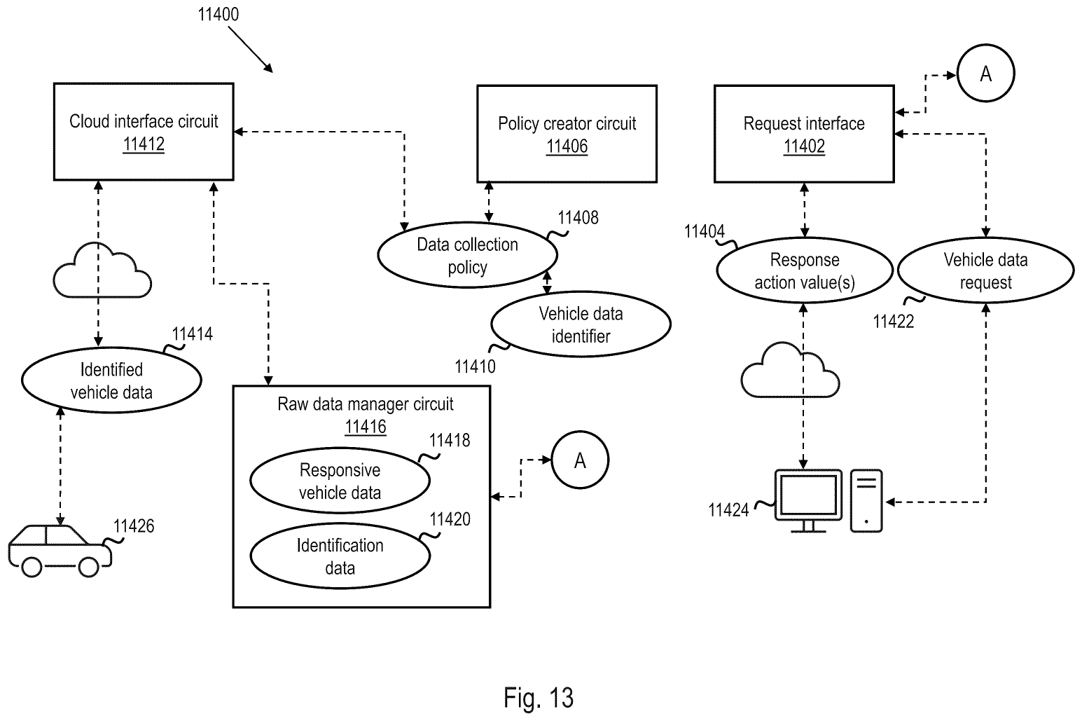

Referencing FIG. 13, an example cloud system 11400 for retrieving selected data from a vehicle, and/or dividing stored collected data and access to the data. The example of FIG. 13 is described as a cloud-based system 11400 for clarity of the description to illustrate aspects of the present disclosure. However, operations of the system 11400 may be performed, additionally or alternatively, on any system configuration external to the vehicle. For example, operations may be performed in whole or part by a service tool, a manufacturing tool, a computing device at least selectively communicatively coupled to the vehicle, or other configurations as set forth herein. An example system includes an external device, whether a cloud-based system or otherwise, coupled to the vehicle using a cellular data connection, a WiFi connection, a physical port connection to a network zone of the vehicle, a Bluetooth connection, and/or any other connection as understood in the art. Operations of intra-vehicle network zone connection devices, such as a CES, CEG, and/or CND, allow for a connection to any network zone of the vehicle to be utilized to receive, configure, and/or update policies to be implemented on the vehicle, and to transmit collected data. In certain embodiments, aspects of the system 11400 may be implemented in the cloud, with other aspects implemented on another external device.

The example system 11400 includes a request interface 11402 configured to interpret a plurality of response action values 11404 from an external device 11424. The response action values 11404 include, without limitation, one or more of: data values for collection (e.g., requested data to be collected from the vehicle); trigger conditions for conditional actions (e.g., data values to be observed for characteristics indicating the trigger event, for example determined by threshold values, processed responses such as a rate of change of a value, a trigger based on a number of values, state values such as “ON”, “OFF”, “ACTIVE”, and/or mode values such as indications of an operating mode, control operation state, etc.); time frames for data collection (e.g., calendar time; operating time relative to the vehicle; a time based amount of data to be collected—e.g., three minutes of data; a relative time to an event detection or trigger condition, such as beginning five minutes after the event, data from the three minutes preceding the event, etc.); priority information to be attributed to any of the foregoing; sampling rates for data values; formatting for data values (e.g., parameter units, bit depth, metadata descriptions, etc.); and/or a data type to be associated with the data values. In certain embodiments, the response action values 11404 may be provided by a user selection of preconfigured values—for example a user may select “vehicle speed” for inclusion as response action value 11404. In certain embodiments, aspects of the response action values 11404 that the user is not authorized to request may be hidden from the user—for example by not providing such values to the user interface operated on the external device 11424. In certain embodiments, aspects of the response action values 11404 that the user is not authorized to request may be annotated—for example with a greyed out text or the like-letting the user know that such values are generally available, but not with the present permissions of the user. In certain embodiments, aspects of the response action values 11404 are presented to the user, and enforcement of the authorization is performed by the policy creator circuit 11406, for example by excluding the values from a final data collection policy 11408, and/or by excluding the entire set of response action values 11404 from the final data collection policy 11408.

In the example of FIG. 13, response action values 11404 indicate defining operations for data collection, trigger evaluation, and/or automatic operations of the vehicle, while vehicle data requests 11422 indicate requests to access responsive vehicle data 11418 collected in response to the response action values 11404. The terminology utilized herein is illustrative and non-limiting.

Operations to generate the data collection policy 11408 with excluded values may include a notification to the user that the requested response action values 11404 were not authorized. In certain embodiments, a notification to the user that the requested response action values 11404 are not authorized in response to a submission attempt by the user—for example allowing the user to identify which aspects of the response action values 11404 are preventing submission, and allowing the user to adjust the response action values 11404. In certain embodiments, a combination of these operations are utilized on the interface—for example hiding some not authorized parameters completely from the user (e.g., highly sensitive parameters that are only available to certain users), and displaying some not authorized parameters to the user. Additionally or alternatively, some parameters may be available in response to a further approval—for example an administrative or supervising user of an entity may have authorization to approve certain parameters as response action values 11404, where another user from the entity requesting the certain parameters may receive a notification to request authorization, and/or the administrative or supervising user may receive a notification that one or more of the certain parameters have been requested. Additionally or alternatively, some parameters may be available based on a subscription, a particular version of the user interface (e.g., a standard versus premium version of a web portal, local application, mobile application, or the like), where the interface may prompt the user to obtain the authorizing features (e.g., subscription, or updated interface version), and/or a notification associated with the parameters may indicate the features needed to access the parameters. In certain embodiments, certain parameters may be available based on access characteristics—for example an unsecured access to the interface and/or a partial login operation to the interface (e.g., entering a password, but not a second step of a two-step authentication, etc.)—where the request interface 11402 may selectively hide parameters unavailable based on the access characteristics, and/or show the parameters as inactive on the interface.

In certain embodiments, the request interface 11402 is configured according to the external device, an associated entity, and/or a type of user and user goal associated with these. For example, the request interface 11402 for interaction with an owner of the vehicle and/or a third party application developer may be simplified, allowing for selection of data collection parameters using selections from menus, utilizing templates, and/or with more limited capability. In another example, the request interface 11402 for interaction with a sophisticated developer, such as a manufacturing entity, fleet owner, or the like, may include convenient interfaces, allow for direct submission of completed policy data structures (e.g., an HTML file, XML file, delimited file, binary file, or the like), or a combination of these (e.g., building an initial data structure based on menu interactions and selections, and allowing access to the source file generated thereby for direct editing and submission).

In certain embodiments, a user device 11424 to provide the response action values 11404 and to provide vehicle data requests 11422 may be different devices, and/or may access separate interfaces 11402. In certain embodiments, a first user providing the response action values 11404 and a second user providing the vehicle data requests 11422 may be separate users, users associated with different entities, and/or may be entirely unrelated. For example, a third party application developer may provide response action values 11404, where the vehicle data requests 11422 may be provided by a vehicle owner. In certain embodiments, a number of separate users may have access to the responsive vehicle data 11418.

In the example of FIG. 13, the system 11400 is depicted with a first cloud boundary to the external device 11424, and a second cloud boundary to the vehicle 11426, with the cloud system positioned therebetween, including the request interface 11402, the policy creator circuit 11406, the raw data manager circuit 11416, and the cloud interface circuit 11412. In certain embodiments, one or more aspects of the cloud system, or all aspects of the cloud system, may be positioned apart from a cloud system, for example with aspects positioned on the vehicle 11426, another external device, or combinations of these. Additionally or alternatively, aspects of the cloud system 11400 may be provided as an internet-based aspect, a web portal, a mobile application, or the like. An example request interface 11402 includes more than one option to interface with the cloud system, for example with a first interface operated as a web portal, another interface operated as a mobile application, another interface operated on a tool (e.g., a service tool, manufacturing tool, or the like), and/or another interface such as on an external device 11424 operating a local application on the device. In certain embodiments, capabilities available for interacting with the cloud system may be varied according to the interface utilized for the interaction (e.g., a service tool having distinct capabilities relative to a mobile application), an entity associated with a user exercising the interface (e.g., a third party application provider, manufacturer, dealer, vehicle owner, etc.), and/or a type of interaction with the cloud system (e.g., a web portal access having distinct capabilities to a manufacturing tool coupled directly to a network zone of the vehicle). Additionally or alternatively, interactions with the cloud system may utilize verification and/or authorization, for example exercising a login interface, encrypted communications between the cloud system and external devices, between the cloud system and the vehicle, and between components of the cloud system. In certain embodiments, the cloud system components may be separate devices-including physically separate devices and/or logically separated devices. For example, the request interface 11402 may be embodied on a separate device (or group of devices) than the raw data manager circuit 11416. In another example, a portion of the request interface 11402 may be at least partially included on an external device and/or on the vehicle.

The example system 11400 includes a policy creator circuit 11406 that determines a data collection policy 11408 in response to the response action values 11404, the data collection policy 11408 including a vehicle data identifier 11410. In certain embodiments, the policy creator circuit 11406 compiles more than one response action values 11404 from more than one user into a data collection policy 11408, for example creating a single compiled data structure representing the policy, and/or providing multiple separate data structures representing the policy. In certain embodiments, the policy creator circuit 11406 checks authorization for portions of the policy according to the entity, user, application, flow, or the like providing the respective portion. In certain embodiments, the policy creator circuit 11406 checks for capability of the policy, for example determining whether data storage resources, processing resources, parameter availability, and/or transmission resources of the vehicle are capable to service data collection or other operations responsive to the policy. In certain embodiments, a policy manager on the vehicle further performs an authorization and/or capability check of the policy provided to the vehicle, for example providing a confirmation to the cloud interface circuit 11412 if the policy is accepted, and providing a notification to the cloud interface circuit 11412 if the policy is declined.

An example cloud interface circuit 11412—for example configured to access the vehicle—is configured to receive identified vehicle data 11414 collected in response to the data collection policy 11408. The vehicle data identifier 11410 may be specifically identifiable information about the vehicle—for example a vehicle identification number (VIN), serial number, media access control (MAC) address from a specified controller of the vehicle, or the like, and/or identifiable information ensuring that the identified vehicle data 11414 can be matched to the vehicle and/or a vehicle data request 11422. An example vehicle data identifier 11410 includes a session identifier (e.g., identifying a data collection “session”, and/or a data collection instance, tied to the block of collected data provided in response to the data collection policy 11408)—for example a unique identifier included with the data collection policy 11408, and attached to the identified vehicle data 11414, allowing identification of the responsive vehicle data 11418 separate from other information such as personal information about the vehicle owner, identification of the specific vehicle related to the data, etc. In certain embodiments, the vehicle data identifier 11410 utilized for a particular data collection policy 11408 may depend upon the type of policy (e.g., a persistent policy may utilize a first type of identifier, and a discrete and/or streaming policy may utilize a second type of identifier), and/or according to the importance for the particular system to keep identifying information separate from the responsive vehicle data 11418.

An example raw data manager circuit 11416 stores at least a portion of the received identified vehicle data 11414, the at least a portion of the identified vehicle data including responsive vehicle data 11418 and identification data 11420. The identification data 11420 may be the same as the vehicle data identifier 11410, or a different identifier. In certain embodiments, the responsive vehicle data 11418 may be encrypted separately from the identification data 11420, allowing for the raw data manager circuit 11416 to provide the correct responsive vehicle data 11418 by comparing the related identification data 11420, without the raw data manager circuit 11416 having access to the responsive vehicle data 11418. The separation of the responsive vehicle data 11418 promotes separation of risk of a data breach, where improper access to a single aspect of the cloud system does not allow matching of the responsive data 11418 with identifying information such as an owner name, specific vehicle, or the like. Example identification data 11420 includes metadata specific to a particular set of response action value(s) 11404.

An example request interface 11402 interprets a vehicle data request 11422, and retrieves at least a portion of the responsive vehicle data 11418 from the raw data manager circuit 11416 in response to the vehicle data request 11422. The example request interface 11402 provides the retrieved data to the external device 11424.

An example system 11400 includes the responsive vehicle data 11418 encrypted utilizing a first encryption key set, and the identification data 11420 encrypted utilizing a second encryption key set. Accordingly, the raw data manager circuit 11416 can be configured to identify responsive data to vehicle data requests 11422, without having access to the responsive vehicle data 11418. In certain embodiments, the raw data manager circuit 11416 may identify responsive data utilizing a hash check or other operation. In certain embodiments, an encryption key to decrypt the responsive vehicle data 11418 is not present on the cloud system 11400, and/or unavailable to selected portions of the cloud system 11400 (e.g., unavailable to the raw data manager circuit 11416).

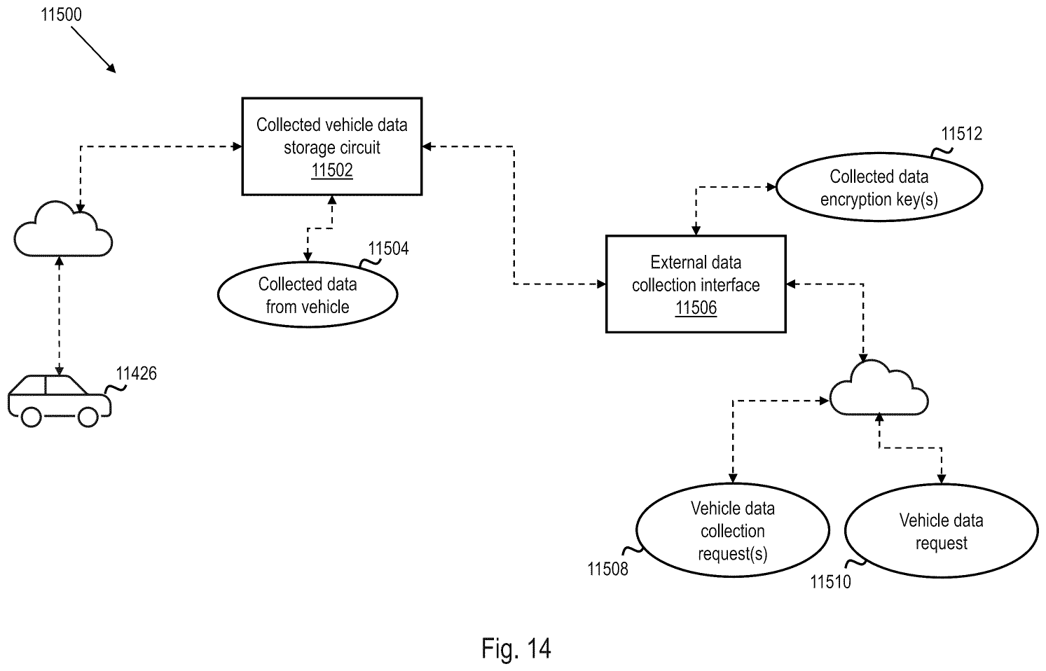

Referencing FIG. 14, an example cloud system 11500 for retrieving selected data from a vehicle, and/or dividing stored collected data and access to the data is schematically depicted. The example of FIG. 14 is described as a cloud-based system 11500 for clarity of the description to illustrate aspects of the present disclosure. However, operations of the system 11500 may be performed, additionally or alternatively, on any system configuration external to the vehicle.

The example system 11500 includes a collected vehicle data storage circuit 11502 that stores collected data 11504 from a vehicle, and an external data collection interface 11506 that selectively provides vehicle data collection request(s) 11508 from an external device to the vehicle, for example by processing the vehicle data collection request(s) 11508 into a policy data structure provided to the vehicle. The example external data collection interface 11506 further provides at least a portion of the stored collected data 11504 from the collected vehicle data storage circuit 11502 in response to a vehicle data request 11510 from an external device. The example system includes separation of at least a portion of the stored collected data 11504 from an encryption key for the at least a portion of the stored collected data 11504. Example arrangements to separate the encryption key from the at least a portion of the stored collected data 11504 include, without limitation to any other aspect of the present disclosure: separate encryption of an identifying portion of the data from a payload portion of the data; identification and/or verification of the payload portion of the data utilizing a hash check; and/or identification and/or verification of the payload portion with a separate identifier for the payload portion. An example external data collection interface 11506 selectively provides the vehicle data collection request(s) 11508 to the vehicle by providing the requests 11508 to the collected vehicle data storage circuit 11502, and/or to a policy creator circuit 11406 (e.g., reference FIG. 13 and the related description).

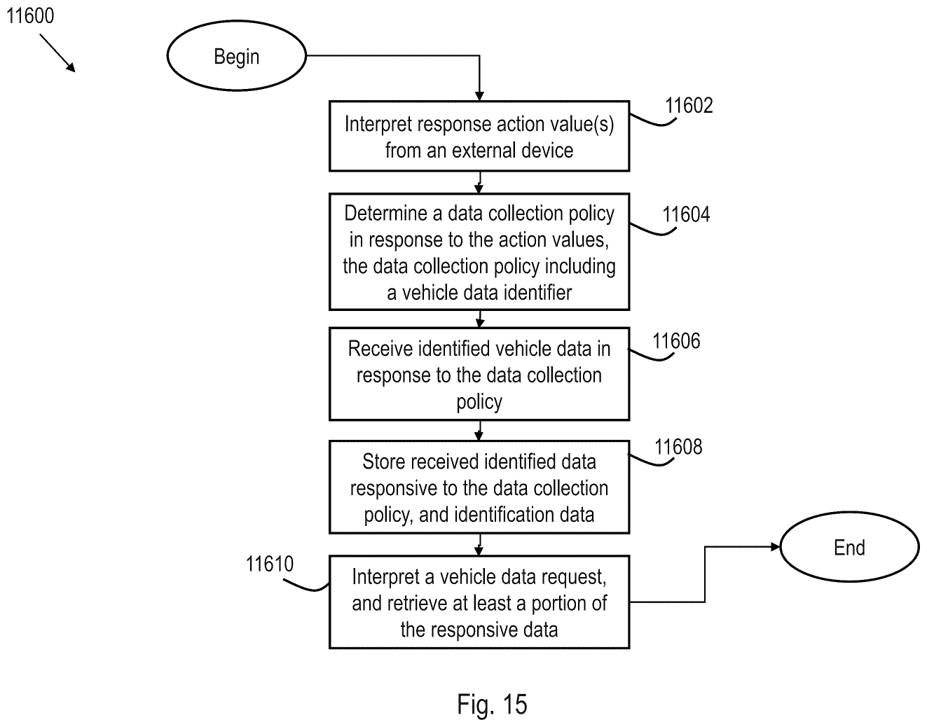

Referencing FIG. 15, an example procedure 11600 for data collection operations from a vehicle is schematically depicted. The example procedure 11600 includes an operation 11602 to interpret response action values from an external device, and an operation 11604 to determine a data collection policy in response to the action values, the data collection policy including a vehicle data identifier. The example procedure 11600 includes an operation 11606 to receive identified vehicle data in response to the data collection policy, an operation 11608 to store received identified data from the vehicle that is responsive to the data collection policy and related identifying data, and an operation 11610 to interpret a vehicle data request, and to retrieve at least a portion of the responsive data.

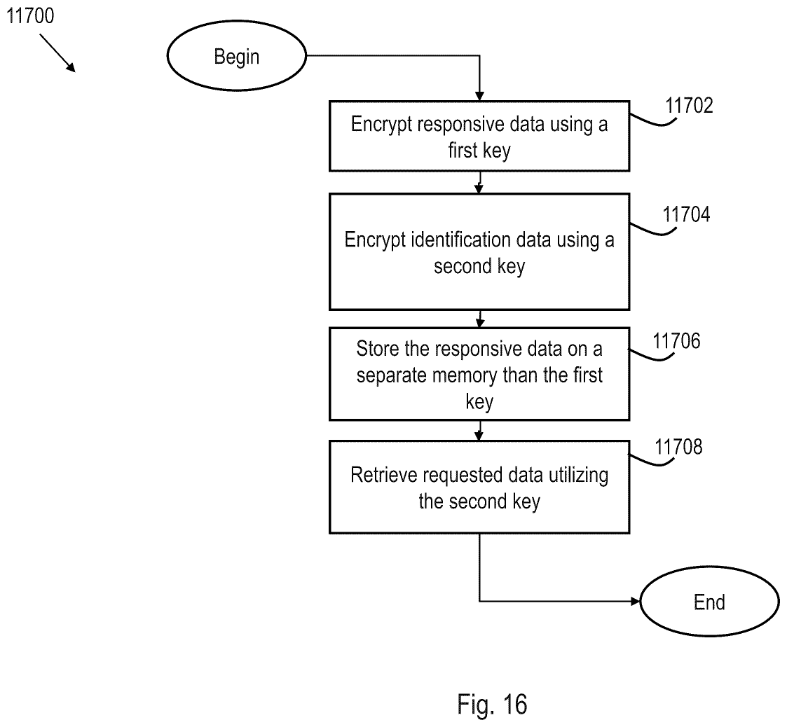

Referencing FIG. 16, an example procedure 11700 for separating responsive data to a vehicle data collection operation from access to the responsive data is schematically depicted. The example procedure 11700 includes an operation 11702 to encrypt responsive data using a first encryption key, and an operation 11704 to encrypt identification data using a second encryption key. In certain embodiments, identification data may be unencrypted. The example procedure 11700 further includes an operation 11706 to store the responsive data on a separate memory from the first encryption key, and an operation 11708 to retrieve requested data utilizing the second encryption key (and/or utilizing the identification data).

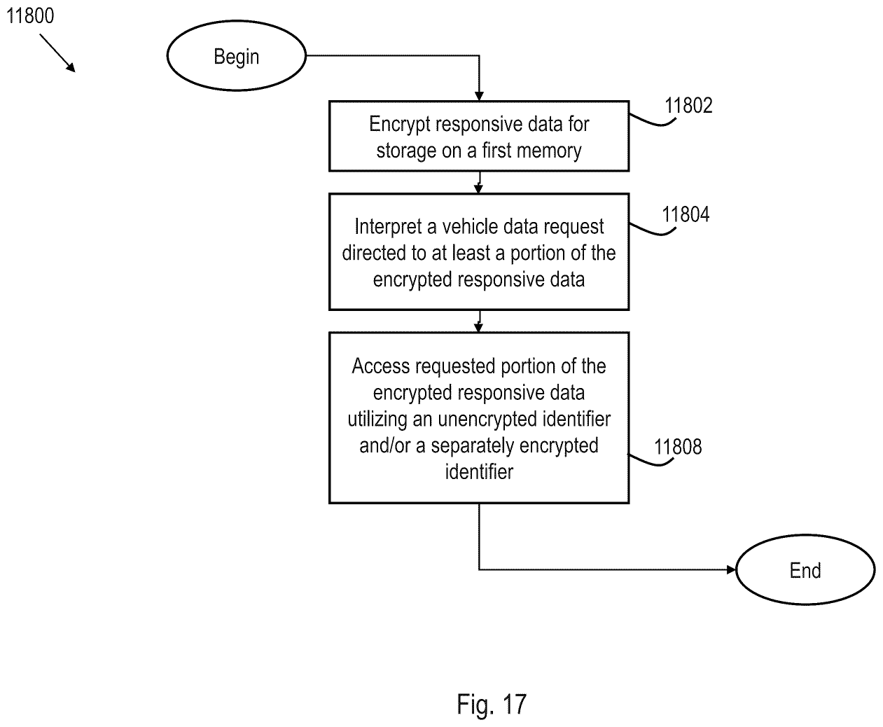

Referencing FIG. 17, an example procedure 11800 for separating responsive data to a vehicle data collection operation from access to the responsive data is schematically depicted. The example procedure 11800 includes an operation 11802 to encrypt responsive data for storage on a first memory, an operation 11804 to interpret a vehicle data request directed to at least a portion of the encrypted responsive data, and an operation 11808 to access requested portions of the encrypted responsive data utilizing an unencrypted identifier and/or a separately encrypted identifier.

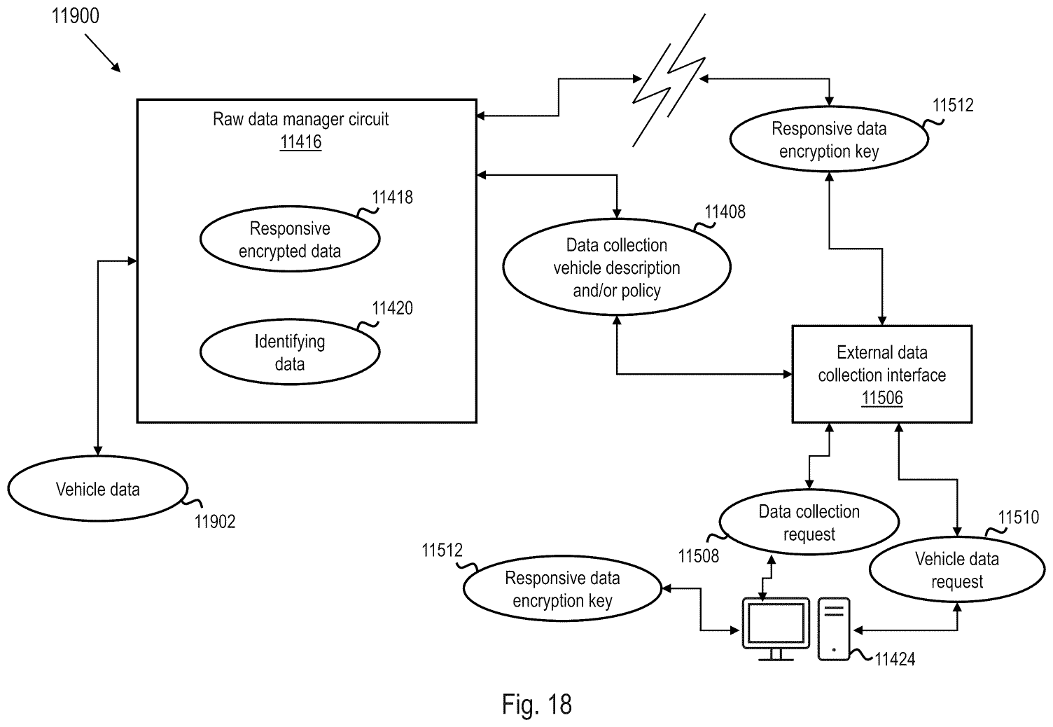

Referencing FIG. 18, an example system 11900 for retrieving selected data from a vehicle, and/or dividing stored collected data and access to the data is schematically depicted. The example system 11900 includes a raw data manager circuit 11416 that stores responsive encrypted data 11418, collected in response to a data collection vehicle description 11408 (and/or a policy), utilizing vehicle data 11902 provided by the vehicle operating a data collection policy on the vehicle. The example system 11900 includes an external data collection interface 11506 that provides at least a portion of the responsive encrypted data 11418 to an external device in response to a vehicle data request 11510. In the example of FIG. 18, an encryption key 11512 for the responsive encrypted data 11418 is kept separate from the raw data manager circuit 11416, for example utilizing separate identifying data 11420 to determine portions of the responsive encrypted data 11418 without decrypting the responsive encrypted data 11418. In certain embodiments, either or both of the external data collection interface 11506 or the external device 11424 have access to the responsive data encryption key 11512, thereby allowing the external device 11424 to access the received data. In the example of FIG. 18, the break between the responsive data encryption key 11512 and the raw data manager circuit 11416 is explicitly depicted for purposes of illustration, but the responsive data encryption key 11512 may be stored on a separate device from the raw data manager circuit 11416, whether a separate physical device or a separate logical device.

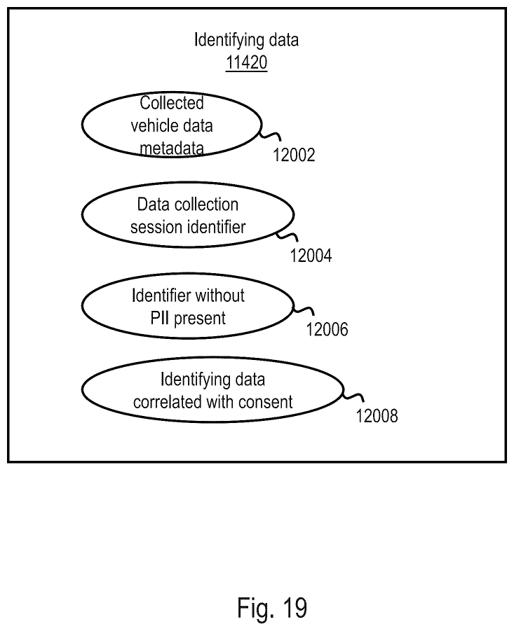

Referencing FIG. 19, example and non-limiting examples of identifying data 11420 are depicted. Example identifying data 11420 include one or more of the following: a collected vehicle data metadata 12002, a data collection session identifier 12004, an identifier configured without personally identifiable information (PII) present 12006, and/or identifying data correlated with a consent 12008 (e.g., where the request interface 11402, and/or a policy manager on the vehicle, provide a consent notification to an external device, where the consent notification includes consent for information presented in the identifying data 11420).

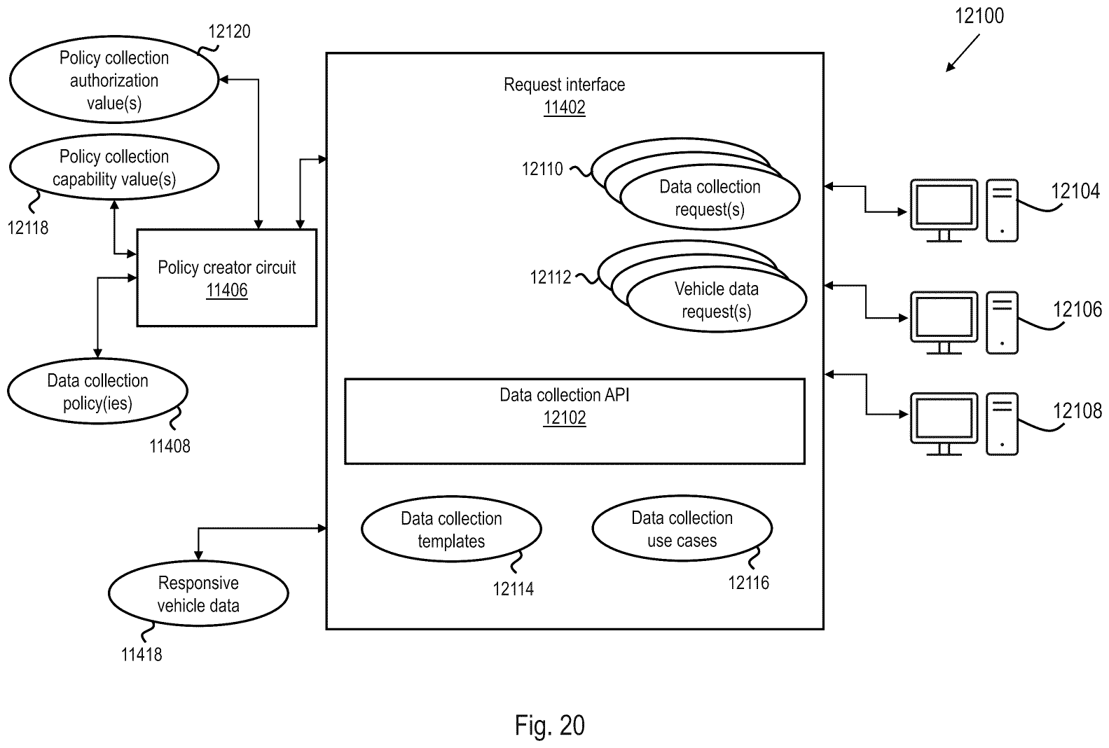

Referencing FIG. 20, an example cloud system for preparing data collection policies, and collecting responsive data from a vehicle, is schematically depicted. The example of FIG. 20 is described as a cloud-based system 12100 for clarity of the description to illustrate aspects of the present disclosure. However, operations of the system 12100 may be performed, additionally or alternatively, on any system configuration external to the vehicle.

The example system 12100 includes a request interface 11402 configured to interpret a vehicle data collection request 12110 for at least one identified vehicle, and a policy creator circuit 11406 that determines a data collection policy 11408 in response to the vehicle data collection request(s) 12110. An example cloud interface provides the data collection policy 11408 to a vehicle, and a raw data manager circuit that stores at least a portion of responsive vehicle data received from the vehicle (e.g., reference FIG. 13).

An example request interface 11402 is further configured to expose an application programming interface (API) (e.g., data collection API 12102) to an external device 12104, 12106, 12108. The API may include access to any selected operations, for example allowing a web portal, mobile application, tool, local application, or the like, to operate an interface to select available data values for collection, to configured a data structure including any aspects of a policy as set forth herein, and/or to request responsive data 11418 after collection operations. The example request interface 11402 further interprets a vehicle data request 12112, and provides retrieved data from the responsive vehicle data 11418 to an external device in response to a vehicle data request 12112. The data collection requests 12110 and/or the vehicle data requests 12112 may be received based on interactions with a user interface provided to the external device(s), and/or in response to an exercise of the API 12102 by the user, an application operated by the user, or the like. The example policy creator circuit 11406 determines the data collection policy 11408 in response to the data collection requests 12110, and/or further in response to policy collection authorization value(s) 12120 and/or policy collection capability value(s) 12118.

Example operations of the policy creator circuit 11406 to determine the policy capability value 12118 include determining the policy capability value 12118 in response to one or more of: a data storage size determined to support the vehicle data collection request; a transmission amount value determined to support the vehicle data collection request; a data availability value associated with the vehicle data collection request; or a data configuration value associated with the vehicle data collection request. Example operations of the policy creator circuit include determining a policy capability value 12118 in response to the vehicle data collection request 12110 and at least one additional vehicle data collection request 12110, and to selectively enable, in response to the policy capability value 12118, at least one of: determining the data collection policy 11408, or including at least one of the vehicle data collection request 12110 or the at least one additional vehicle data collection request 12110. The policy creator circuit 11406 further determines the policy capability value 12118 in response to at least one parameter such as: a data storage size determined to support each of the vehicle data collection request 12110 and the at least one additional vehicle data collection request 12110; a transmission amount value determined to support each of the vehicle data collection request 12110 and the at least one additional vehicle data collection request 12110; a data availability value associated with each of the vehicle data collection request 12110 and the at least one additional vehicle data collection request 12110; a data configuration value associated with each of the vehicle data collection request 12110 and the at least one additional vehicle data collection request 12110; or a priority determination between the vehicle data collection request 12110 and the at least one additional vehicle data collection request 12110 for any one or more of the foregoing.

An example policy creator circuit 11406 determines a policy authorization value 12120 in response to the vehicle data collection request 12110, and to perform at least one operation, in response to the policy authorization value, such as: selectively enabling the determining the data collection policy 11408; or determining the data collection policy 11408 to support at least a portion of the vehicle data collection request 12110. The request interface 11402 is configured to provide at least one use case value 12116 to a user interface, each use case value 12116 including a vehicle data collection template 12114, and determining the vehicle data collection request 12110 in response to responses from the user interface to the provided at least one use case value 12116. The request interface 11402 is further configured to determine the at least one use case value in response to at least one of: an entity type associated with the user interface; a permissions value associated with the user interface; and previous data collection policies determined for users having a shared characteristic determined for the user interface.

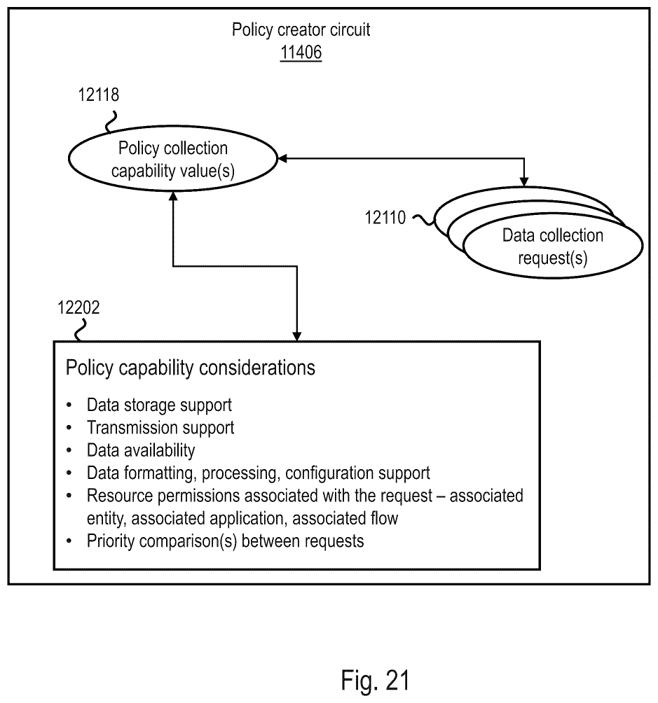

Referencing FIG. 21, an example policy creator circuit 11406 is schematically depicted. The example policy creator circuit 11406 may be utilized in any system herein, and/or may perform operations herein, related to determining, interpreting, and/or creating a policy and/or data collection operations. The example policy creator circuit 11406 determines a policy collection capability value 12118 in response to received data collection requests 12110. In certain embodiments, the policy creator circuit 11406 determines the policy collection capability values 12118 in response to capability considerations 12202 such as: data storage support to service the policy, data transmission support to service the policy, data availability to support the policy (e.g., are the requested data values available), data formatting, processing, and/or configuration support for the policy (e.g., can the parameters be provided in the requested units, bit depth, sampling rates, response time, etc., including whether processing support resources are available to perform formatting and/or configuration operations for collected data), resource permissions associated with the request (e.g., does an entity, flow, and/or application associated with the data collection request 12110 have sufficient permissions to utilize supporting resources, and/or sufficient permissions to consume supporting resources in a quantity needed to support the data collection request 12110), and/or priority comparisons between requests (e.g., lower priority data collection requests 12110 may be excluded if the overall policy including all requests exceeds a capability value).

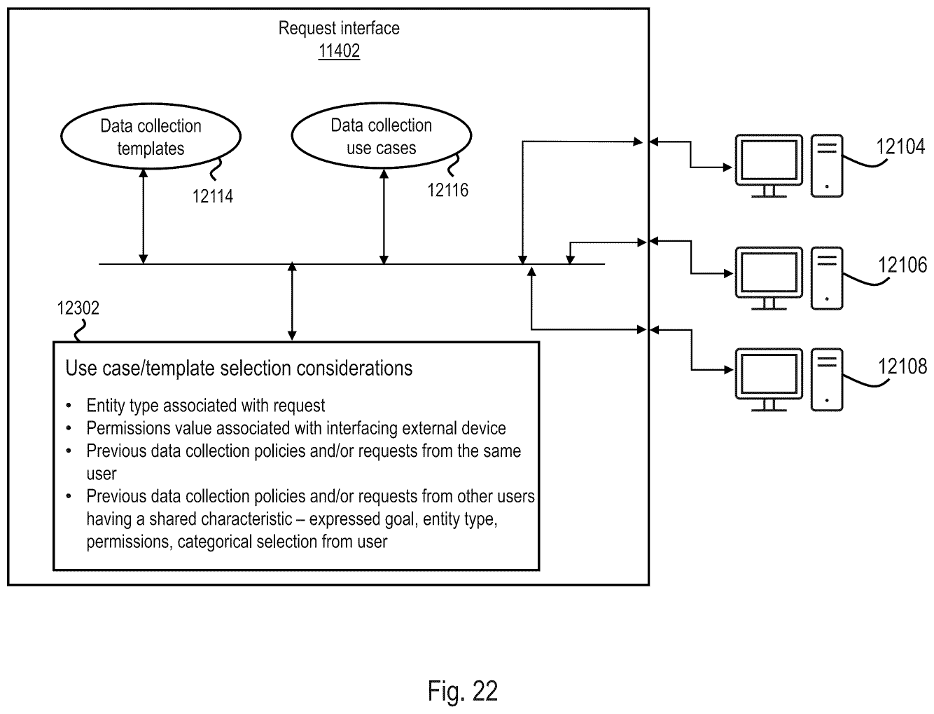

Referencing FIG. 22, an example request interface 11402 providing use case and/or template selections to external device(s) is schematically depicted. The example request interface 11402 may be utilized in any system herein, and/or may perform operations herein, related to determining, interpreting, and/or creating a policy and/or data collection operations, and/or related to receiving and processing data collection requests. The example request interface 11402 determines a data collection template 12114 and/or a data collection use case 12116 for providing to an external device 12104, 12106, 12108 on an interface, where the use case 12116 and/or template 12114 is available for selection as a data collection request, and/or for modification to rapidly configure a data collection request. The example request interface 11402 determines the data collection templates 12114 and/or data collection use cases 12116 in response to selection considerations 12302 such as: an entity type associated with a request (e.g., providing useful use cases and/or templates according to the entity type-such as a manufacturer, service organization, application developer, dealer, vehicle operator, vehicle owner, etc.); a permissions value associated with an interfacing external device (e.g., where users having a similar permissions profile may be more likely to be seeking similar data, and/or users having a similar permissions profile can efficiently utilize the same templates and/or use cases due to overlap in available parameters); previous data collection policies and/or requests from the same user (and/or same entity, same external device, same access location, etc.); and/or previous data collection policies and/or requests from other users having a shared characteristic with the user (e.g., sharing an expressed goal, an entity type, a permissions value, and/or a categorical selection, such as by a user, where the categorical selection may relate to subject matter of the data collection-location data, powertrain data, feature utilization data, etc.—and/or may relate to an intended use of the data collected—service feature, efficiency feature, operator convenience feature, etc.).

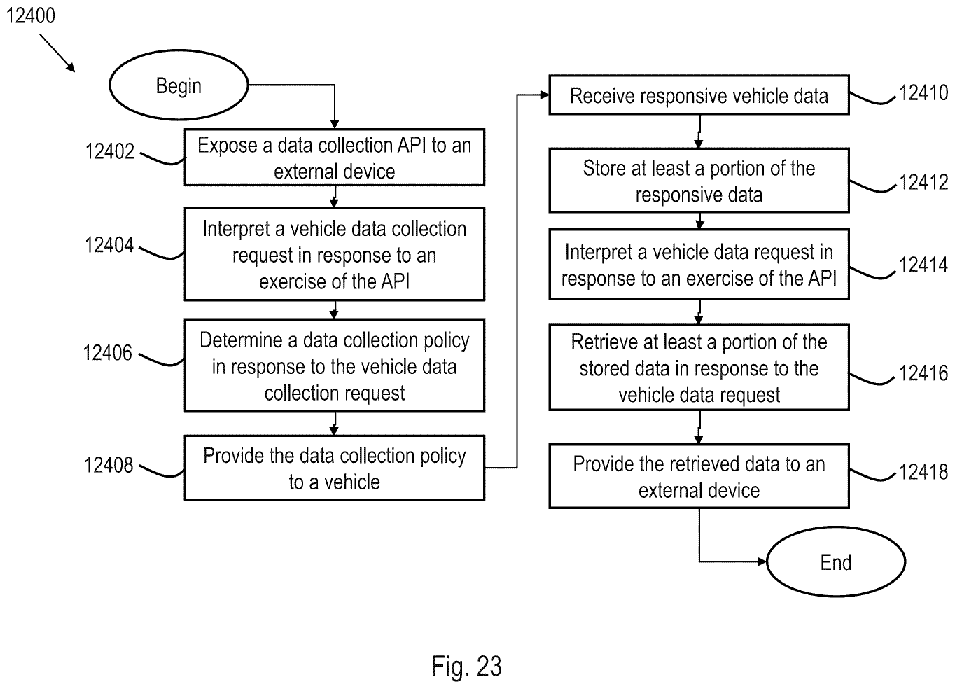

Referencing FIG. 23, an example procedure 12400 for operating a request interface to determine data collection requests and/or collected data access requests is schematically depicted. The example procedure 12400 includes an operation 12402 to expose a data collection API to an external device, an operation 12404 to interpret a vehicle data collection request in response to an exercise of the API, and an operation 12406 to determine a data collection policy in response to the vehicle data collection request. The example procedure 12400 includes an operation 12408 to provide the data collection policy to a vehicle, an operation 12410 to receive responsive vehicle data collected in response to the data collection policy, and an operation 12412 to store at least a portion of the responsive data. The example procedure 12400 includes an operation 12414 to interpret a vehicle data request in response to an exercise of the API, an operation 12416 to retrieve at least a portion of the stored data in response to the vehicle data request, and an operation 12418 to provide the retrieved data to an external device.

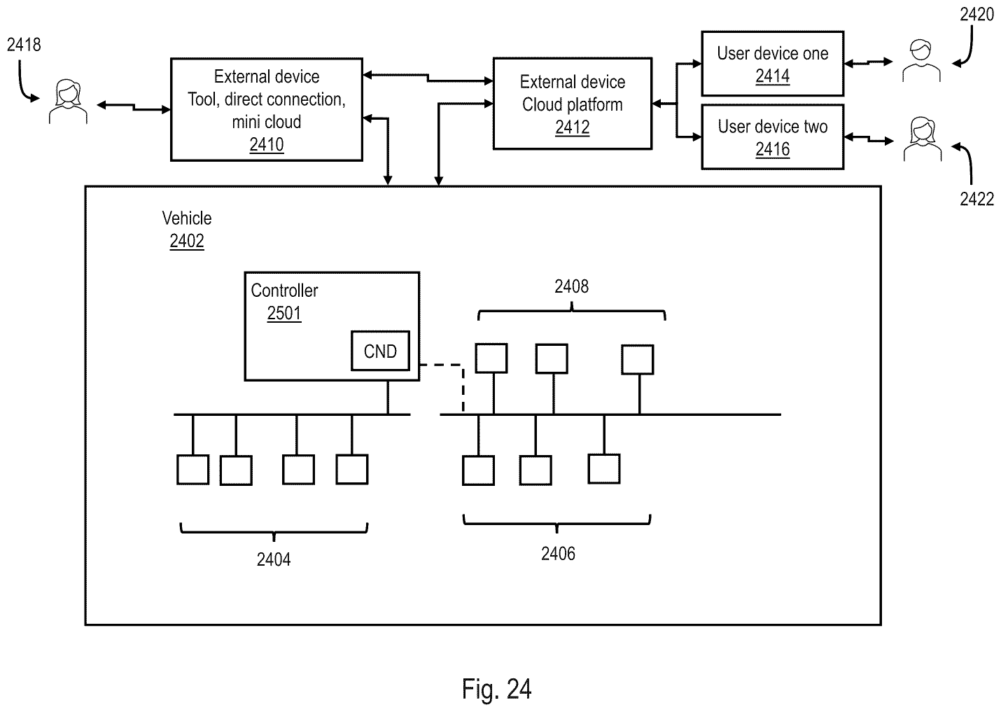

Referencing FIG. 24, an example system is depicted that may be utilized with, and/or that may include, in whole or part, embodiments as set forth throughout the present disclosure and/or aspects thereof. The example system includes a vehicle 2402 having a number of network zones 2404, 2406, 2408, each of the network zones 2404, 2406, 2408 having a number of end points thereon. The end points may be controllers, sensors, actuators, computing devices, and/or any other components of a vehicle using network communications. The example network zones 2404, 2406, 2408 may be physically distinct networks, for example networks on distinct hardware backbones and/or hardware layers, and/or may include virtually separated networks utilizing shared hardware components. In the example of FIG. 24, for purposes of illustration, network zone 2404 is a separate hardware network, and network zones 2406, 2408 utilize the same network hardware but are virtual zones, for example allowing devices to share the network while keeping them separated for security, certification, segregation of control aspects, or any other reason. In the example of FIG. 24, a controller 2501 performs operations to control and implement data collection operations, to support shared memory allocation to support data collection and/or automation operations, or the like. The example of FIG. 24 is non-limiting, and the controller 2501 may be distributed across various end points or the like, but is depicted as a single device in a specific location for clarity of the description. The example controller 2501 is positioned on a same computing device with a converged network device (CND) that facilitates communications between devices on the vehicle regardless of the device location (e.g., which network zone the device is connected to and/or positioned on). In certain embodiments, the CND, if present, may be located on any end point, including a separate end point from the controller 2501, and/or may be distributed across more than one end point. The example system is coupled, at least intermittently or selectively, to a cloud server (e.g., cloud platform 2412), and/or may be coupled to other external devices 2410 such as a tool (e.g., a manufacturing tool, OEM tool, engineering tool, service tool, etc.), directly coupled to a device (e.g., a device coupled to an OBD port, by Bluetooth, by WiFi, etc.), and/or coupled to a mini cloud (e.g., a laptop, workstation, or similar device, that provides certain support operations such as would be provide by the cloud platform 2412, but allowing the vehicle 2402 to connect to the mini cloud where connectivity to the cloud is unavailable and/or undesirable, for example to enhance security for the operations being performed, which may be engineering, manufacturing, service, or other operations where it may be desirable to isolate the vehicle from the cloud, internet, or wide area network). In certain embodiments, any operations described in relation to a cloud system herein may additionally or alternatively be available, in whole or part, on a mini cloud 2410 external device, and/or in a tool of any type.

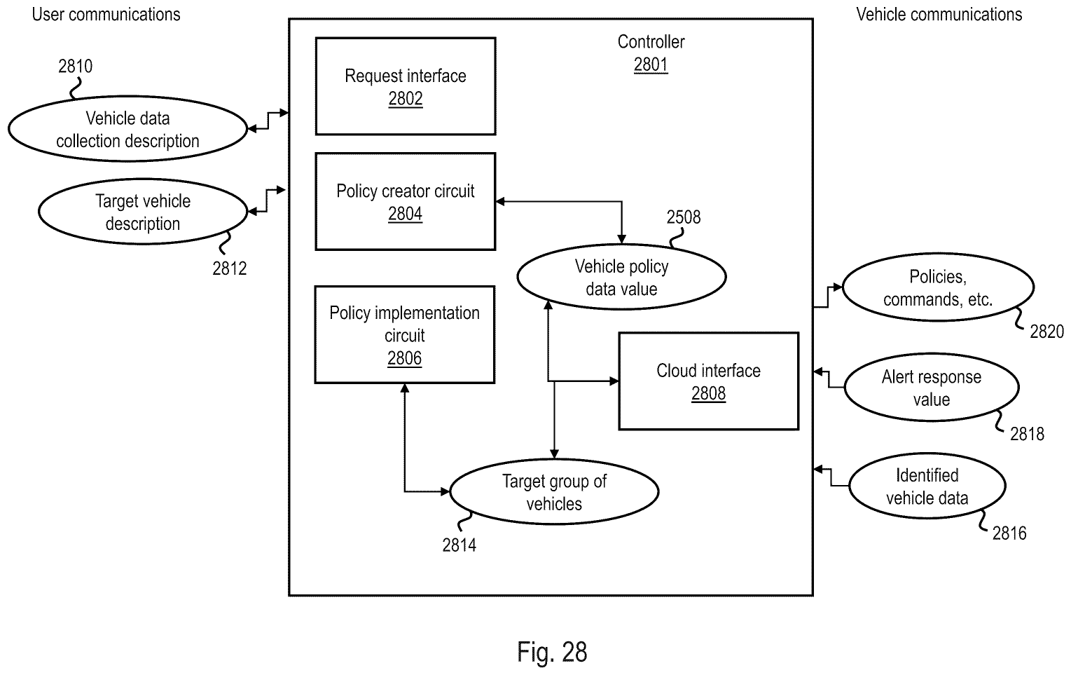

The example system includes user devices 2414, 2416 coupled to the cloud platform 2412, allowing the cloud platform 2412 to implement a user interface, for example a user data collection interface, request interface, and/or any other interface as described throughout the present disclosure and/or that would be evident to one of skill in the art to facilitate user interactions with any system or apparatus as set forth herein. In certain embodiments, access to the cloud platform 2412 may utilize a web portal, proprietary software, mobile application, or the like, where the user devices 2414, 2416 include appropriate computing devices to access the interface, display aspects to the user, accept user inputs, and communicate inputs and receive communications from the cloud platform 2412. In certain embodiments, the cloud platform 2412 may support interactions using an application programming interface (API), for example allowing the user to interact with the cloud platform 2412 utilizing any configured interface desired and/or as set up by an administrator, vehicle tool provider, or the like. The users 2418, 2420, 2422 may be any type of user, for example a service technician, engineer, manufacturer, OEM, dealer, body builder, fleet manager, vehicle owner and/or operator, or the like. In the example of FIG. 24, some users 2420, 2422 interact with the system through the cloud platform 2412, and some users 2418 interact with a tool or other device directly connected to the vehicle 2402. The embodiment of FIG. 24 depicts a specific vehicle, although the system may interact with groups of vehicles (e.g., reference FIGS. 28-32 and the related description), including potentially a very large number of vehicles (e.g., all vehicles for a particular manufacturer).

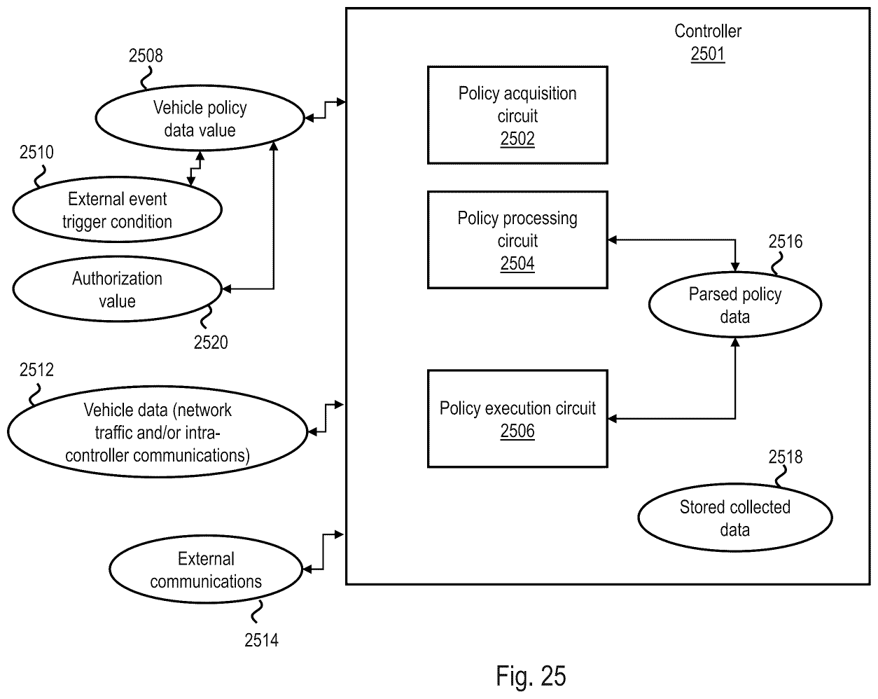

Referencing FIG. 25, an apparatus for collecting vehicle data utilizing events based on external parameters to the vehicle is depicted. Without limitation to any other aspect of the present disclosure, external events include events determined based on any information that is not direct vehicle data. In certain embodiments, external data may be available to the vehicle in whole or part, for example an ambient temperature of the vehicle may be sensed on the vehicle but may be considered external data for the vehicle. The example apparatus includes a controller 2501 that includes a policy acquisition circuit 2502 configured to interpret a vehicle policy data value 2508 including an external event trigger condition 2510. The policy processing circuit 2504 is configured to generate parsed policy data 2516 including the external event trigger condition 2510. The parsed policy data 2516, as used herein, includes determining the portions of the policy that relate to data collection operations, automated operations, and/or other information utilized to support operations herein. For example, a policy may include other information, such as registering components of the vehicle, specifying relevant versions of hardware, firmware, and/or software on the vehicle, or the like, that are not necessarily a part of the data collection operations as set forth herein. Additionally or alternatively, data collection operations may utilize several end points distributed on different network zones, where each end point that is utilized does not need (and possibly cannot use) information for other end points, and accordingly the parsing operations determine the information relevant to each end point, and utilizes the parsed policy data 2516 to command each end point accordingly. In certain embodiments, the end points may be supported by a zone agent, software agent, or the like, such that the policy execution circuit 2506 provides commands to those supporting agents to implement data collection and/or other communications, where some (or all) of the end points providing and/or utilizing information do not work with the parsed policy data 2516 directly, but rather are responsive to the parsed policy data 2516 through the operations of the supporting agent(s). The policy execution circuit 2506 is configured to collect vehicle data 2512 from one or more vehicle end points in response to the parsed policy data 2516. The collected data is stored as stored collected data 2518 and/or may be communicated via external communications 2514. An authorization value 2520 may also be included in the vehicle policy data value.

Authorization values, as used herein, can support numerous operations within the present disclosure to ensure vehicle security and proper operation, and to ensure that specific data, such as mission critical data, vehicle control data, data including personally identifiable information (PII), or the like, is not observed by or manipulated by users or devices that should not access or manipulate such information. Authorization values may be related to, the requesting user or device, and/or the providing user or device. For example, an entity requesting data collection operations (e.g., a user providing a vehicle policy data value) may have specific authorizations to access data, to adjust data values, to request certain operations (e.g., summaries of data, statistical analysis of data, etc.), to utilize certain resources (e.g., limitations on the allowed network utilization, memory utilization, and/or processing utilization, to support requested operations), and/or to view certain data elements (e.g., including viewing the data values, and/or the existence of the parameters at all). In certain embodiments, the permissions may relate to the current operating conditions and/or state of the vehicle—for example a user may have increased permissions to utilize network resources during certain operating conditions (e.g., when total network utilization is low), and/or during certain operating states (e.g., when the vehicle is in a steady state cruise operation), and reduce permissions during other operating conditions and/or operating states. The permissions associated with the authorization values may be determined according to an identity of the user, an entity associated with the user (e.g., a user associated with a manufacturer of the vehicle may have distinct permissions relative to a user associated with a dealer), a role of the user (e.g., administrative, engineering, operator, and/or service users may have distinct permission), and/or any metadata utilized to control access (e.g., the user login type, subscription parameters, time of day of access, etc., may all be utilized to adjust and/or apply authorization values. In certain embodiments, the authorization value may be compared to permissions associated with a provider of the data—for example data provided by certain end points, associated with particular vehicle applications, flows, and/or features, and/or data that is associated with particular networks and/or network zones, may be limited to vehicle policy data values 2508 having sufficient authorization values 2520 for such access. The authorization values and implementations herein are not limiting.

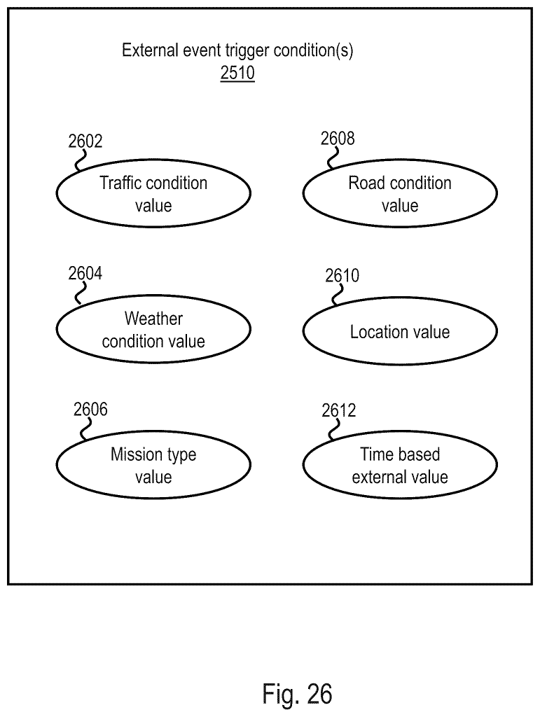

Referencing FIG. 26, example external event trigger conditions 2510 are further detailed in non-limiting examples. An example external event trigger condition 2510 includes a traffic condition value 2602, allowing a user to configure a policy for data collection based on traffic conditions (e.g., a categorical traffic description such as “heavy” or “light” traffic, based on quantitative values such as a vehicle throughput past a relevant location, a number of vehicles within a specified range, or the like). The external event trigger conditions 2510 may be utilized to determine data collection operations, and/or may be utilized to determine whether the policy is active. For example, an external event trigger condition 2510 may be utilized to keep a policy inactive until the trigger condition is met, and then the policy is activated, whereby the policy may then have further trigger conditions associated with specific data collection, where those further trigger conditions are not monitored until the external event trigger conditions 2510 are met. The external event trigger conditions 2510 may be staged sequentially, for example a first condition related to weather may be a first stage, and then a second stage related to traffic may be utilized—for example a policy may include a first trigger based on determining that it is night time, and then a second trigger condition that the weather is snowy, before any further conditions are checked as a part of active policy data collection operations. Additionally or alternatively, any trigger conditions set forth herein may be combined, whether external event trigger conditions 2510 or vehicle based trigger conditions, and may be utilized to determine if a policy should be active, as well as to execute data collection operations in response thereto. The staged trigger determination for activating a policy for monitoring allows for a more efficient operation of the system, for example where monitoring during data collection may utilize significant processing resources to determine if data collection conditions are present, supporting buffering of data, or the like, allowing for the policy activation conditions to utilize simplified and selective activation parameters where the purposes of the data collection will not be present yet, and accordingly significant processing, memory utilization, and network communication resources can be saved until the vehicle is in a condition where successful data collection is more likely to be available.

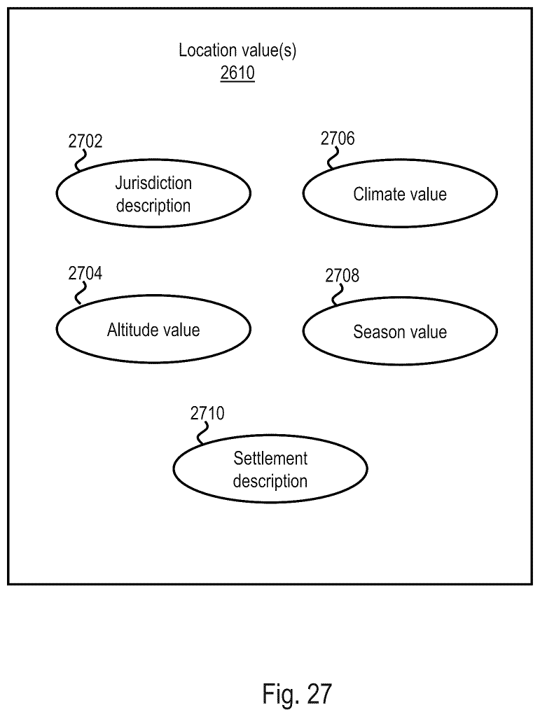

An example external trigger condition 2604 includes one or more of: a weather condition value 2604 (e.g., precipitation, rain, temperatures, presence and/or magnitude of wind, outlier or unusual weather compared to a baseline, etc.); a mission type value 2606 (e.g., commuting, errands trip, first responder mission, law enforcement mission, hauling a load, hot shotting, where the mission type may be a permanent value, such as a first responder mission type for an ambulance, or a transient value, such as a commuting mission type based on the vehicle position, time of day, previous operator behavior, etc.); a road condition value 2608 (e.g., quantitative values such as a road curvature description, road banking description, road shoulder description, speed limit value, road grade, number of lanes, exit density and/or proximity, etc., and/or qualitative values such as a maintenance condition, presence of road construction, designated high risk road section, or the like); a location value 2610 (e.g., geography, jurisdiction, zoning such as a school zone, etc., and reference FIG. 27 and the related description); and/or a time based external value 2612 (e.g., time of day, calendar date, work day vs. week day, commuting time value, a relative time such as time elapsed since a trip commenced, and/or any other sequencing parameter such as miles traveled, operating parameter (e.g., engine rotations, wheel rotations, fuel and/or energy consumed, etc.)).

Referencing FIG. 27, example location values 2610 are further detailed, comprising various specific values such as: a jurisdiction description 2702 (e.g., a relevant country, state, city, etc., for example to meet required data monitoring regulations, adjusting collection operations based on applicable laws, etc.); an altitude value 2704 (e.g., allowing for data collection operations under conditions of interest, such as in low ambient pressure conditions); a climate value 2706 (e.g., a qualitative climate value such as temperate, desert, or tropical, as well as quantitative values such as average temperatures, wind, precipitation, or ambient sunlight); a season value 2708 (e.g., allowing for data collection based on conditions of interest that may relate to a season, such as during cold start operations, where the season may be weather based such as spring/summer/fall/winter, and/or based on other conventions, such as a holiday season, tourist season, bison migration season, etc.); and/or a settlement description 2710 (e.g., allowing for data collection based on factors such as urban environment, rural environment, population density values, vehicle density values, etc.). The examples of external event trigger conditions 2510 are non-limiting, and it will be seen that some potential external event trigger conditions may fit into multiple categories (e.g., a school zone determination may be considered a road condition or a location value, depending on the convention utilized). The examples and names used for examples are non-limiting illustrations to clarify aspects of the present disclosure.

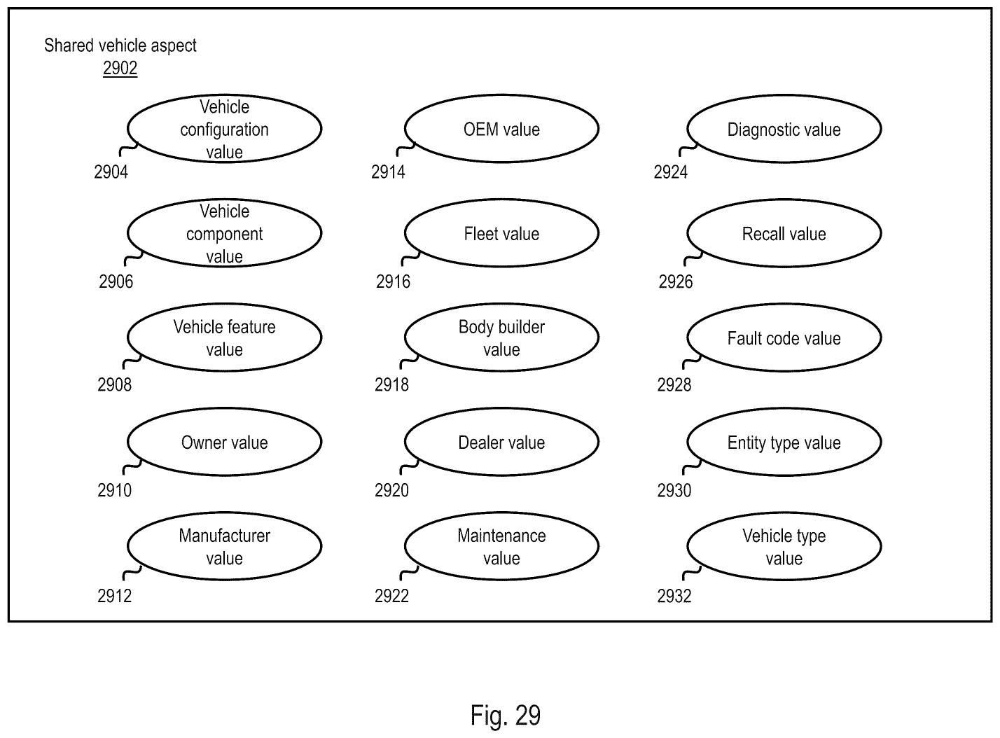

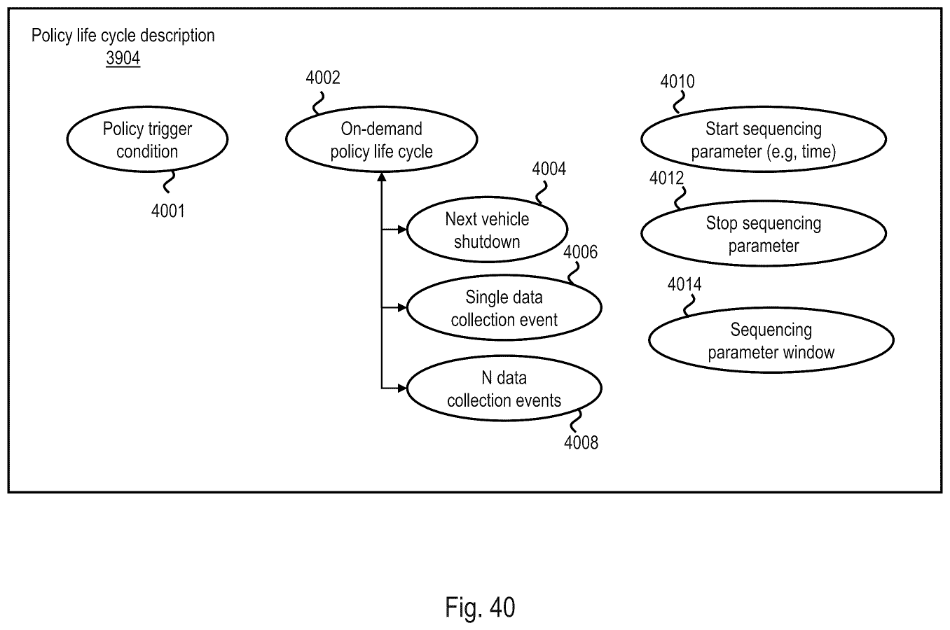

Referencing FIG. 28, an example cloud system is depicted comprising a controller 2801 that includes a request interface 2802 configured to interpret at least one vehicle data collection description 2810 and a target vehicle description 2812. In the example of FIG. 28, user communications with the controller 2801 are depicted on the left side, and vehicle communications are depicted on the right side, for convenience and clarity of the description, but the communications are not limiting and may come from any source. The policy creator circuit 2804 is configured to determine at least one vehicle policy data value 2508 in response to the vehicle data collection description 2810 and the target vehicle description 2812, thus the request interface 2802 allows the user to provide the data to be collected, including any trigger conditions that are utilized for data collection operations, and any trigger conditions (e.g., external event trigger conditions 2510 and/or policy trigger conditions 4001—reference FIG. 40, that are utilized to determine when the policy implementing the data collection should be active), and further allows the user to provide the relevant vehicles where the data collection should be implemented (e.g., by providing the relevant policies 2820 and/or commands to the relevant vehicles). The policy implementation circuit 2806 is configured to determine a target group of vehicles 2814 in response to the target vehicle description 2812 and to provide at least one vehicle policy data value 2508 to the group of vehicles 2814. The cloud interface 2808 is configured to receive identified vehicle data 2816 (e.g., data collected from vehicles implementing the policy 2820) and/or an alert response value 2818 (e.g., where a vehicle does not install or execute the policy, and/or where execution of the policy fails for any reason) in response to the vehicle policy data value 2508. The system may also handle policies, commands, etc. 2820, for example with the cloud interface 2808 implementing communications between the controller 2801 and the relevant vehicles identified in the target group of vehicles 2814. In certain embodiments, the policy implementation circuit 2806 determines the target group of vehicles 2814 in response to a shared vehicle aspect 2902 (reference FIG. 29), allowing the user to rapidly determine vehicles relevant to the planned data collection operations. Additionally or alternatively, the user can select specific vehicles, or a specific vehicle, for example selecting vehicles from an available list and/or providing an identifier for specific vehicles on the request interface 2802.

Referencing FIG. 29, further details for an example shared vehicle aspect 2902 are depicted. The example shared vehicle aspect 2902 includes a vehicle configuration value 2904 (e.g., vehicles having certain versions of firmware, software, an installation version, and/or any other identifier utilized to set forth the configuration of vehicles), a vehicle component value 2906 (e.g., targeting vehicles having a specific sensor, actuator, transmission, valve, etc.), a vehicle feature value 2908 (e.g., vehicles having a feature such as cruise control, ADAS, ABS, and/or specific versions of a feature), an owner value 2910 (e.g., specific owners, owner types, owner characteristics, etc.), a manufacturer value 2912, an OEM value 2914, a fleet value 2916, a body builder value 2918 (e.g., identifying specific body builders, upfitters, 3^{rd} party add-on entities, and/or types of these such as those that install certain types of components, features, or configure vehicles for specific applications such as emergency vehicles, performance vehicles, or the like), a dealer value 2920, a maintenance value 2922 (e.g., vehicles that utilize certain maintenance procedures, and/or that have had certain maintenance procedures performed or not performed, including over a selected time period), a diagnostic value 2924 (e.g., vehicles having certain diagnostics available or not available, that have performed certain diagnostics, and/or that have certain diagnostic results including over a selected time period), a recall value 2926 (e.g., vehicles that are subject to (or not subject to) a particular recall, and/or that have had a particular recall performed or not), a fault code value 2928 (e.g., a vehicle that has a particular fault code available, that has a particular fault code active, and/or that has had a particular fault code active in a selected time period), an entity type value 2930 (e.g., based on a categorical entity type such as manufacturer, OEM, dealer, etc., and/or based upon a functional type including for example which aspects of the vehicle the entity has responsibility for and/or access to), and a vehicle type value 2932 (e.g., commercial, passenger, rental, first responder, truck class, etc.). The example shared vehicle aspects 2902 provide a number of levers for the user to quickly select a group of vehicles that are likely to be useful ways to organize the vehicles for various data collection purposes, and provides an implementation scheme for the user to quickly deploy policies for data collection, automation, monitoring, and data analysis to those vehicles.

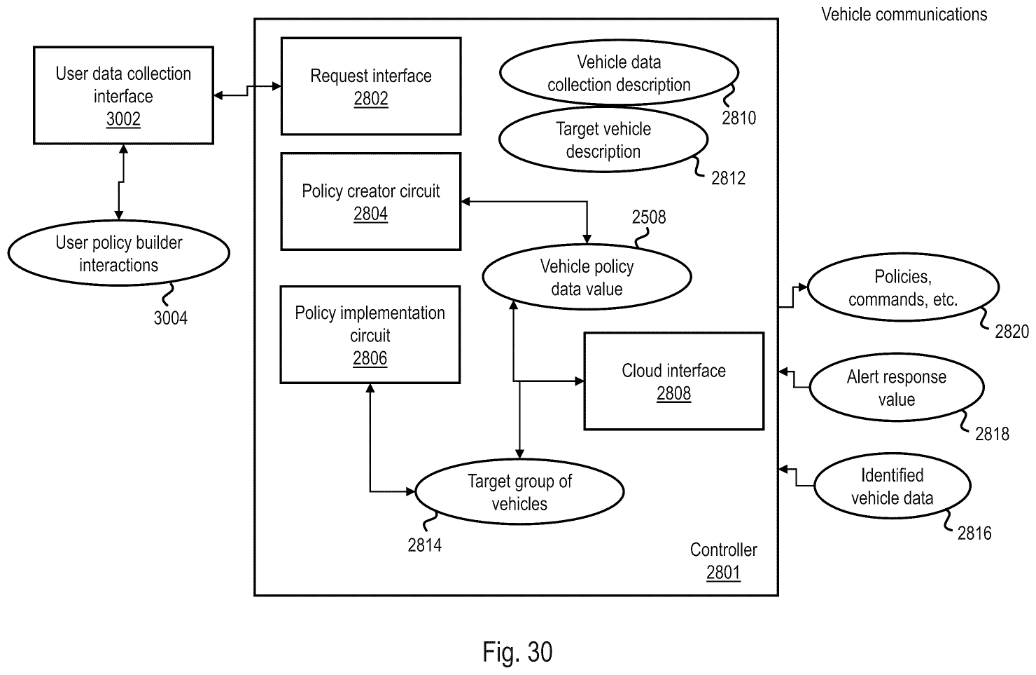

Referencing FIG. 30, an example cloud system is depicted comprising a controller 2801 that includes a request interface 2802 configured to implement a user data collection interface 3002 and to interpret at least one vehicle data collection description 2810 (e.g., data values to be collected, trigger conditions for the data, priority for the data collection, etc.) and a target vehicle description 2812 in response to user policy builder interactions 3004 with the user data collection interface 3002. The policy creator circuit 2804 is configured to determine at least one vehicle policy data value 2508 (e.g., a policy configured to implement the data collection operations on the vehicle when processed by a controller of the vehicle) in response to the vehicle data collection description 2810 and the target vehicle description 2812. The policy implementation circuit 2806 is configured to determine a group of vehicles 2814 in response to the target vehicle description 2812 and to provide at least one of the vehicle policy data values 2508 to the group of vehicles in response to user policy implementation interactions 3004 (e.g., building a collection recipe describing trigger conditions for the policy to be active, trigger conditions for the data to be collected while the policy is active, and the data to be collected; selecting and/or defining target vehicles; approving the policy and/or vehicle selections; deploying the policy; and/or monitoring the policy deployment and/or collected data in response) with the user data collection interface 3002. The cloud interface 2808 is configured to receive at least a portion of identified vehicle data 2816 (e.g., data collected pursuant to the policy) and/or an alert response value 2818 (e.g., vehicle alert that the policy or a portion thereof cannot be, or will not be, implemented) in response to the vehicle policy data value. The system may also handle policies, commands, etc. 2820, and/or any other communications with the vehicle.

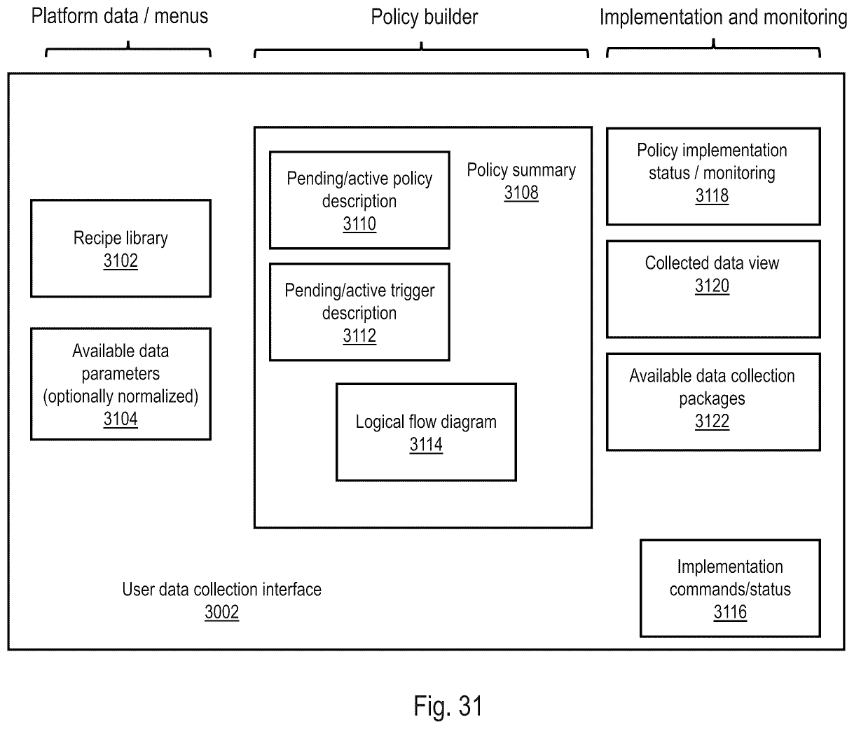

Referencing FIG. 31, an example user data collection interface 3002 is depicted, comprising a recipe library 3102 (e.g., default data collection recipes, pre-built data collection recipes, previously saved data collection recipes, and/or recommended data collection recipes based on a request and/or indicated interest by the user), available data parameters 3104 (e.g., displaying parameters available for data collection, which may include parameters within the authorization of the user, and/or which may be filtered based on a request and/or indicated interest by the user), and a policy summary 3108. An example policy summary 3108 displays information for the user indicated which parameters are intended for collection, triggers controlling policy activation and/or data collection operations, the target group of vehicles 2814, etc. In certain embodiments, a pending/active policy description 3110 may be presented on the policy summary 3108, for example allowing the user to readily identify whether a displayed policy (or which displayed policies) has been deployed, and/or indicating which aspects of the policy need to be completed before deployment. In certain embodiments, a pending/active trigger description 3112 may be presented on the policy summary 3108, for example allowing the user to readily view trigger conditions in the policy (e.g., policy activation trigger conditions and/or data collection trigger conditions), and may further include an indication of how those trigger conditions would have been met on selected vehicles (e.g., confirming that a planned trigger scheme will operate as intended), as well as a confirmation whether the triggers are included in the policy or whether they are pending for inclusion. In certain embodiments, a logical flow diagram 3114 is depicted on the policy summary 3108, for example allowing the user to readily confirm the chain of actions for a complex triggering scheme and/or to visualize dependencies between operations that would be performed to execute the policy.

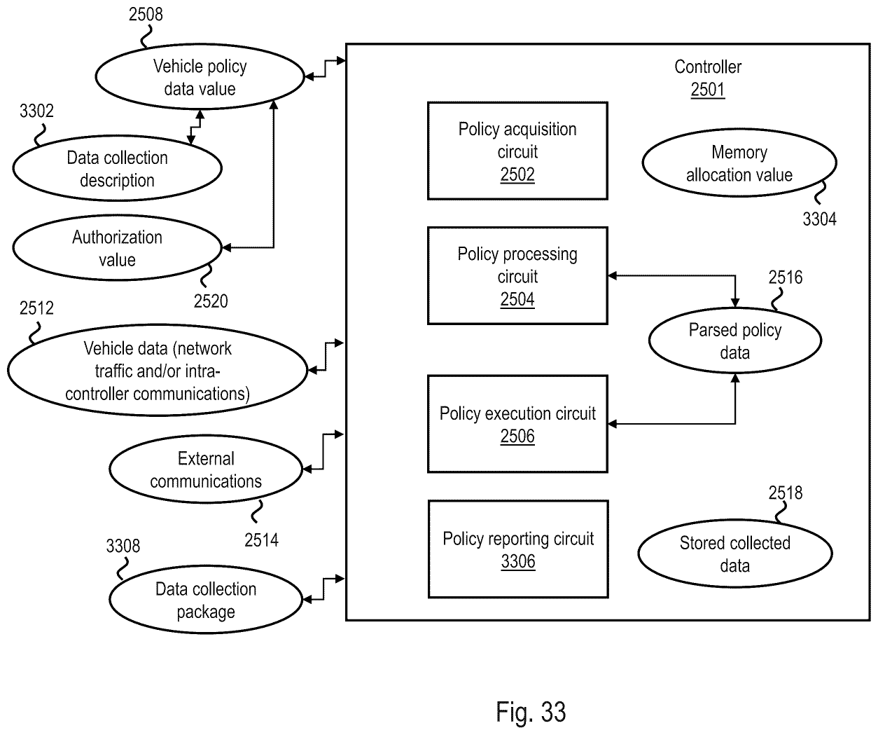

The example user data collection interface 3002 includes a policy implementation status/monitoring 3118 display that allows the user to see which vehicles have received and/or confirmed the policy, whether the policy is not yet active, is active, and/or if the policy is completed (e.g., the policy is not active, but has already been executed). The example user data collection interface 3002 includes a collected data view 3120 allowing the user to see which vehicles have collected data for a policy, and may further allow the user to see the specific data for vehicles, access summaries of the data, access summaries of the policy implementation (e.g., how many vehicles have received and/or confirmed the policy, how many vehicles have collected data for the policy, etc.). The example user data collection interface 3002 includes a view for available data collection packages 3122 (e.g., data structures having collected data therein, which may be identified and/or indexed—reference FIG. 33 and the related description). The example user data collection interface 3002 includes a component for implementation commands and/or status 3116—for example allowing the user to approve and/or deploy policies.

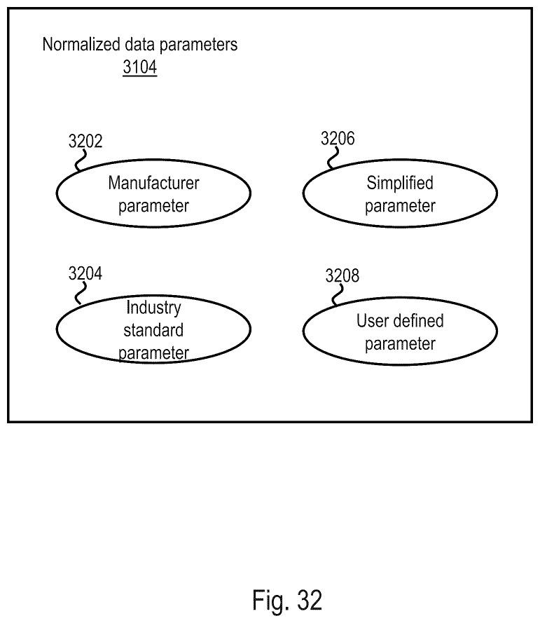

Referencing FIG. 32, example and non-limiting normalized parameters 3104 are depicted, which may be utilized on the user data collection interface 3002 to improve accessibility for policy creation to a broad range of users. For example, displayed parameters on the user data collection interface 3002 may use terminology that is likely to be understandable to the user. Example and non-limiting normalized parameters include one or more of a manufacturer parameter 3202 (e.g., parameter naming, resolution, units, sampling rates, etc. specified by a particular manufacturer), an industry standard parameter 3204 (e.g., as specified by an industry standard, that are conventionally used in a particular industry, etc.), a simplified parameter 3206 (e.g., a parameter name and/or description prepared for non-technical or casual users, marketing or business personnel, consumer users, etc.), and/or a user defined parameter 3208 (e.g., parameter display set up by the user, or by another user on behalf of the user, etc.). In certain embodiments, the user data collection interface 3002 may allow the user to reveal the actual parameter properties (e.g., where possible, noting that some parameters may have several “actual” versions depending on the selected group of vehicles, in which case a common set of properties may be displayed, and/or several versions of the properties may be displayed) and/or to switch parameters (globally, individually, and/or in selected groups) between different normalization schemes.

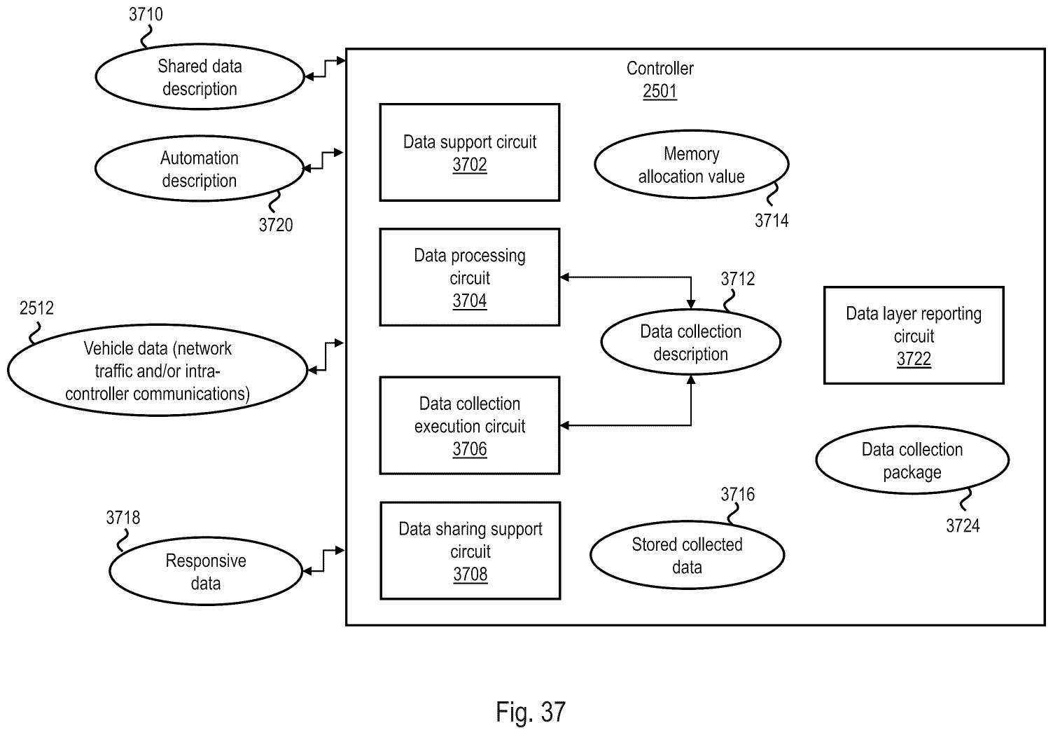

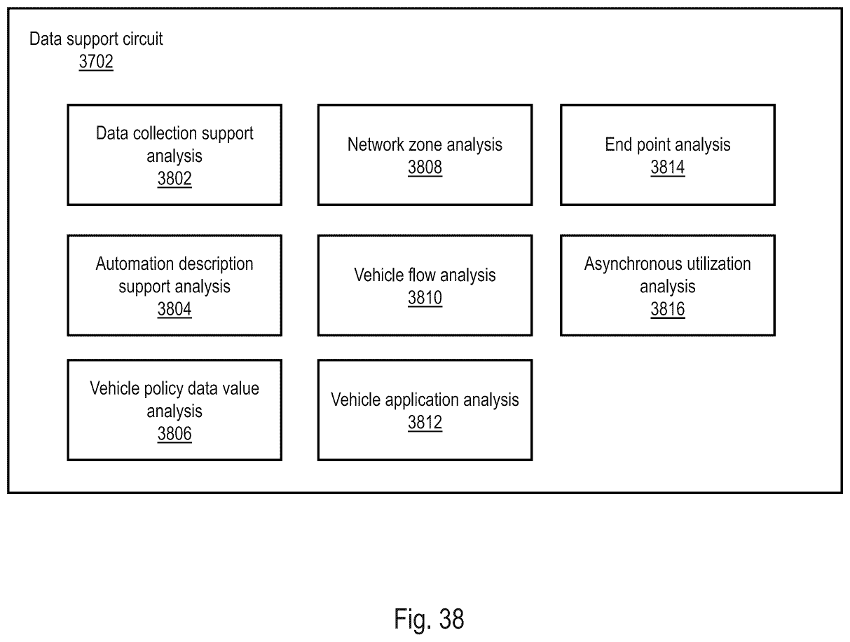

Referencing FIG. 33, an example apparatus is depicted comprising a controller 2501 that includes a policy acquisition circuit 2502 configured to interpret a vehicle policy data value 2508 comprising a data collection description 3302. The policy processing circuit 2504 is configured to generate parsed policy data 2516 corresponding to the data collection description and to determine a memory allocation value 3304 in response to the parsed policy data. In certain embodiments, the memory allocation value 3304 is an amount of memory, memory location(s), storage schemes, life cycle management for the memory, and the like, to support data collection operations according to the data collection description 3302. In certain embodiments, the memory allocation value 3304 accounts for the storage to support the data collection operation, including storage of the collected data, and/or intermediate memory allocation for processing operations that may be utilized to exercise triggers, perform data processing, likely storage time until the collected data can be communicated to the cloud (if applicable), or the like. In certain embodiments, the memory allocation value 3304 includes sufficient memory allocation to perform all operations. In certain embodiments, the memory allocation value 3304 may be configured to support a number of policies and/or data collection operations, and may be intelligently provided at less than 100% support of all policies and/or operations simultaneously (e.g., reference FIGS. 37-38 and the relevant description), which may result in significant reduction of the required memory to support data collection operations as set forth herein.

The policy execution circuit 2506 is configured to collect vehicle data 2512 from one or more vehicle end points in response to the parsed policy data 2516 and to store at least a portion of the collected vehicle data as stored collected data 2518 in response to the memory allocation value 3304 (e.g., in the specified locations, formatting, applying the specified prioritization and/or life cycle management, applying specified compression operations, etc.). An example policy reporting circuit 3306 is configured to generate a data collection package 3308 responsive to the collected vehicle data and to perform at least one of storing the data collection package or communicating the data collection package 3308 via external communications 2514.

In certain embodiments, the data collection package 3308 provides a data structure that can be communicated and/or accessed by a user, where the data collection package 3308 includes all data collected for a policy, and/or for a particular triggered data collection event of the policy. An example policy reporting circuit 3306 includes a package identifier with the data collection package 3308, for example identifying the policy including the vehicle policy data value 2508, which data collection operation and/or which trigger of the policy was utilized to generate the data, or the like. In certain embodiments, the package identifier is a uniquifier for the data collection package 3308, for example based on the requesting user and/or entity that provided the policy. In certain embodiments, the package identifier includes descriptive metadata for the data collection package 3308, for example including a time stamp for beginning and/or ending collection times, vehicle operating conditions and/or vehicle states applicable at a time relevant to the data collection package 3308, network utilization and/or available memory relevant to the policy operations, or the like. In certain embodiments, the package identifier provides a convenient hook to index, identify, sort, filter, and/or share data collection packages 3308 for a user that is monitoring policies and/or collected data from policies. An example policy reporting circuit 3306 includes at least a portion of a flow log in the package—for example logs relating to network communications and/or end points thereof, operations of certain flows on the vehicle at times relevant to the policy (e.g., during policy activation, trigger determinations, and/or data collection operations), which may allow the user to troubleshoot policy implementation, plan for improved implementation of policies going forward, determine if issues surfaced in the collected data are signal (e.g., the type of issue the data collection was intended to identify) or noise (e.g., issues arising from the implementation of the policy, for example excessive network utilization or memory, conflicts with vehicle operations, etc.), and/or to provide inputs for a machine learning, artificial intelligence, and/or other iterative improvement operation to improve the creation, deployment, and/or execution of policies, data collection operations, and/or automated operations over time. An example policy reporting circuit 3306 includes a vehicle condition log in the package—for example including active fault codes and/or fault counters, vehicle parameters such as operating state, power throughput, vehicle speed, or the like, a listing of active diagnostics, features, algorithms, applications, or flows on the vehicle during times relevant to the policy, or the like, and which may be used in a manner similar to those aspects described for the flow log preceding.

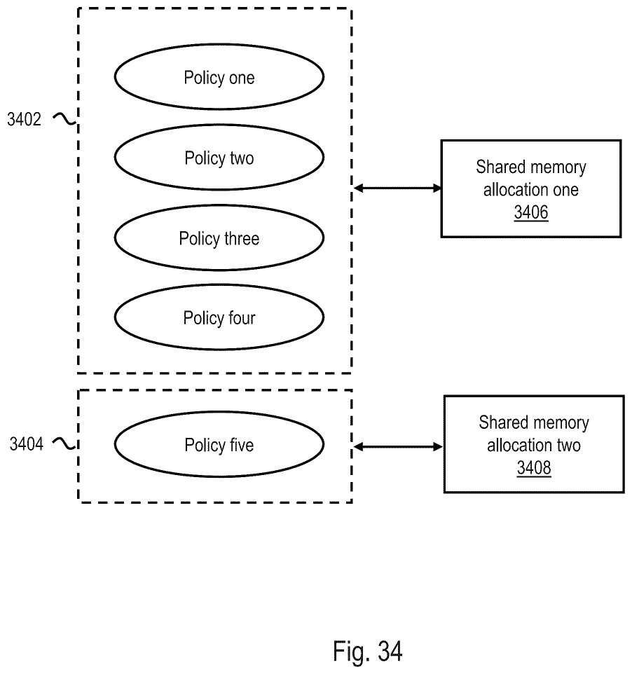

Referencing FIG. 34, an example shared memory allocation is schematically depicted. The example of FIG. 34 is described in the context of a number of policies active on a vehicle at the same time (or with at least some overlap in active time for the policies), where shared memory allocation is utilized to support the policies in a manner that allows for efficient utilization of system resources to support policy operations. It will be understood that the concepts of shared memory allocation as set forth herein may be utilized to support multiple data collection events from a single policy, for example where a data collection package 3308 is prepared for each data collection event responsive to a trigger, and/or for a number of data collection events responsive to triggers for a policy, but less than all of them (e.g., a policy that triggers twenty (20) individual collection events may utilize a single data collection package, twenty (20) data collection packages, and/or several data collection packages—for example in groups of five (5), all collection events for a given time period (e.g., hourly, daily, weekly, monthly, etc.) and/or sequencing parameter (e.g., all collection events per trip, per 1,000 miles, per 500 hp-hr of powertrain energy utilization, and/or according to any other sequencing parameter), a principled grouping of collection events into a package (e.g., providing collection packages that are similarly sized and/or that utilize a similar amount of processing power to support each package; providing collection packages that are sequentially sized to provide for convenient and progressive analysis of the data, such as three packages sized with 1, 2, and 4 units of data therein; and/or providing collection packages that have sufficient data therein to perform statistical analysis such as frequency analysis, statistically significant sample sizes of the data, etc.), and/or packages tied to external parameters (e.g., completing packages before a quarterly business meeting so the data can be analyzed in time before the meeting, tying the packaging timing to an engineering deliverable, design date for a subsequent model year for the vehicles, etc.). In certain embodiments, the basketing scheme for a given embodiment may be updated in response to changes in the policies (e.g., a policy is added or removed, for example by a user providing a vehicle policy data value), and/or an expiration or inactivation of a policy (e.g., the expiration of a relevant time frame and/or sequencing parameter, the completion of operations such as data collection for the policy, and/or the occurrence of a deactivating trigger event for the policy). Where the basketing scheme for a given embodiment is updated, any operations may be performed to transition to the updated basketing scheme, for example previously collected data may be stored in a partial package which is closed, communicated to the cloud, included in the new basketing scheme (if applicable), or the like.

In certain embodiments, operations to combine policies for treatment herein (e.g., using a shared memory allocation, shared data packages, etc.) are referenced as supporting a basket of policies, where it will be understood that the combining unit may be collection events, trigger events, and/or automated operations rather than policies (e.g., supporting a basket of collection events, or more generally supporting a basket of combining units). In certain embodiments, combining policies into data packages and/or shared memory allocations are referenced in the context of supporting the basket for appropriate memory allocation values, for example ensuring that memory utilization on the vehicle remains within the capability of the vehicle, where it will be understood that the context of supporting the basket may relate to processing utilization and/or network utilization (e.g., ensuring that network utilization on the vehicle remains within the capability of the vehicle).

It can be seen that the operations herein to support a basket of combining units (e.g., policies) provide for significant improvements, such as: improved resource utilization for data collection, policy deployment and implementation, and/or automated operations; higher confidence execution of operations for the combining units; an increased likelihood that the operations for the combining units will be performed within desired timeframes; and/or allows for a greater system capability to support operations for the combining units (e.g., a given system can support a greater number of combining units, and therefore a greater number of collection events, greater amount of collected data, and/or an increased number of available automated operations) given fixed system resources. In certain embodiments, operations to support a basket of combining units improves the ability and likelihood of preserving system capability, for example to meet a QoS standard for the underlying operations, and/or to meet a QoS standard for other operations in the system that compete with the system resources utilized to perform the underlying operations.

Again referencing FIG. 34, an example policy processing circuit 2504 implements a basketing scheme for a number of policies on the vehicle (five policies, in the example), by determining the memory allocation value 3304 as a shared memory value to support a basket of policies. In the example of FIG. 34, the policy processing circuit 2504 determines a shared memory allocation one 3406 memory allocation value 3304 to support the first policy basket 3402, and determines a shared memory allocation two 3408 memory allocation value 3304 to support the second policy basket 3404. In certain embodiments, the policy processing circuit 2504 may utilize the same baskets 3402, 3404 to determine data collection packages 3308 (e.g., the first policy basket 3402 is package into a single data collection package 3308), however the policy processing circuit 2504 may utilize a distinct basketing scheme for data collection packages 3308, and/or omit a basketing scheme for the data collection packages 3308. In certain embodiments, the basketing scheme for combining units may be performed by the policy processing circuit 2504, for example where the basketing operations are implemented by analysis of the policies, applications, flows, and/or other aspects of the vehicle that may utilize memory, processing, and/or network resources. In certain embodiments, the basketing scheme for combining units may be performed by the policy execution circuit 2506, and/or adjusted by the policy execution circuit 2506, for example where the basketing operations are implemented by, or updated by, analysis of the actual execution and/or performance of the policies, applications, flows, and/or other aspects of the vehicle that may utilize memory, processing, and/or network resources. In certain embodiments, the policy processing circuit 2504 and policy execution circuit 2506 may iteratively implement and/or adjust the basketing scheme(s) utilized as policies are added and removed, as data collection operations are resolved, and as the performance of the vehicle changes over time.

An example operation to determine the basket scheme to support combining units may utilize a trigger correlation analysis, for example determining correlation and/or anti-correlation between combining units (e.g., policies having trigger events for activation and/or for data collection operations that are likely to occur at the same time; that are unlikely to occur at the same time; and/or that cannot occur at the same time (e.g., data collection is based on mutually exclusive vehicle states)). Another example operation to determine the basket scheme to support combining units may utilize historical operations from the underlying policies, triggers, automated operations, and/or data collection operations, and/or historical operations for offset policies, triggers, automated operations, and/or data collection operations, which may improve the estimates of actual resource utilization to support the combining units, and/or to determine correlations, anti-correlations, and/or dependencies between the combining units. Another example operation to determine the basket scheme to support combining units may utilize historical operations from the underlying policies, triggers, automated operations, and/or data collection operations from an offset vehicle (or a group of offset vehicles), and/or historical operations for offset policies, triggers, automated operations, and/or data collection operations from an offset vehicle (or a group of offset vehicles). Another example operation to determine the basket scheme to support combining units may utilize a probabilistic analysis to determine resource utilization, whether a resource exceedance will occur, to determine a shared memory allocation value to support the basket of combining units, or the like. Example and non-limiting probabilistic analyses include a Bayesian analysis, a Monte Carlo analysis, a fuzzy logic based tuning of baskets and/or basket parameters, utilizing a Poisson distribution of potential operations and/or disturbances, and/or operating a digital twin of at least a portion of the vehicle network, memory, and/or processing operations, for example in a simulated operation of the vehicle over a number of trips, to surface the utilization of resources and/or correlations/anti-correlations between combining units. In certain embodiments, the probabilistic analysis can be performed over time utilizing historical data, for example in the cloud, as the vehicle continues to operate. Further, the probabilistic analysis can be performed on offset vehicles and/or using data from offset combining units, to improve the performance of the system over time. The described operations to determine the basket scheme, including for example which aspects should utilize a shared data collection package 3308, shared memory allocation values 3406, 3408, and/or should be supported by a shared data collection package 3724 (reference FIG. 37 and the related description), are non-limiting, and in certain embodiments various operations to determine the basket scheme can be combined and/or performed in sequence as the relevant data and/or supporting resources become available.

Without limitation to any other aspect of the present disclosure, an offset vehicle as used herein is a separate vehicle from the contemplated vehicle, which shares an aspect of the vehicle in a relevant manner to the comparison. For example, a vehicle having the same hardware components as the present vehicle may be considered an offset vehicle for purposes of determinations where the hardware components are relevant to the analysis. In certain embodiments, offset vehicles may be determined according to similar principles as vehicles having shared vehicle aspect 2902 (reference FIG. 29), although any other relevancy determinations are also applicable. In certain embodiments, many vehicles have a ready corpus of offset vehicles, such as vehicles sharing a make, model year, duty cycle, etc. In certain embodiments, a vehicle may be an offset vehicle for one purpose (e.g., the shared characteristic of the vehicles is relevant to the one purpose) but not for a second purpose (e.g., the shared characteristic of the vehicle is not relevant to the second purpose).

Without limitation to any other aspect of the present disclosure, an offset policy, trigger, automated operation, and/or data collection operation (or, combining unit) is a separate combining unit from the contemplated combining unit, which shares an aspect of the combining unit in a relevant manner to the comparison. For example, a first policy utilizing the same end points, collecting a similar amount of data at a similar rate, and based on similar trigger conditions as a second policy, may be considered an offset policy to the second policy for purposes of determining resource utilization and/or correlations with other policies. In another example, a first policy utilizing the same end points, collecting a similar amount of data at a similar rate as a second policy, but utilizing distinct trigger conditions as the second policy, may be considered an offset policy to the second policy for purposes of determining of resource utilization, but may not be considered an offset policy to the second policy for purposes of determinations of correlations with other policies. The examples are non-limiting illustrations.

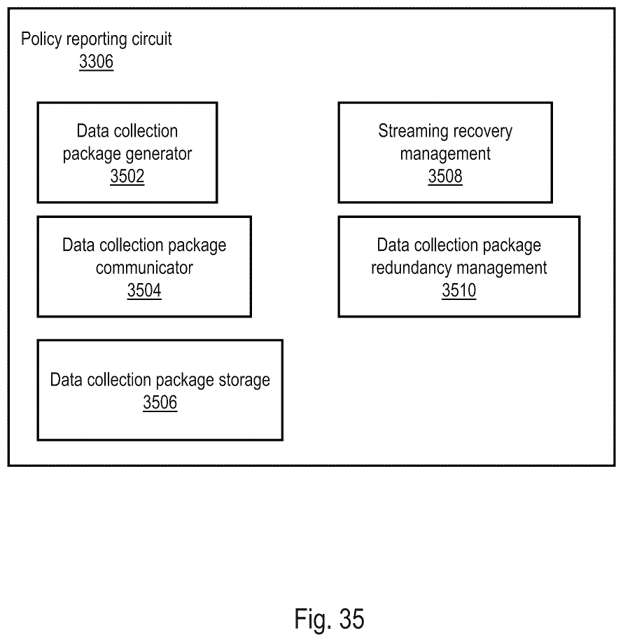

Referencing FIG. 35, an example policy reporting circuit 3306 is depicted. The example policy reporting circuit 3306 includes one or more processing components configured to support operations to generate data collection package(s) 3308 to store, organize, and/or communicate collected data. The example policy reporting circuit 3306 includes a data collection package generator 3502 that generates a data collection package 3308 for each policy, for a basket of policies, and/or for data collected in response to a trigger event (e.g., a trigger event that activates a particular policy, and/or that activates a particular data collection event within a policy or otherwise). The example data collection package generator 3502 may further append collection data to a data collection package 3308, and/or may adjust the data collection packages 3308 already created, for example in response to an adjustment in the basketing scheme relevant to the data collection packages 3308. The data collection package 3308 may be stored on the vehicle, communicated to an external device, and/or may be made available to devices (e.g., end points, flows, applications, features, controller, etc.) on the vehicle (e.g., reference FIG. 37 and the related description).

The example policy reporting circuit 3306 includes a data collection package communicator 3504 that manages communication of the data collection package 3308, for example streaming the data of the data collection package 3308 to an external device (e.g., a cloud server, mini cloud, connected tool, etc.) at a selected time, according to vehicle operating conditions, or the like. In certain embodiments, the data collection package communicator 3504 performs operations according to a priority associated with the data collection package 3308, associated with a requesting user or entity associated with a policy that initiated the data collection package 3308 (or portions thereof), and/or associated with a source (e.g., end point, application, flow, feature, etc.) of data or portions thereof within the data collection package 3308. In certain embodiments, the priority of the policy and/or resulting data may be defined in the policy, which may be limited to a priority range associated with the user or entity creating and/or implementing the policy.

The example policy reporting circuit 3306 includes a data collection package storage 3506 component that manages storage of the data collection package 3308 on the vehicle. For example, the data collection package storage 3506 component enforces the memory size and/or location aspects set forth in the associated memory allocation value 3304, ensures that data structures, identifiers, indexing, compression, and descriptive metadata are applied and stored in the data collection package 3308 and/or referenced in and communicated with the data collection package 3308. In certain embodiments, certain compression aspects may be applied to the data collection package 3308, such as time series compression, repetitive value compression, or the like, and the data collection package storage 3506 component ensures that any data required to decompress the data package are stored in the data collection package 3308 and/or referenced in and communicated with the data collection package 3308. In certain embodiments, the data collection package 3308 may include precursor data that can be utilized to re-create multiple data sets—for example and without limitation: a raw data stream that supports multiple virtual sensors and/or various processed values, state determinations; a high sampling rate stream of data that supports multiple requests for the stream of data at different sampling rates; and/or a normalized stream of data (e.g., resolution, units, parameter naming, etc.) that supports multiple requests for functionally the same data with a distinct final form as accessed by the requesting user based on the characteristics of the data from the requesting user. In a further example, redundancy management operations (e.g., by the data collection package redundancy management 3510 component) may provide a smaller data set that can be utilized to re-create multiple requested data sets, where the smaller data set is stored and/or communicated as the data collection package 3308. In such embodiments, the data collection package storage 3506 component stores the smaller data set, and information sufficient to re-create the multiple requested data sets is stored in the data collection package 3308 and/or referenced in and communicated with the data collection package 3308. In certain embodiments, information to re-create requested data sets from the abbreviated data collection package 3308 (e.g., based a smaller data set, compressed data set, and/or precursor data), information sufficient to re-create the requested data, and/or information to decompress the data collection package 3308, may be communicated with the data collection package 3308 by referencing the operations utilized and/or utilizing accepted conventions, which can further reduce the data stored and/or communicated to support operations of the policy reporting circuit 3306.

The example policy reporting circuit 3306 includes a streaming recovery management 3508 component that performs a streaming recovery operation in response to an interruption of communicating the data collection package 3308 to an external device. For example, communication operations may be interrupted for any reason, for example by a vehicle shutdown event, due to a loss in network communications (which may be intermittent), due to an increase in activity on a network and/or external communication device (e.g., due to vehicle operations), and/or due to a competing resource interest from a higher priority communication. An example streaming recovery operation includes utilizing a memory buffer to communicate the data collection package 3308, allowing for repetition of any lost data to be communicated after the communications are restored. In certain embodiments, for example where defined in the policy, for critical data collection packages 3308, or the like, the streaming recovery operation includes a formal check (e.g., with the receiving external device) of which information has been received, allowing the policy reporting circuit 3306 to resume communication of the data collection package 3308 while ensuring the data is complete. In certain embodiments, the streaming recovery operation performs optimistically, for example assuming that a last communication for the data collection package 3308 was received, and the policy reporting circuit 3306 resumes communication of the data collection package 3308 from the last message sent once communication is resumed. In certain embodiments, for example where a memory buffer is not utilized and/or is not available, streaming recovery operations can include restarting a data collection package 3308, utilizing a pointer to the data collection package 3308 to track which portions have been sent, and/or canceling the communication of data (e.g., where the data collection package 3308 is not critical and/or is aged, and/or where the data collection package 3308 is usable in a partial form and a large majority of the data collection package 3308 was previously sent). In certain embodiments, the applicable streaming recovery operations are considered as a factor in determining the basketing scheme for a system, and/or the iterative improvement operations for a basketing scheme additionally consider adjustments to the applicable streaming recovery operations for the baskets. In certain embodiments, the streaming recovery management 3508 component may additionally or alternatively form a part of the policy execution circuit 2506, and/or may support the policy execution circuit 2506.

The example policy reporting circuit 3306 includes a data collection package redundancy management 3510 component configured to perform a redundancy management operation in response to determining that at least two policies on the vehicle have a shared collected data element. The shared collected data element may be a literal data overlap (e.g., the same data values as stored in a data collection package and/or as transmitted responsive to each policy are present), or a raw data overlap (e.g., the same raw data values are the source of truth for at least a portion of the data collection package and/or as transmitted responsive to each policy are present—for example where the stored/transmitted data is determined from the same raw data, and/or is processed such as for resolution, units, or the like). The shared collected data element examples set forth a literal overlap and a raw data overlap, but it will be understood that the overlap may be intermediate, for example data may be subjected to several processing operations, with the overlap extending through several, but not all, of the processing operations, and/or where the data is precursor data for one or more of the supported policies. It is contemplated that the redundancy management operation may utilize the raw data before any processing and/or may utilize an intermediate portion of the data as pseudo-raw data for redundancy management operations. The redundancy management operations are described in the context of data collected for a policy, but may additionally or alternatively apply to any collected data for any purpose in the system, including intermediate data (e.g., utilized for trigger analysis). In certain embodiments, the redundancy management operations may include adjusting the basket scheme (e.g., combining data from the related policies into a same data collection package 3308 and/or stored collected data 2518) so the data is only stored and/or communicated once. For a literal data overlap, packaging the shared data elements into the same data structure (e.g., in the package and/or stored data) is sufficient to reduce the redundancy, potentially just with a reference to which aspect of the data collection package 3308 and/or stored collected data 2518 are responsive to which policies of the basket. For a raw data overlap, the redundancy management operations may include storing the subsequent processing information to convert the overlapping raw data into the requested literal data responsive to the policy, including separate processing information for each policy that is a member of the overlap group. Example and non-limiting processing includes up-sampling or down-sampling operations to be performed, unit conversions to be applied, resolution adjustments, virtual sensor parameters, or the like. In certain embodiments, subsequent processing information may be self-evident (e.g., differences in units) and/or communicated by referencing the operations and/or utilizing accepted conventions (similar to operations of the data collection package storage 3506 component foregoing). In certain embodiments, the applicable redundancy management operations are considered as a factor in determining the basketing scheme for a system, and/or the iterative improvement operations for a basketing scheme additionally consider adjustments to the applicable redundancy management operations for the baskets. In certain embodiments, the data collection package redundancy management 3510 component may additionally or alternatively form a part of the policy execution circuit 2506, and/or may support the policy execution circuit 2506.

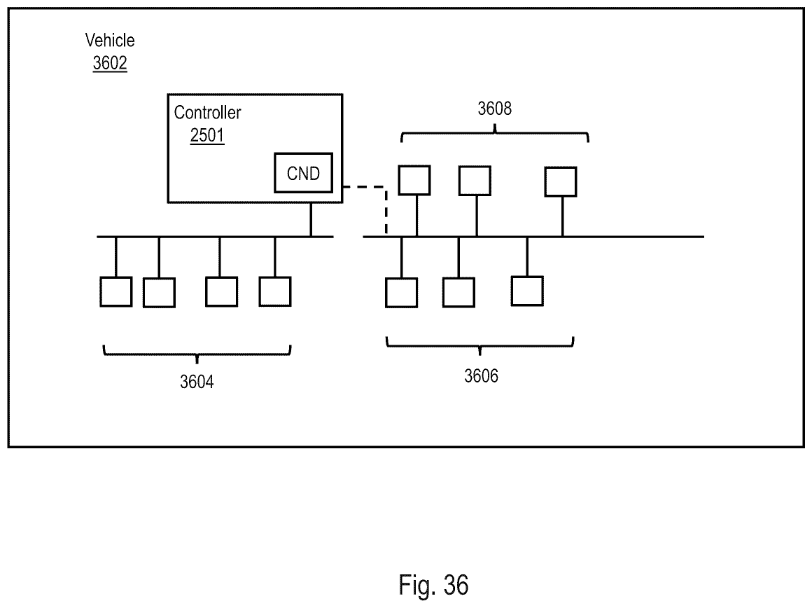

Referencing FIG. 36, a vehicle 3602 is depicted comprising a plurality of network zones, each network zone having a plurality of end points positioned thereon. The vehicle includes a controller 2501 and a converged network device (CND). The network zones include a first network zone 3604, a second network zone 3606, and a third network zone 3608. The controller 2501 is configured to regulate communications between the network zones and to manage data collection from the end points within each network zone. In certain embodiments, end points on the networks/zones communicate data values to each other, where the data provided and/or requested may be continuous, intermittent, and/or as requested, and where the data may be utilized synchronously (e.g., the data is expected to be contemporary data describing current operating conditions) or asynchronously (e.g., the data is utilized in a process, such as long term analysis, where the data is not required to be contemporary, but may need to be time sequenced and/or high rate data).

Referencing FIG. 37, a controller 2501 is depicted comprising a data support circuit 3702 configured to determine a shared data description 3710 comprising vehicle data values. In embodiments, an automation description 3720 may also be provided. The vehicle data values include data provided by prospective data source end points (e.g., during normal operations, it is expected that at least during certain operating conditions, and/or as requested, the data will be provided by the prospective data source end point) and data utilized by prospective data destination end points (e.g., during normal operations, it is expected that at least during certain operating conditions, and/or as requested, the data will be utilized by the prospected data source end point). The data processing circuit 3704 is configured to generate a data collection description 3712 in response to the shared data description and to determine a memory allocation value 3714 in response to the data collection description. In certain embodiments, the shared data description 3710 may be determined in response to a vehicle policy data value 2508, essentially allowing a user to define a shared data block that can be utilized by end points in the system.

The data collection description 3712 defines which parameters are to be collected, any processing that should be performed on the data before sharing with other end points, and the life cycle of the stored data to support the prospective data destination end points. For example, the data processing circuit 3704 determines which data values are to be included in the shared data description 3710, how much data should be kept (e.g., 1 second of data, 30 seconds of data, etc., where the values may vary for each data element and how they are provided and utilized in the system), and determines the memory allocation value 3714 to support the shared data. Where processing is performed on the data according to the data collection description 3712, the memory allocation value 3714 will additionally account for any intermediate memory utilization to support those processing operations. The data collection execution circuit 3706 is configured to collect vehicle data 2512 from one or more end points in response to the data collection description 3712 and to store at least a portion of the collected vehicle data as stored collected data 3716 in response to the memory allocation value. The data sharing support circuit 3708 is configured to provide responsive data 3718 from the collected vehicle data (e.g., where the data is contemporaneous and available) or the stored collected vehicle data to a data destination end point. The optional data layer reporting circuit 3722 is configured to generate a data collection package 3724 and to perform at least one of storing the data collection package or communicating the data collection package to an external device, for example allowing a user to review the data collection description 3712, memory allocation value 3714, and/or the stored collected data 3716 to diagnose, troubleshoot, and/or iteratively improve the operations of the shared data operations of the embodiment of FIG. 37. In certain embodiments, the data sharing support circuit 3708 may publish the data collection package 3724 as a service, and/or may subscribe destination end points for the shared data automatically to implement the shared data operations without disrupting operations of the vehicle. In certain embodiments, any or all of the data communicated between end points on the vehicle may be managed utilizing a shared data description 3710.

Referencing FIG. 38, a data support circuit 3702 is depicted comprising various analysis components. An example component includes a data collection support analysis 3802, for example determining data collection responsibilities for end points on the vehicle to service policies or other data collection operations. An example component includes an automation description support analysis 3804 component, for example determining data sharing between end points, and/or data collection responsibilities, for end points on the vehicle to service automated operations that may be provided by a policy. An example component includes a vehicle policy data value analysis 3806 component that determines shared data between end points, determines common data elements, or the like, to support policies implemented on the vehicle. An example component includes a network zone analysis 3808 that determines which messages are passing on which networks, for example to determine repetitive communications, high utilization messages, or the like, which may be good candidates for inclusion in a shared data description 3710. An example component includes a vehicle flow analysis 3810 component, for example to determine message traffic responsive to flows on the vehicle, including the location of end points that are sources and destinations for communications to support the flow. The example vehicle flow analysis 3810 component can determine if communications to support the vehicle flow can be more efficiently and/or more reliably supported by centralizing those communications utilizing a shared data description 3710 and providing the common data store (stored collected data 3716). Additionally, utilizing a shared data description 3710 to support operations of a flow on the vehicle can provide additional options for optimization and/or iterative improvement of the vehicle flow, and/or troubleshooting issues with the vehicle flow, by providing the shared data as a data collection package 3724, allowing for granular analysis of the data available to supporting end points for the vehicle flow, and/or allowing for post-processing of operations of the vehicle flow. An example component includes a vehicle application analysis component, which operates similarly to the vehicle flow analysis 3810 component. An example component includes a network zone analysis 3808 component, for example to determine message traffic on a network zone, and to determine if a shared data description 3710 can support improvements to the network zone (e.g., by allowing a shift of some communications to another network zone, by time shifting some communications if allowable, and/or by reducing multiple communications from an end point where the destination may only sparsely utilize some, or all, of those communications). An example component includes an end point analysis 3814. An example component includes an asynchronous utilization analysis 3816 component, for example to determine message traffic that can be significantly time shifted, for example for longer term analysis that may be performed significantly after the data is generated. Additionally, the asynchronous utilization analysis 3816 component can ensure that the data is preserved at sufficient sampling rates, resolution, and in sufficient continuous strings of data to support the asynchronous operations. The example components are non-limiting, and the division of specific operations is a non-limiting example to illustrate aspects of the data support circuit 3702. The data support circuit 3702 is configured to determine the shared data description in response to analyses performed by these components, supporting efficient data collection and sharing within the vehicle's network zones. The example of FIGS. 37-38 provides for a hidden data layer that can be utilized to significantly enhance the ability to diagnose and troubleshoot issues on the vehicle, and/or to perform long term iterative improvements for network management and configuration, and for underlying control algorithms operating on vehicle end points.

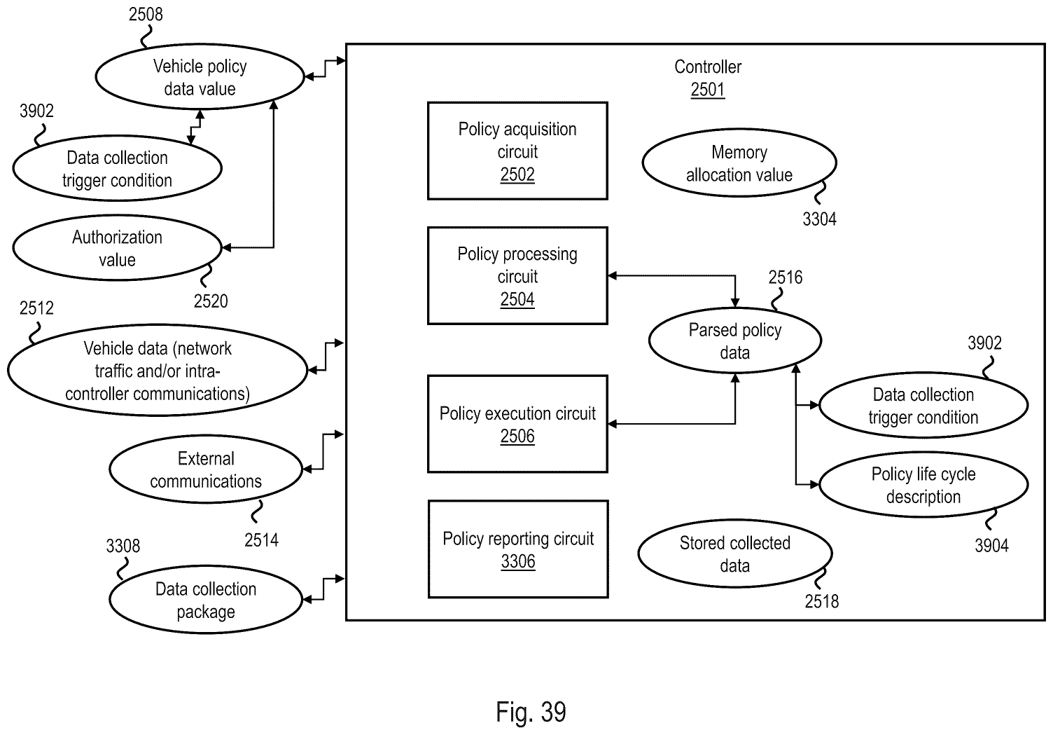

Referencing FIG. 39, an apparatus is depicted comprising a controller 2501 that includes a policy acquisition circuit 2502 configured to interpret a vehicle policy data value 2508 including a data collection trigger condition 3902. The policy processing circuit 2504 is configured to generate parsed policy data 2516 including the data collection trigger condition and a policy life cycle description 3904. The policy execution circuit 2506 is configured to collect vehicle data 2512 from one or more vehicle end points in response to the parsed policy data. The collected data is stored as stored collected data 2518 and may be communicated via external communications 2514. The policy reporting circuit 3306 is configured to generate a data collection package 3308 responsive to the collected vehicle data. An authorization value 2520 may also be included in the vehicle policy data value. The memory allocation value 3304 is determined in response to the parsed policy data.

Referencing FIG. 40, an example policy life cycle description 3904 is further detailed, including a policy trigger condition 4001 and an on-demand policy life cycle 4002. The policy trigger condition 4001 can include any type of trigger condition and/or analysis to determine when the policy should be active once installed, and may include an external event trigger condition 2510. An example on-demand policy life cycle 4002 includes one or more of: monitoring the data collection trigger condition until a next vehicle shutdown 4004 (e.g., the policy is active immediately, and goes inactive at the next vehicle shutdown); monitoring the data collection trigger condition until a single data collection event 4006 is performed (e.g., the policy is active immediately, and goes inactive after the data collection trigger occurs and a data collection operation is performed); and/or monitoring the data collection trigger condition until a selected number of data collection events 4008 are performed (e.g., the policy is active immediately, and goes inactive after a specified number of collection events, where the data collection trigger may be applicable each time before collection, or all collection events may follow after a single occurrence of the data collection trigger). An example policy life cycle description 3702 includes a start sequencing parameter 4010 (e.g., begin at 10 AM, begin one hour after the next trip starts, begin 10 second after vehicle speed reaches 30 mph, etc., where the sequencing parameter may be time based, and/or any other sequencing parameter as set forth herein); a stop sequencing parameter 4012 (e.g., a time and/or other sequencing parameter defining a stop time for the collection); and/or a sequencing parameter window 4014 (e.g., a start/stop time or other sequencing parameter). The example operations are non-limiting to illustrate aspects of the present disclosure.

A mission, vehicle mission, or other similar terminology as used herein should be understood broadly. A mission, as utilized herein, references any one of: a primary function; an intended function; a critical function; and/or a minimum enabling function (e.g., a function required for operations to be considered normal, and/or acceptable to allow continued operation). A mission, for example of the vehicle, may depend upon the current operating condition of the vehicle and/or an intended use of the vehicle. For example, a vehicle mission may include an ability to provide motive power and/or motive operation, and may further include a performance description such as a minimum available power, torque, and/or vehicle speed (e.g., which may be the same as, or lower than, rated values for these). In another example, a mission may be an ability to provide power and/or functionality of a system of the vehicle—such as a light, communication operations, holding operations, cabin environment operations, or the like. In certain embodiments, some level of operation of the vehicle or component may be available, where the vehicle or component is not mission capable—for example where motive operation is available, but below acceptable performance characteristics for the vehicle. In certain embodiments, a mission related aspect may not affect the performance of the vehicle but nevertheless be mission critical—for example a loss of air bag function, ABS function, or the like may not prevent operation of the mission (e.g., motive operation), but nevertheless be considered mission critical for the vehicle to continue operation in an acceptable manner. It can be seen that the mission of a vehicle, component, control operation, or the like may depend on the context of the vehicle, including design considerations, purpose of the vehicle, policies and/or preferences of an entity related to the vehicle (e.g., a fleet owner, vehicle owner, regulatory authority, etc.), geographic location of the vehicle, and/or terrain position of the vehicle (e.g., current altitude, grade, road type, etc.). A data value or other feature may be a mission critical and/or mission related data value or feature on a first vehicle but not on a second vehicle, and/or at a first time for a given vehicle but not at a second time for the given vehicle. One of skill in the art, having the benefit of the present disclosure and information ordinarily available for a vehicle and components thereof, can readily determine whether a data value, control operation, component, or other element of the system is mission critical and/or mission related. Certain considerations to determine whether a data value, control operation, component, or other element of the system is mission critical and/or mission related include, without limitation: a rating of the vehicle, an intended use of the vehicle, a quality of service requirement associated with the vehicle, a warranty description of the vehicle or a component thereof, a duty cycle expected for the vehicle, a geographical operating region of the vehicle, a terrain operating region of the vehicle, regulatory requirements associated with the vehicle, and/or policy considerations associated with the vehicle.

Example trigger evaluation operations herein support any type of analysis or determination operations, including at least: basic logical operators (e.g., AND, OR, numerical comparisons, etc.); nested logical expressions with appropriate formatting (e.g., ((X>5 && Y<10)∥Z!=100) && P<0.05); math functions (e.g., arithmetic, exponential, trigonometric, modular, gamma, etc.); and/or complex data transformation functions over a range of data (e.g., median; mean; standard deviation; map; reduce; min/max; bucketing; filtering; integrating; derivating; and/or frequency analysis operations). Additionally or alternatively, trigger evaluation operations may be sequenced, looped, and/or run in parallel.

Example and non-limiting procedures are described following for performing enhanced data collection, advanced triggering schemes related to data collection and/or automated operations, and supporting operations for data collection. The procedures set forth may be performed, in whole or part, by any systems, circuits, computing devices, or other components as set forth throughout the present disclosure. A given system may utilize any one or more procedures, in whole or part, and the procedures set forth provide an example for performing certain operations as set forth in the present disclosure.

An example procedure includes an operation to interpret a vehicle policy data value including an external event trigger condition, an operation to generate parsed policy data including the external event trigger condition, and an operation to collect vehicle data from one or more vehicle end points in response to the parsed policy data. Example and non-limiting external event trigger conditions include one or more of a traffic condition value, a weather condition value, and/or a road condition value.

In a further example, a procedure includes an operation to collect vehicle data in response to an authorization value associated with the vehicle policy data value. Example and non-limiting authorization values may correspond to a requesting entity for the vehicle policy data value, a vehicle type value, and/or a data type value of the collected data. The authorization value may indicate an authorization of the requestor to collect the data, or an authorization required for the type of data (or specific data elements) being collected.

An example external event trigger conditions includes a location value, where the procedure further includes an operation to collect vehicle data in response to the location value. Example and non-limiting location values include a jurisdiction description, an altitude value, a climate value, and/or a season value. An example location includes a settlement description. An example external event trigger condition includes a mission type value, where the procedure further includes an operation to collect vehicle data in response to the mission type value.

In some aspects, the techniques described herein relate to a method, wherein the location value includes a jurisdiction description.

Another example procedure includes an operation to interpret at least one vehicle data collection description and a target vehicle description, an operation to determine at least one vehicle policy data value in response to the at least one vehicle data collection description and the target vehicle description, and an operation to determine a group of vehicles in response to the target vehicle description. The example procedure further includes an operation to provide at least one vehicle policy data value to the group of vehicles (and/or to provide modified versions of a vehicle policy data value to selected vehicles of the group of vehicles), and an operation to receive identified vehicle data and/or an alert response value in response to the at least one vehicle policy data value.

In a further example, the operation to determine the group of vehicles is performed in response to a shared vehicle aspect. Example and non-limiting shared vehicle aspects include a vehicle configuration value, a vehicle component value, and/or a vehicle feature value. Additionally or alternatively, example and non-limiting shared vehicle aspects include an owner value, a manufacturer value, an OEM value, a fleet value, a body builder value, and/or a dealer value. Additionally or alternatively, example and non-limiting shared vehicle aspects include a maintenance value, a diagnostic value, a recall value, and/or a fault code value. Additionally or alternatively, example and non-limiting shared vehicle aspects include an associated entity type value and/or a vehicle type value.

Another example procedure includes an operation to implement a user data collection interface, an operation to interpret at least one vehicle data collection description and a target vehicle description in response to user policy builder interactions with he user data collection interface, and an operation to determine at least one vehicle policy data value in response to the at least one vehicle data collection description and the target vehicle description. The example procedure further includes an operation to determine a group of vehicles in response to the target vehicle description, and an operation to provide at least one of the vehicle policy data values to the group of vehicles in response to user policy implementation interactions with the user data collection interface.

In some aspects, the techniques described herein relate to a method, further including displaying a recipe library on the user data collection interface, and interpreting the at least one vehicle data collection description in response to user interactions with the recipe library.

In a further example, the procedure includes an operation to display at least one normalized data parameter on the user data collection interface. Example and non-limiting normalized data parameters include one or more of a manufacturer parameter, an industry standard parameter, a simplified parameter, and/or a user defined parameter.

In a further example, the procedure includes an operation to display a policy summary on the user data collection interface. Example and non-limiting policy summaries include one or more of: an active recipe description, a pending recipe description, an active trigger description, a pending trigger description, and/or a logical flow diagram associated with the at least one vehicle data collection description.

In a further example, the procedure includes an operation to receive at least a portion of identified vehicle data in response to the at least one vehicle policy data value, and/or to receive an alert response value in response to the at least one vehicle policy data value. A further example procedure includes an operation to update the policy summary on the user data collection interface in response to the received data and/or received alerts.

An example procedure includes an operation to interpret a vehicle policy data value including a data collection description, an operation to generate parsed policy data corresponding to the data collection description, an operation to determine a memory allocation value in response to the parsed policy data, an operation to collect vehicle data from one or more vehicle end points in response to the parsed policy data, and an operation to store at least a portion of the collected vehicle data in response to the memory allocation value.

In a further example, the procedure includes the memory allocation value as a fixed value determined in response to the parsed policy data, and/or determining the memory allocation value in response to an authorization value associated with the vehicle policy data value.

In a further example, the procedure includes the memory allocation value as a dynamic value determined in response to the parsed policy data, and/or determining the memory allocation value in response to an authorization value associated with the vehicle policy data value. An example procedure includes the vehicle policy data value including at least one policy of a number of policies, and determining the memory allocation value as a shared memory value to support a basket of policies selected from the number of policies. The shared memory value to support a basket of policies may allow for a smaller memory allocation to support all of the policies in the basket, determined according to an operation such as: a probabilistic operation in response to parsed policy data for each of the policies in the basket; adjusting the shared memory value in response to a trigger correlation analysis for the policies in the basket; analyzing historical data collection operations on a vehicle having a controller performing the procedure (where the historical data collection operations relate to the same policies, offset policies, and/or individual collection or processing aspects—e.g., to determine intermediate memory support values-of the same policies or offset policies); analyzing historical data collection operations on an offset vehicle; and/or selecting the basket distribution of policies utilizing any one or more of the foregoing. An example procedure includes an operation to adjust the shared memory value using historical data collection operations on the vehicle and/or an offset vehicle, including adjusting the basket distribution of policies and/or adjusting the memory allocation value.

In a further example, the procedure includes an operation to generate a data collection package responsive to the collected vehicle data, and an operation to perform at least one of storing the data collection package or communicating the data collection package to an external device. An example procedure includes including a package identifier with the data collection package. Example and non-limiting package identifiers include one or more of: an identifier for a policy including the vehicle policy data value; an identifier for a trigger of a policy including the vehicle policy data value; or descriptive metadata for the package. An example procedure includes an operation to include at least a portion of a flow log in the package, and/or an operation to include a vehicle condition log in the package.

In a further example, the procedure includes an operation to perform a streaming recovery operation in response to an interruption of the communicating the data collection package to an external device. Example and non-limiting streaming recovery operations include: buffering at least a portion of the data collection package, determining whether a portion of the data collection package was transmitted (and/or assuming a communicated portion was transmitted), and/or resuming the streaming operation for the data collection package after communications and/or vehicle operations are restored.

In a further example, the procedure includes an operation to generate a separate data collection package for each trigger occurrence for a selected trigger of a policy that includes the vehicle policy data value. Additionally or alternatively, the procedure includes an operation to append new collected data responsive to the selected trigger occurrence to a previously existing data collection package. Additionally or alternatively, the procedure includes an operation to prepare the data collection package after more than one trigger occurrence, and creating separate data collection packages and/or appending further data collection values for additional trigger occurrences. In certain embodiments, the data collection package includes all data for the policy (e.g., waiting until the policy is no longer active before preparing and communicating the data collection package). In certain embodiments, the data collection package is not communicated off the vehicle, but is instead retained in memory to be available to a user that connects to the vehicle, and/or that provides a request for the data to be communicated off the vehicle.

In a further example, the procedure includes an operation to perform a redundancy management operation in response to determining that two (or more) policies have a shared data element. The shared data element may be a literal data overlap (e.g., the same data values as stored in a data collection package and/or as transmitted responsive to each policy are present), or a raw data overlap (e.g., the same raw data values are the source of truth for at least a portion of the data collection package and/or as transmitted responsive to each policy are present—for example where the stored/transmitted data is determined from the same raw data, and/or is processed such as for resolution, units, or the like). In certain embodiments, the determination of raw data overlap can be more efficient for purposes of collecting, storing, and/or transmitting data, but may utilize additional processing power in determining that the same raw data values are the source of truth for responsive data for each policy. Accordingly, embodiments herein may utilize redundancy management, for embodiments that utilize it at all, for either literal data overlap, raw data overlap, or both (e.g., depending upon the data type, which operations are performed to transform between the literal data and the raw data, whether memory utilization, network utilization, or processing utilization is a limiting factor and/or drives the cost and/or complexity of the system, etc.). Further, the utilization of redundancy management may be dependent on the operating condition of the vehicle (e.g., operating conditions that increase network traffic may change the utilization of redundancy management), and/or the state of vehicle components (e.g., available memory and/or current memory utilization). In certain embodiments, the redundancy management may be utilized to limit the data collection values actually collected, the data collection values that are stored, and/or the data collection values that are transmitted off the vehicle.

An example procedure includes an operation to determine a shared data description including vehicle data values. In the example, each of the vehicle data values is a data value provided by a prospective data source end point (e.g., during run time, the data value is provided by, or can be provided by, the data source end point) and/or a value based on such data values. In a further example, each of the vehicle data values is utilized by a prospective data destination end point (e.g., during run time, the data value may be utilized by the data destination end point, at least during certain operating conditions or states). The example procedure further includes an operation to generate a data collection description in response to the shared data description, and to determine a memory allocation value in response to the data collection description. The example procedure further includes an operation to collect vehicle data from end points in response to the data collection description, and an operation to store at least a portion of the collected vehicle data in response to the memory allocation value. The example procedure further includes an operation to provide responsive data from the collected data and/or the stored data, to a data destination end point. The example procedure provides for ease of data sharing between end points, reduces the knowledge required to configure end points to utilize available data, and allows for ease of data management operations for example to determine how much data is utilized in the system, how often the data is utilized, which end points utilize the data, and the like. The example procedure simplifies data availability for asynchronous features (e.g., the destination end point may utilize the data in batches, after a delay period, etc.), allowing the system to provide sufficient data storage to support the asynchronous data utilization without overdesigning the system, and/or without forcing additional capability such as additional buffering memory storage down to the destination end points and/or controllers performing operations for the destination end points. The example procedure creates a type of hidden data layer that is accessible to end points to allow for rapid design of the system and/or rapid and high confidence updating of the system. In certain embodiments, the shared data description is determined to support specific operations that utilize data sharing between end points as set forth in the specification for such operations, such as determining the shared data description in response to an automation description and/or a vehicle policy data value. In certain embodiments, the shared data description is determined based on an analysis of operations, for example utilizing code analysis, empirical observation of network traffic, end point communications, or the like. An example operation includes determining the shared data description by performing one or more operations such as: analyzing a vehicle application, analyzing a vehicle flow, analyzing one or more network zones of the vehicle, and/or analyzing one or more end points (e.g., tracking source and/or destination messages for the end points to determine the parameters utilized and/or sourced from the end point).

In a further example, the utilization by the prospective data destination end points is an asynchronous utilization, where determining the shared data description is in response to an analysis of the asynchronous utilization (e.g., time offsets, how often the asynchronous operations are performed, the amount of data and/or any required time relationship between the collected data and the asynchronous operations, etc.).

In a further example, the procedure includes an operation to generate a data collection package in response to the collected and/or stored vehicle data. The generated data collection package may be stored and/or communicated to an external device. The data package may include any aspects as set forth in the present disclosure, such as a package identifier, the data package may be published as a service on the vehicle, end points (and/or flows, applications, or features) may subscribe to the data package, and/or the procedure may include operations to automatically publish the data package from the source end points, and subscribe the destination end points to the data package, to implement the shared data description operations.

In some aspects, the techniques described herein relate to a method, further including generating a data collection package in response to the at least one of the collected vehicle data or the stored collected vehicle data. Without limitation to any other aspect of the present disclosure, example package identifiers include one or more of: an identifier for an automation description utilized to determine the shared data description; an identifier for a vehicle policy data value utilized to determine the shared data description; an analysis description for an analysis utilized to determine the shared data description; or descriptive metadata for the package.

An example procedure includes an operation to interpret a vehicle policy data value including a data collection trigger condition, an operation to generate parsed policy data including the data collection trigger condition and a policy life cycle description, and an operation to collect vehicle data from one or more vehicle end points in response to the parsed policy data. Example and non-limiting policy life cycle descriptions include a policy trigger condition, where the procedure further includes an operation to commence monitoring the data collection trigger condition in response to the policy trigger condition. An example policy life cycle description includes an on demand policy life cycle, and monitoring the data collection trigger condition by performing operations such as: monitoring the data collection trigger condition until a next vehicle shutdown; monitoring the data collection trigger condition until a single data collection event is performed responsive to the data collection trigger condition; and/or monitoring the data collection trigger condition until a selected number of data collection events are performed responsive to the data collection trigger condition. An example policy life cycle description includes a start time (or start sequencing parameter), a stop time (or stop sequencing parameter), and/or a time window (or sequencing parameter window). The time and/or sequencing parameter values may be utilized as absolute and/or relative values.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. An apparatus, comprising:
a policy acquisition circuit configured to interpret a vehicle policy data value comprising a data collection description;
a policy processing circuit configured to generate parsed policy data corresponding to the data collection description, and to determine a memory allocation value in response to the parsed policy data; and
a policy execution circuit configured to collect vehicle data from one or more vehicle end points in response to the parsed policy data, and to store at least a portion of the collected vehicle data in response to the memory allocation value.

2. The apparatus of claim 1, wherein the memory allocation value is a fixed value determined in response to the parsed policy data.

3. The apparatus of claim 2, wherein the policy processing circuit is further structured to determine the memory allocation value in response to an authorization value associated with the vehicle policy data value.

4. The apparatus of claim 3, wherein the authorization value corresponds to at least one of: a requesting entity for the vehicle policy data value; a vehicle type value; or a data type value of the collected vehicle data.

5. The apparatus of claim 1, wherein the memory allocation value is a dynamic value determined in response to the parsed policy data.

6. The apparatus of claim 5, wherein the policy processing circuit is further structured to determine the memory allocation value in response to an authorization value associated with the vehicle policy data value.

7. The apparatus of claim 6, wherein the authorization value corresponds to at least one of: a requesting entity for the vehicle policy data value; a vehicle type value; or a data type value of the collected vehicle data.

8. The apparatus of claim 5, wherein the vehicle policy data value comprises one policy of a plurality of policies, and wherein the policy processing circuit is further structured to determine the memory allocation value as a shared memory value to support a basket of policies comprising a selected plurality of the plurality of policies.

9. The apparatus of claim 8, wherein the policy processing circuit is configured to determine the shared memory value utilizing a probabilistic operation in response to parsed policy data for each of the policies of the basket of policies.

10. The apparatus of claim 9, wherein the policy processing circuit is further configured to adjust the shared memory value in response to a trigger correlation analysis.

11. The apparatus of claim 9, wherein the policy processing circuit is further configured to adjust the shared memory value in response to historical data collection operations on a vehicle defining the apparatus.

12. The apparatus of claim 9, wherein the policy processing circuit is further configured to adjust the shared memory value in response to historical data collection operations on at least one offset vehicle.

13. The apparatus of claim 1, further comprising a policy reporting circuit configured to generate a data collection package responsive to the collected vehicle data, and to perform at least one of storing the data collection package or communicating the data collection package to an external device.

14. The apparatus of claim 13, wherein the policy reporting circuit is further configured to include a package identifier with the data collection package.

15. The apparatus of claim 14, wherein the package identifier comprises at least one of:
an identifier for a policy comprising the vehicle policy data value;
an identifier for a trigger of a policy comprising the vehicle policy data value; or
descriptive metadata for the package.

16. The apparatus of claim 13, wherein the policy reporting circuit is further configured to include at least a portion of a flow log in the package.

17. The apparatus of claim 13, wherein the policy reporting circuit is further configured to include a vehicle condition log in the package.

18. The apparatus of claim 13, wherein the policy reporting circuit is further configured to perform a streaming recovery operation in response to an interruption of the communicating the data collection package to an external device.

19. The apparatus of claim 18, wherein the policy reporting circuit is further configured to utilize a memory buffer to perform the streaming recovery operation.

20. The apparatus of claim 13, wherein the policy reporting circuit is further configured to generate a separate data collection package for each trigger occurrence for a selected trigger of a policy comprising the vehicle policy data value.

21. The apparatus of claim 13, wherein the policy reporting circuit is further configured to append new collected data responsive to a selected trigger of a policy comprising the vehicle policy data value to a previously existing data collection package.

22. The apparatus of claim 1, further comprising:
wherein the vehicle policy data value comprises one policy of a plurality of policies; and
wherein the policy execution circuit is further configured to perform a redundancy management operation in response to determining that at least two of the policies have a shared collected data element.

23. The apparatus of claim 22, wherein the shared collected data element comprises a literal data overlap.

24. The apparatus of claim 22, wherein the shared collected data element comprises a raw data overlap.

25. The apparatus of claim 22, wherein the memory allocation value is a dynamic value determined in response to the parsed policy data, and wherein the policy processing circuit is further structured to determine the memory allocation value in response to the redundancy management operation.

26. The apparatus of claim 1, further comprising:
wherein the vehicle policy data value comprises one policy of a plurality of policies;
a policy reporting circuit configured to generate a data collection package responsive to the collected vehicle data, and to perform at least one of storing the data collection package or communicating the data collection package to an external device; and
wherein the policy reporting circuit is further configured to perform a redundancy management operation in response to determining that at least two of the policies have a shared collected data element.

27. The apparatus of claim 26, wherein the shared collected data element comprises a literal data overlap.

28. The apparatus of claim 26, wherein the shared collected data element comprises a raw data overlap.
